(19) United States
(12) Patent Application Publication
(10) Pub. No.: US 2018/0165604 A1
(43) Pub. Date: Jun. 14, 2018

(54) SYSTEMS AND METHODS FOR AUTOMATING DATA SCIENCE MACHINE LEARNING ANALYTICAL WORKFLOWS

(71) Applicant: U2 SCIENCE LABS A MONTANA, San Juan Capistrano, CA (US)

(72) Inventors: Andrew M. Minkin, McKinney, TX (US); Mark McNally, San Juan Capistrano, CA (US); William Knight, Bainbridge Island, WA (US); Stephane Major, Poway, CA (US); Richard Lamoreaux, Redmond, WA (US); Leandro Hernandez, Ladera Ranch, CA (US)

(21) Appl. No.: 15/836,804

(22) Filed: Dec. 8, 2017

Related U.S. Application Data
(60) Provisional application No. 62/432,558, filed on Dec. 9, 2016.

(51) Int. Cl. G06N 99/00; G06N 5/02

(52) U.S. Cl. CPC G06N 99/005; G06N 5/022

(57) ABSTRACT

Systems and methods for automating data science machine learning using analytical workflows are disclosed that provide for user interaction and iterative analysis including automated suggestions based on at least one analysis of a dataset.

### CROSS-REFERENCE TO RELATED APPLICATIONS

This application claims priority to U.S. Provisional Application No. 62/432,558, filed Dec. 9, 2016, titled “SYSTEMS AND METHODS FOR AUTOMATING DATA SCIENCE MACHINE LEARNING ANALYTICAL WORKFLOWS,” which is hereby incorporated by reference in its entirety for all purposes.

### FIELD OF THE INVENTION

The subject matter described herein relates generally to automatically constructing workflows and workflow steps associated with decision-making in data science and machine learning for a given analytical process.

### BACKGROUND OF THE INVENTION

The problem of automatically constructing workflows and workflow steps associated with decision making in data science and machine learning for a given analytical process can be difficult in many embodiments. Big data analytics is typically a complex decision-making process involving the consideration of the dataset attributes, user attributes and goals, intended use of the results from the analytics, and finally domain specific facts and rules (knowledge). The intent of these analytics and models is generally to model and subsequently automate the data science analytical process enough so that a non-data scientist could perform relatively complex analytical tasks and understand the results.

This can be a labor-intensive process requiring the active involvement of one or more data scientists to make decisions regarding data transformations, selecting and testing appropriate algorithms and parameters to analyze the data, and presenting the results. Analysis tasks may involve the construction of predictive models or involve supervised machine learning. This characterizes an inquiry workflow and is often designed to test one or more specific hypotheses about the data being analyzed. Another process may involve the construction of descriptive models involving unsupervised learning. This can be characterized as a discovery workflow and is designed for hypothesis construction. A typical manual data science process is performed using customized tools and scripts written by hand or specified by the data scientist. When very large data sets are analyzed, the analytical steps must be performed on a platform that can support the necessary analytical computing capability—normally a distributed platform such as Hadoop or Spark, for example. Significant specialized knowledge regarding platform capability is often required in order run these types of analytics at a large scale.

This knowledge is typically applied using a labor intensive “manual” data science process in the prior art at present. Various data science technologies may automate small parts or portions of a particular process, such as searching for parameters for a given machine learning algorithm or using relational database software to build queries for extraction, transformation, and loading. The prior art is currently deficient in automating an entire data science analytical process on any sort of a larger scale.

Various attempts have been made including Thinkworx IoT Platform (http://www.thingworx.com/IoTPlatform) and Dr. Mo Automatic Statistical Software (http://soft10ware.com) but are deficient because they are tailored to specific analytical task or domain.

Accordingly, described herein are systems and methods for performing large scale automated workflow generation and performance and can be reused across various analytical tasks and domains.

### SUMMARY

The present subject matter is directed to automatically generating and executing the necessary workflow steps to perform a given analytical task. These solutions can be accomplished using a combination of expert system (knowledge based) and machine learning (data driven) techniques driven by one or more decisions associated with given steps in an analytical workflow as executed on an underlying platform. Both techniques will operate in terms of a feature space derived from observing quantitative and qualitative data from data science workflows that abstracts data science workflows for metalearning, a subfield of machine learning where automatic learning algorithms are applied on meta-data about machine learning experiments. This metalearning feature set, or metaspace, can support transfer learning, using knowledge gained while solving one problem and applying it to a different but related problem. The system can implement an intelligent agent framework to accomplish this. Each of one or more specialized agents in the framework can be operable to make complex analytical decisions associated with given steps in an analytical workflow and execute them on the underlying platform on very high volume and high dimensional datasets.

Application of the principles described herein can be considered and variously applied in the fields of scientific discovery, forecasting, and modeling highly complex functions, for instance in predictive analysis. In some embodiments, they can be broken down or separated by methodology including symbolic reasoning (rules/production systems), reinforcement learning (RL), recommenders, and others. Techniques such as rule conflict resolution and the merging of knowledge-based and data-driven methodologies can be performed in novel ways while reactive distributed agents and messaging to achieve workflow inferencing can be implemented. Also described are novel techniques including the use of block-based approaches for encapsulating, reusing and executing analytical commands in workflow sequences.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE DRAWING(S)

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 shows an example embodiment of a high-level machine learning task mapping to nudge types within an autonomous learning systems diagram.

FIG. 2 shows an example embodiment of a partial system architecture diagram.

FIG. 3 shows an example embodiment of a Lambda architecture and its mapping to a physical architecture diagram.

FIG. 4 shows an example embodiment of system architecture diagram.

FIG. 5 shows an example embodiment of a data flow diagram.

FIG. 6A shows an example embodiment of a logical system operation diagram.

FIG. 6B shows an example embodiment of a more detailed logical architecture of a system Platform.

FIG. 7A shows an example embodiment of a physical system operation diagram.

FIG. 7B shows an example embodiment of a more detailed physical architecture of a system platform.

FIG. 7C shows an example embodiment of the integration of different aspects of analytic content into a logical system operations diagram of the auto-curious module.

FIG. 7D shows an example embodiment of the detailed integration points of different tasks and analytic content into an abstract logical system operations diagram of the auto-curious module diagram.

FIG. 7E shows an example embodiment of a mapping between the types of commands in a Ubix Data Science Language and the machine learning process architecture diagram.

FIG. 8A shows an example embodiment of a system architecture diagram.

FIG. 8B shows an example embodiment of a high-level Solution Architecture.

FIG. 9A shows an example embodiment of analytic content mapped to nudge types to user focused analytic tasks in an abstract system architecture diagram.

FIG. 9B shows an example embodiment of analytic content inputs and outputs mapped to nudge types, general workflows and feedback loops associated with user controls in a high-level abstract system architecture diagram.

FIG. 10A shows an example embodiment of processes of ingesting source analytic assets, including analytic context from a corpus of documents and code, processing to generate metaspace points that map user domains to analytic domains and drive autonomous machine learning workflows as expressed in a high level architectural diagram.

FIG. 10B shows an example embodiment of the processes of using metaspace points to provide feedback on quantitative tasks that drive Schema nudges and Analytic nudge types, including workflows from external machine learning algorithms, to drive autonomous machine learning workflows as expressed in a high level architectural diagram.

FIG. 10C shows an example embodiment of the processes of driving metaperception models from source analytic to generate visualizations and applications driven by autonomous machine learning workflows as expressed in a high level architectural diagram.

FIG. 10D shows an example embodiment of the processes of ingesting source analytic assets processing to generate metaspace points that drive autonomous machine learning workflows as they relate to technology layers and nudge types as expressed in a high level architectural diagram.

FIG. 11 shows the combined Big Data based technologies and their role in constructing machine learning workflow in a partial physical architecture diagram.

FIG. 12 shows an example embodiment of the core components of an analytic event orchestrator and their role in constructing machine learning workflow through interactions in a high-level architecture diagram.

FIG. 13 shows an example embodiment of a high-level architectural diagram.

FIG. 14 shows an example embodiment of a high-level abstract system architecture diagram.

FIG. 15 shows an example embodiment of a Visual Analytics Reference Model diagram.

FIGS. 16A-16B show an example embodiment of an overall analytical workflow decision tree for constructing an analytical application and solution that includes a combined data gathering, model construction and model application workflow.

FIG. 17 shows an example embodiment of an overall analytical workflow tree.

FIG. 18 shows an example embodiment of an actor-based agent framework with and logical task groupings diagram.

FIG. 19 shows an example embodiment of a learning architecture and interaction diagram.

FIG. 20 shows an example embodiment of an IHS Port Prediction Ontology.

FIGS. 21A-21B show an example embodiment of a question graph diagram.

FIG. 22 shows an example embodiment of an interaction semantics diagram.

FIGS. 23A-23D show an example embodiment of an AC Metaspace Metamapper diagram.

FIG. 24A shows an example embodiment of an AC Metaspace used for driving suggestions in a partial user experience flow diagram.

FIG. 24B shows an example embodiment of an AC Metaspace visualizations used for driving the appropriate user experience in a machine learning workflow diagram.

FIG. 24C shows an example embodiment of a user interface screen for adding a custom question graph item.

FIG. 24D shows an example embodiment of a user interface screen for navigating and viewing information on existing question graph items.

FIGS. 25A-25D show an example embodiment of AC's persistence schema.

FIG. 26 shows an example embodiment of a user interface screen for an initial inquiry in many use cases.

FIG. 27A shows an example embodiment of a first user interface screen for a Titanic workflow use case.

FIG. 27B shows an example embodiment of a second user interface screen for a Titanic workflow use case.

FIG. 27C shows an example embodiment of a third user interface screen for a Titanic workflow use case.

FIG. 27D shows an example embodiment of a fourth user interface screen for a Titanic workflow use case.

FIG. 27E shows an example embodiment of a fifth user interface screen for a Titanic workflow use case.

FIG. 27F shows an example embodiment of a sixth user interface screen for a Titanic workflow use case.

FIG. 27G shows an example embodiment of a seventh user interface screen for a Titanic workflow use case.

FIG. 27H shows an example embodiment of an eighth user interface screen for a Titanic workflow use case.

FIG. 27I shows an example embodiment of a ninth user interface screen for a Titanic workflow use case.

FIG. 27J shows an example embodiment of a tenth user interface screen for a Titanic workflow use case.

FIG. 27K shows an example embodiment of an eleventh user interface screen for a Titanic workflow use case.

FIG. 27L shows an example embodiment of a twelfth user interface screen for a Titanic workflow use case.

FIG. 27M shows an example embodiment of a thirteenth user interface screen for a Titanic workflow use case.

FIG. 27N shows an example embodiment of a fourteenth user interface screen for a Titanic workflow use case.

FIG. 28A shows an example embodiment of a first user interface screen for a flight delay workflow use case.

FIG. 28B shows an example embodiment of a second user interface screen for a flight delay workflow use case.

FIG. 28C shows an example embodiment of a third user interface screen for a flight delay workflow use case.

FIG. 28D shows an example embodiment of a fourth user interface screen for a flight delay workflow use case.

FIG. 28E shows an example embodiment of a fifth user interface screen for a flight delay workflow use case.

FIG. 28F shows an example embodiment of a sixth user interface screen for a flight delay workflow use case.

FIG. 28G shows an example embodiment of a seventh user interface screen for a flight delay workflow use case.

FIG. 28H shows an example embodiment of an eighth user interface screen for a flight delay workflow use case.

FIG. 28I shows an example embodiment of a ninth user interface screen for a flight delay workflow use case.

FIG. 28J shows an example embodiment of a tenth user interface screen for a flight delay workflow use case.

FIG. 28K shows an example embodiment of an eleventh user interface screen for a flight delay workflow use case.

FIG. 28L shows an example embodiment of a twelfth user interface screen for a flight delay workflow use case.

FIG. 28M shows an example embodiment of a thirteenth user interface screen for a flight delay workflow use case.

FIG. 29 shows an example embodiment of a high-level system level architecture diagram.

FIG. 30 shows an example embodiment of a logical architecture process diagram of the primary learning workflow using analytic content inputs and outputs.

FIGS. 31A-31B show an example embodiment diagram of a variety of AC learning workflow connections.

FIG. 32 shows an example embodiment table showing different administrative and user roles and access privileges for an AC system.

FIG. 33 shows an example embodiment diagram of an AC system deployment model.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

In the various embodiments described herein, Auto-Curious (AC) can include or be implemented by or as one or more programs that are designed to automate the construction of analytical or other data science workflows and their associated analytical decision-making tools. Analytical workflows can be thought of in some embodiments as one or more non-linear sequences of tasks that can be mapped to key distinct phases in a given workflow.

An example of how the subject matter disclosed herein can function, a user of the implementation of principles discussed herein may be able generate a workflow in a matter of minutes for a given problem, such as a Kaggle competition. This may guarantee that any results will be ranked within the top 10% of accuracy as compared with other results not implementing the principles herein. It may also generate these results even though a user implementing the principles may not be a formal data scientist. It can allow the user to create and develop new insights based on raw data and to perform many or all of these functions using a customized or standard computing device, such as a mobile device, tablet, video game console, laptop, desktop, or others.

Before fully delving into the subject matter of the various example embodiments contemplated, a brief description and non-exclusive listing of various terms is provided below, as well as an associated description of each.

Analytic Domain can be an ontology that AC uses to describe components of a metaspace. These can include workflows that translate User Source Features and User Domains in terms that can be applied across multiple domains. An Analytic Domain can include features and Feature Engineering can be performed in order to build one or more metaspace and their models.

An App is any endpoint using an autonomous data science workflow, including question graph portals, that use a published Solution in order to deliver analytic content and context. Multiple Apps can reference the same solution and multiple solutions can be used in an App.

A Case can be an instance of a domain or one of its Source Features, as well as various schema relationships that may be the smallest granularity of features. For example, a ship and its position at a certain time could be considered a case. Primary key or uniqueid may require that a datatype has a 1:1 mapping to a source schema and case.

Competitive Modeling can be an analysis or synthesis of parallel metamodeling techniques to generate and determine one or more best performing approaches.

Composite Modeling can include using a combination of primary workflows that may drive a goal metric and model family, as well as any additional levels of complexity for these models for Feature Engineering. These can include PCA (a statistical procedure that uses an orthogonal transformation to convert a set of observations of possibly correlated variables into a set of values of linearly uncorrelated variables called principal components.) clustering, matrix factorization, collaborative filtering, and others that are used to build a combination of strong models (distribution-free model in which the hypothesis of the learning algorithm is required to perform only slightly better than random guessing) and weak models (a model using distributions and given access to a source of examples of the unknown concept, the learner with high probability is able to output an hypothesis that is correct on all but an arbitrarily small fraction of the instances).

CVU can be an acronym for Client/Visualization/User Experience to describe several systems used to generate and manage client interactions and render visual analytics.

Domain can be an ontology represented in one or more logical groupings and relationships of Source Features. Relationships that encapsulate one or more ontologies with user roles, verbs, or processes may result in interaction graphs and goals can be used to define a domain. Nudges of a Domain type are the addition of semantic data to a workflow.

Domain Digestion can include processes performed after ingestion of data and metadata that acts to prepare sources for mapping to an Analytic Domain. It can take source and domain features and apply ontology types from implicit modeling before beginning semantic mapping.

Feature can be a name and data attributed to a given case. For example, data files such as ORB (a near real-time vessel monitoring, ocean buoy tracking and ship tracking data for commercial fishing boats and merchant fleets travelling global waters using AIS sensors provided by ORBCOMM for ship activity beyond 50 miles from shore https://www.orbcomm.com/en/networks/satellite-ais) data can have a column called nimo, a unique reference number for each ship maintained by the International Maritime Organization (http://imo.org). A value or class of the feature can be the nimo number, while the nimo entity can be the name of the column “nimo.” The case key of this feature can be included at a nimo-timestamp combination grain.

Feature Engineering can include creation of new features derived from Source Features that are based on filters, aggregations, and additional calculations. An example can include converting a series of GPS timestamps for a journey into an index value for waypoint transits.

Gestalt Modeling can be a combination of several metamodeling techniques that is performed in order to quickly arrive at robust models with meaningful user feedback. A combination of Progressive Modeling, Composite Modeling, Competitive Modeling, OKA, and other factors may be used to achieve Gestalt Modeling.

A Goal can be a domain property of features that describe a target result for a workflow execution. As an example, one goal could be to predict a port destination with finding true positive rate being a success metric of the goal.

A Hero Graphic can be an Insight suggested by Auto-Curious that has the highest expectation of being recognized as an insight and is typically the most prominently displayed plot rendered by a visual analytic client.

Implicit Modeling can include trivial semantic mapping performed using individual Source Features upon a load to enhance Semantic Context. As an example, this can include suggesting two numerics with expected ranges and names that are a GPS coordinate. This in turn can suggest a numeric field with values like 20160716 as a date or time stamps.

Implicit Type can be a default data type assigned to a Source Feature, such as a timestamp, double.

Import can be a physical process of loading new data or extending existing data, an incremental import, from files or streams into the system. Importing can feed into the process of Ingestion. Importing can apply to both sources for analytic content, such as CSV (a comma-separated values (CSV) file store of tabular data (numbers and text) in plain text where each line of the file is a data record and each record consists of one or more fields, separated by commas), JDBC (an application programming interface (API) for Java defining how a client accesses a database. It is Java based data access technology and used for Java database connectivity.), or others, as well as analytic context, such as RDF (The Resource Description Framework, a family of World Wide Web Consortium (W3C) as a general method for conceptual description or modeling of information that is implemented in web resources), ARFF ((Attribute-Relation File Format, an ASCII text file that describes a list of instances sharing a set of attributes.), OWL (Web Ontology Language, a computational logic-based language standard for semantic representations produced by the W3C), Maana (a type of knowledge graph produced by a company of the same name), or others.

Inferred Schema can be a trivial feature engineering performed on a user domain upon an initial or incremental import of a user domain. This can also include any changes modeled by a user. As an example, a multiresolution transform on latitude and longitude columns can be an inferred schema.

Ingestion can include any processes that receive sources of analytic content and context from initial import that produces internal system data structures. Implicit modeling can occur via workflows during this phase to derive initial suggested Ontology Types prior to Domain Digestion.

Inductive Transfer can be similar to transfer learning, include the storing of knowledge gained, results or solutions, while solving one problem that are subsequently applied to a different but related problem. In AC terms, this can include or require building rules and models from multiple domains that are mapped to the Analytic Domain, before applying them to new domains to achieve results based on common learning.

Insight can be a combination of workflow context, plots, and interactions that are generated from a previous interaction with a domain.

Insight Producers can be members of a data “team,” such as managers, information architects, business or subject manager experts, data scientists, and others.

Insight Consumers can be system users that interact with insights shared directly from either a User Domain or a Solution Domain. For example, any non-Question Graph or nudge interactivity in a maritime context may be Insight Consumers. Insight Consumers may generally have read access to domains, sources and models. If a user elects to import a new set of data and map it to published model, they can be considered to be consuming the model's insights. However, if they add workflows to customize the output or publish it for use in a microservice, they may be considered to have engaged in Insight Producer activities.

Insight Workers may be individuals in both an Insight Producer and Insight Consumer role. For example, they may be a business analyst who performed a nudge to review candidate waypoints or to build a ship ETA model based on a port prediction model.

Insight Factory can be a user interface used by Insight Producers to build rules, insights, and solutions starting with sources and domains.

Interaction can include a series of suggested tasks used as a next step in a current workflow or the mechanisms to execute them and update the user on the next steps based on the definitions of the solution or common learning.

Interaction Graph can be an audit trail of interactions that have evolved a domain to its current state. In some embodiments, this can be called a “system conversation.”

Metafeatures are synonymous with metaspace points and covering entire workflows, including transforms, user queries, model configuration and testing, exploring “dead ends” in research for further usage later and training models beyond the initial scope of predictive model algorithm choices.

Metamodels can be machine learning models generated from data directly sourced from the output of other machine learning models.

Metamodeling can include analysis, construction, and development of frames, rules, constraints, models, and theories that are applicable and useful for modeling a predefined class of problems. In system terms, these can include sources, rules, domains, and schemas used to build all of the Analytic Domain and maintain the metaspace and its optimization models.

Metaperception can be the process of using metaspace points derived from a history of user interactions customizing visual analytics in order to build and apply suggestion models for optimizing the likelihood of insight recognition by future user interactions.

Metaspace can be a proprietary AC code and objects associated with: data collected by mapping User Domains to system Analytic Domain; workflows by AC and users for feature engineering based on those mappings; and advanced analytic and predictive models built based on using deep learning. These advanced analytic and predictive models can include the following goals: defining and applying analytic clusters to User Domain assets, optimizing forward chaining tasks based on current state of data and workflow, optimizing backwards chaining goals and methods based on simulated and user nudged workflows, and others.

Metaspace Cluster can be the result of applying a metamodel suggestion model to the current state of the machine learning framework's AC environment. An example would be building a Kmeans cluster model on several summary statistics gathered from different datasets and building cluster of these datasets to partition the possible suggestions for modeling algorithms.

Metaspace Point can be an example of all details regarding the quantitative (ex. Standard deviation, mean and kurtosis of a column's numeric values) and qualitative (ex. Knowing two numbers are geospatial data) collected through a process of Domain Mapping that are used to apply metaspace suggestion models.

Million Model March can be an internal project that uses a preset number of datasets, such as 100, with a preset number of transforms, such as 100, and a preset number of algorithm combinations, such as 100, to build internal models for suggesting workflow changes. This can be used to perform Gestalt Modeling on a large number of datasets, such as 1,000 or more.

A Model can be output based and built for a specific goal based on a combination of domain rules, nudges, and either supervised or unsupervised, or combinations of both performed in learning operations.

Namespace can be a combination of a relationship between logical entities that are defined within a particular schema, Source Features, and Interaction Graphs. An example is given herein with respect to oil tanker behavior.

A Nudge can be a user interaction that provides input to a metaspace model. Alternately, when the auto-curious module is running simulations of machine learning workflows, nudges may occur in headless interaction, where one or more options of suggested workflow states is explored without user interaction. All nudges can be considered interactions, but nudges may be specific to a model. For example, looking at feature space of waypoints and deciding whether models should include waypoints in the model, which translates to adding more weight to waypoints in secondary model, or excluding waypoints to remove them from subsequent training on existing models. Each interaction to include or exclude is a nudge case that can impact the state of the next generation of the model.

Ontology can be a subset of a domains that can describe the relationship between logical entities defined within a particular schema.

Ontology Type can be a feature of the Analytic Domain derived from source data types, such as a geospatial coordinate.

Overkill Analytics (OKA) can be a data science philosophy leveraging computing scale and rapid development technologies to produce faster, better, and cheaper solutions to predictive modeling problems, including the construction and management of ensembling techniques, model hyper-parameters, and partitioning strategies, in order to drive other modeling workflows.

Pragmatic can be a smallest unit of analytic execution. For example, it can be as simple as renaming a column, apply an existing model, and others.

Presentation Manager can be a client of AC that manages workflow analytics necessary to support Visual Analytics.

Progressive Modeling can be a combination of running multiple small samples either at import or during post-load analysis, as well as their orchestration, and subsequently presenting their partitioned results for an ensembling rule.

A Question Graph can be a curated set of interactions and insights derived from an Interaction Graph to support one or more solutions. For example, Insight Producers can curate features, goals and insights from their port prediction error analysis and possible interactions when asking for nudges and Insight Consumers can use a question graph to nudge waypoint inclusions and exclusions.

Root Domain can be a User Domain suggested by implicit modeling after Domain Digestion. In some cases, this is also referred to as a Default Domain before it is published.

Rules (also formally called Analytics) can be a collection of workflows, from simple named filters to complex autonomous analytics, that are linked to domain goals defined in the schema and created by custom user interactions and system created workflows. Outputs of rules can include interactions, models, insights to understand the model content and behavior, messaging endpoints available to publish as solutions or sources, and others. Rules or Analytic nudge types can be the most common source of metaspace points after source ingestion and the primary consumer of gestalt modeling techniques.

A Schema can be a logical representation of calculations, aggregations, and ontology types that are based on and built from a User Domain using suggestions that are included in implicit modeling and custom rules. For example, a vocabulary of waypoints used as features for the port prediction model can be a schema.

A Scout can be an Auto-curious goal planning agent that uses analytic event orchestrators to manage the backward chaining suggestions, executing analytic workflows that process “dead-end” or features removed form models for changes in population stability, and offers new tasks that were not in the original goals of a machine learning workflow.

Semantic Content can be any metaspace feature engineering performed by AC workflows that is derived primarily from quantitative or statistical Source Features. For example, it can describe subcommands, table based metrics from OpenML (an online collaboration platform where scientists can automatically share, organize and discuss machine learning experiments, data, and algorithms), or others.

Semantic Context can be any metaspace feature engineering performed by AC workflows that derive primarily from semantic or metadata Source Features. It is generally built from an understanding of the Semantic Content of the data and known or suggested Ontology Types that are applicable. For example, date and time parts such as day, month, year can allow a mapping into autoregressive and other time-based forecasting algorithms to be applied by the system.

Semantic Mapping can be the process of mapping Source Domain and Schema features into an Analytic Domain by assigning which Analytic Domain features will apply to a given User Domain feature. This allows placement of sources of the domain to be viewed in the context of the metaspace and its suggested workflows.

A Sentry can be an Auto-curious goal planning agent that uses analytic event orchestrators to manage the forward chaining suggestions that control the constraints for a modeling action, such as triggering when model aging occurred or listening to a stream, or to what degree of gestalt learning should be used in order to accomplish an analytic task.

A Solution can be a collection of insights and interaction definitions that are published for use in human or automated insight consumption. For example, a REST endpoint exposing a predicted destination of a ship at a given time or a mobile app tracking predicted destination changes.

A Solution Domain can be a curated User Domain published to a distributed team for collaboration or as the foundation for building solutions. It can be the equivalent of promoting content from a user sandbox to a solution and may be extended to all rules and Interaction Graphs. As an example, one data scientist building generic shipping analytics User Domain and then publishing it so other teams can use the definitions can be a Solution Domain. Alternatively, the act of making a view of the same domain for use by a port operator app may only use those parts of a User Domain relevant to that app.

A Source can be any file, stream, JDBC accessed database, or other input that the system may use for building other components. For example, sources can be ORB Stream, AIS data (AIS: (Automatic Identification System) Near real-time vessel monitoring and ship tracking data for commercial fishing boats and merchant fleets travelling global waters for ship activity within 50 miles from shore gathered via sensors the International Maritime Organization's International Convention for the Safety of Life at Sea), or others.

Source Features can be the names and data associated with the smallest grain of data defined by a source. Examples that are associated with those given previously include nimo, portname, and others.

Supervised Learning can be predictive analytic modeling. It can include the training, testing, tuning, and use or implementation of algorithms that produce a predicted state based on one or more target labels and may also include many model influencer features and any measure of errors applicable on applications for a predicted case and an actual outcome. Regression, binary classification, multiclass classification, and time series based forecasting may be primary algorithm families.

Unsupervised Learning can be descriptive analytic modeling. It can include training, testing, tuning, and use or implementation of algorithms that produce a predicted state based on one or more target labels and many model influencer features and, in general, may have measures of error applicable on a model basis that are not associated with an actual outcome. Clustering, collaborative filtering, matrix factorization, and association rules may be primary algorithm families.

User Domain can be a personal sandbox of sources, related domains, schema(s), and rules built from importing external sources and domains. Ontologies imported into domains such as RDF, OWL, or JDBC database schemas may not necessarily include concepts to define pragmatics. For example, ARFF can support relationships of names in data to a relation alias and define a datetime pattern to apply to render a timestamp, but it may not support higher level abstractions of joints between data relations and relationships. Insight Producers can import and curate sources and domains, so rules, insights, and solutions can be generated by the system, its administrators, and users.

Visual Analytics can be the collection of workflow analytics, declarative rendering specifications, and related mapping of visual syntax to interactions. For example, it can show a port prediction model output as a map of ships, ports, and routes and any subsequent visual analytics available by user or system interaction with ships, ports, and routes.

Visual Analytic Ontology can include an extension of the Analytic Domain that is specific to Visual Analytic interactions.

Workflow can be a set of related tasks designed as a reusable component of a domain's rules.

Workflow Analytics can be any insights created by a workflow that do not prescribe a specific visual rendering.

To briefly elaborate on Gestalt Modeling, various goals may include: 1) defining generic ways to assemble metamodels; 2) supporting the use of third party algorithms with the Metamodel infrastructure; 3) providing scale when the algorithm may not have been designed with a DSL primitives, such as R, Python, WEKA, and others; 4) ensuring Auto-Curious can perform various tasks with a metamodel; 5) ensuring system engine(s) have various interactions with metamodels; and 6) others.

Defining generic ways to assemble metamodels can further include defining component models such as one or many logically related algorithms and combining with rules into standard complex models. Techniques for defining these assemblies include ensemble models, model averaging and other aggregation schemes, voting systems, bagging, boosting, multiple resolution models, routing by model, partitioning models, and others.

Ensuring Auto-Curious can perform various tasks with a metamodel can include: planning branch executions based on simpler predictive analytic output, profiles of data and existing goal hierarchies; comparing lift and other analytic metrics of the new outputs; providing a surface for publishers to build metamodels; and others.

Ensuring the system engine(s) have these interactions with metamodels can include: support of any “Big Data” operations; management of any scale-out Data Science necessary; allowing streams, graphs, and tables to train using “empty” metamodels or metamodel templates; allowing streams, graphs, and tables to predict using existing metamodels that were made in Auto-Curious; and others.

Ensuring the system engine(s) have these interactions with metamodels can include: support of any “Big Data” operations; management of any scale-out Data Science necessary; allowing streams, graphs, and tables to train using “empty” metamodels or metamodel templates; allowing streams, graphs, and tables to predict using existing metamodels that were made in AutoCurious; and others.

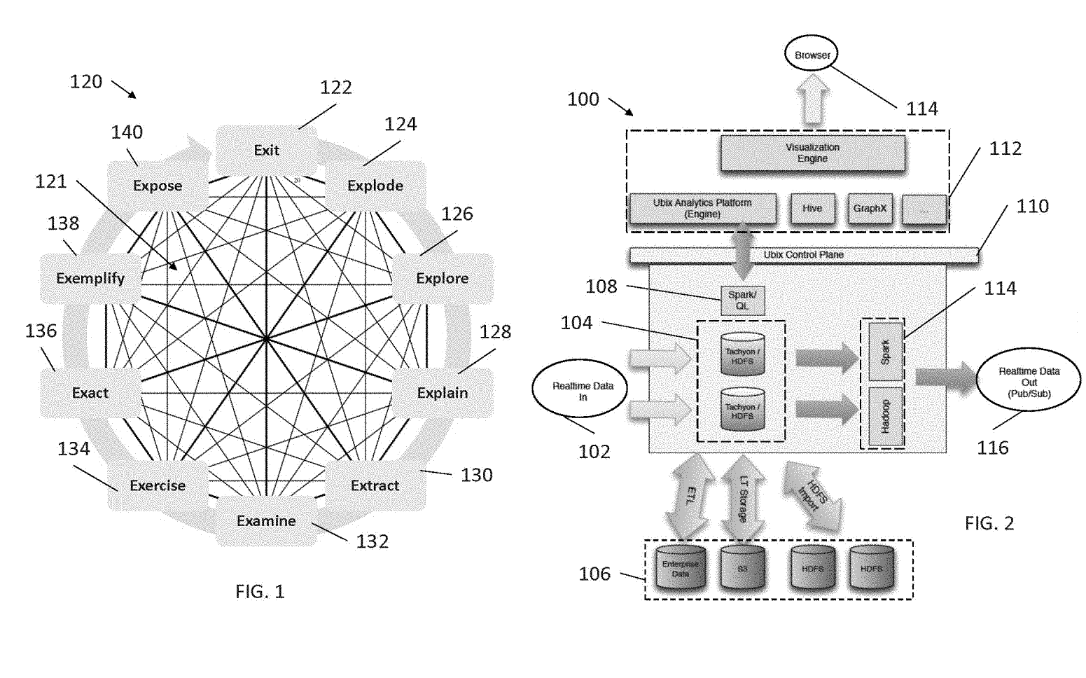

FIG. 1 shows an example embodiment of a high-level machine learning task mapping to an autonomous learning systems nudge types diagram 120. Data science workflows fall into two general categories, discovery and inquiry. As such, steps 122, 124, 126, 128, and 130 can fall into a discovery category, while steps 132, 134, 136, 138, 140 fall into an inquiry category. Most data science workflows are a combination of these component workflows, where discovery has a solution that involves deterministic calculations and does not result in building of any supervised or unsupervised learning models. For inquiry on the other hand, supervised or unsupervised learning models are the core of analytic content.

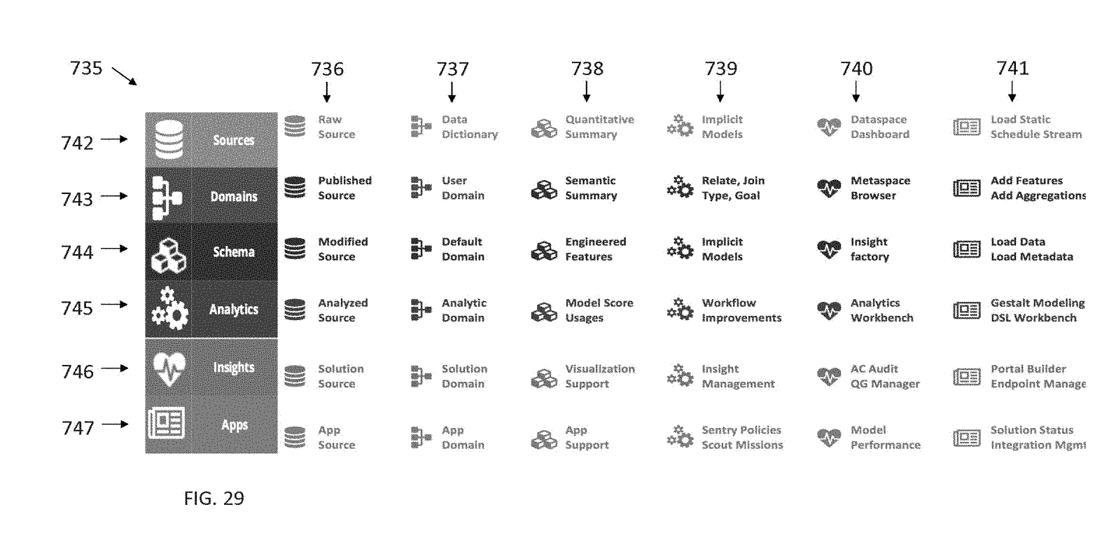

In the example embodiment, an iconography that can be used to represent the six nudge types and include, sources, schema, domains, analytics, insights, and apps, and are discussed in more detail with respect to FIG. 29. These have relationships to the detailed listed of generic data science workflows. Source, domain, and schema nudge types have hard boundaries as they are tied directly to physical storage and generation of analytic context. Apps, insights, and analytics (or rules) have more overlaps as they represent different but related facets of interaction with the products of machine learning workflows. In a sense of deliverables to Insight Workers, there is a general progressive flow of complexity, but as shown a network or web 121 relationship indicates that at any time in the process, data science workflows may need to revisit earlier or move to future steps in a directed acyclic graph view of a machine learning workflow.

As mentioned above, various steps can be grouped together as an interaction between a physical architecture and a logical architecture underlying the system data science language. Explode step 124 and explore step 126 can be a source group. Explain step 128 can be a Rules group. Extract step 130 can be a Schema group. Examine step 132 can be an analysis group. Exercise step 134, exact step 136, and exemplify step 138 can be an Insight group. Expose step 140 and Exit step 122 can be a Study group.

An exit step 122 can include developing a monitoring schedule with one or more goals or other success metrics. These can include balancing or weighing speed versus accuracy. Next, an explode step 124 can include loading with basic profiling and draft ML models for discovery. Next, an explore step 126 can include visualizing, filtering, and grouping results. Next, an explain step 128 can include add relationships, defining domains, creating or modifying friendly names, creating or modifying annotations as required, and defining or modifying constraints. Next, an extract step 130 can include shaping and aggregating; bin/normalize/compressing; imputing, cleaning, and handle nulls; performing calculations; sampling; and others. An examine step 132 can include modelling at least one family, techniques, and feature selection. An exercise step 134 can include initial training, monitoring and measuring raw performance, determining or adjusting model content, and performing visualizations over data. An exact step 136 can include performance analytics, cross-validation, and RL input to model. An exemplify step 138 can include overkill analytics tuning, meta-models, adding business rules, model behavior changes such as cutting scores, and External ML. An expose step can include integration and deployment, AB testing in the field, applying the model to other datasets, larger test applications of data parameterized workflow, and validation and feedback loop.

FIG. 2 shows an example embodiment of an idealized partial system architecture diagram 100. In the example embodiment, real time data 102 can be received by the system and stored in one or more databases 104 in non-transitory computer readable media. In some embodiments these can be Tachyon HDFS databases. The system can also exchange data with other databases 106 and systems such as enterprise data via extraction, transform, load (ETL), S3 data via long term (LT)-Storage and Hadoop Distributed Filing System (HDFS) data via HDFS importing. A Spark/Query Language (QL) sub-system 108 can exchange data over a system control plane 110 with a system layer 112 analytics platform, such as an engine that can interact with Hive, GraphX, and other libraries before using a visualization engine to prepare and distribute results for display of information to a user via a browser 114. Data in the system can also be used by an internal sub-system 114 of combined or separate engines Hadoop or Spark to export real time data 116 out of the system via Pub/Sub.

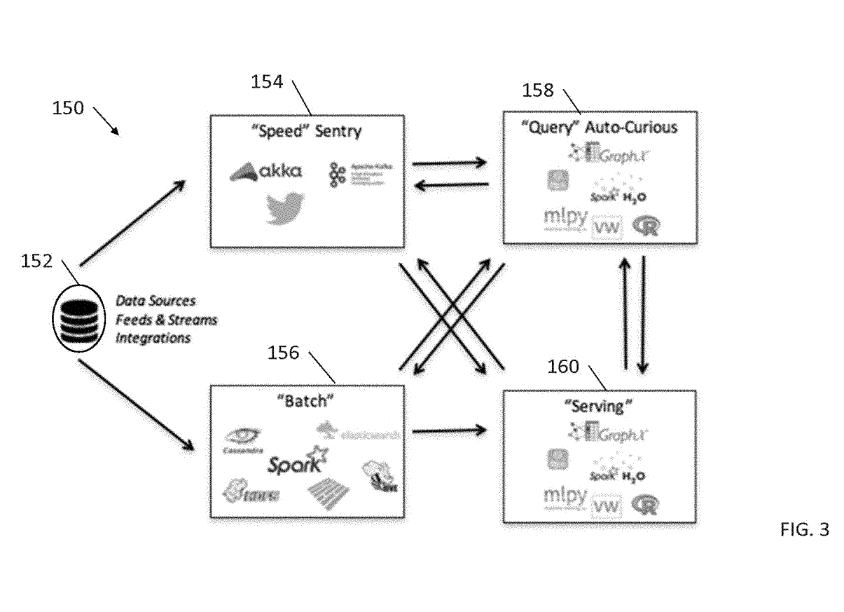

FIG. 3 shows an example embodiment of a Lambda Big Data architecture and its mapping to a physical architecture diagram 150. As shown in the example embodiment, one or more data sources, feeds, streams, or integrations 152. This type of data-processing architecture can handle massive quantities of data by taking advantage of both batch- and stream-processing methods balance latency, throughput, and fault-tolerance by using batch processing 156 to provide comprehensive and accurate views of batch data 160, while simultaneously using the speed of real-time stream processing with speed sentry module 154 to provide queried views of online data. Speed sentry module 154 and batch module 156 can exchange data with a “query” Auto-Curious module or system 158, while batch module can send data to or have data retrieved from it by a “serving” module 160. Speed sentry module 154 can also exchange data with serving module 160. Additionally, query module 158 can exchange data with serving module 160 and can be joined before presentation.

Examples of speed sentry modules 154 or submodules can include Twitter, akka, and Apache Kafka. Examples of batch modules 156 or submodules can include Cassandra, HDFS, Spark, elasticsearch, and Hive. Examples of query modules 158 or submodules can include GraphX, mlpy, VW, Spark H₂O, and R. Examples of serving modules 160 or submodules can include GraphX, mlpy, Spark H₂O, and R. Examples of outbound sentry modules 162 or submodules can include cloudera, Apache Camel, SourceThought, alteryx, pentaho, and RabbitMQ.

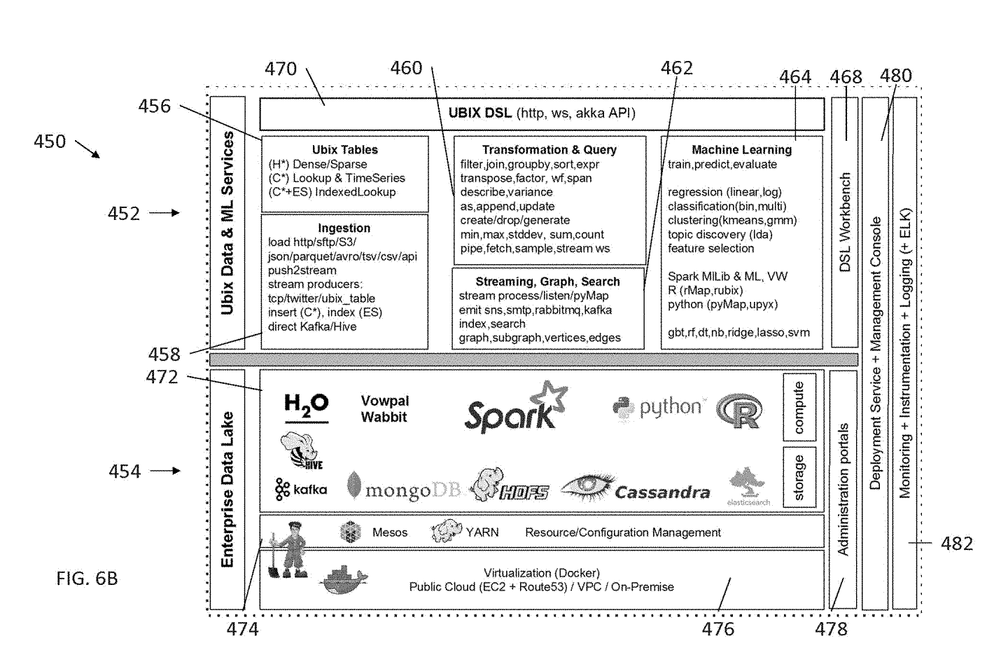

The systems operated by a Data Science Language (DSL) can provide all syntax necessary to accomplish tasks for which data scientist normally have to build significant amounts of “glueware” or software that simply connects Big Data, Data Science and other tasks in order to complete a machine learning workflow. Details of mapping of subsystems used in an example Lambda architecture are further discussed herein for more explanation (see description of FIG. 6B).

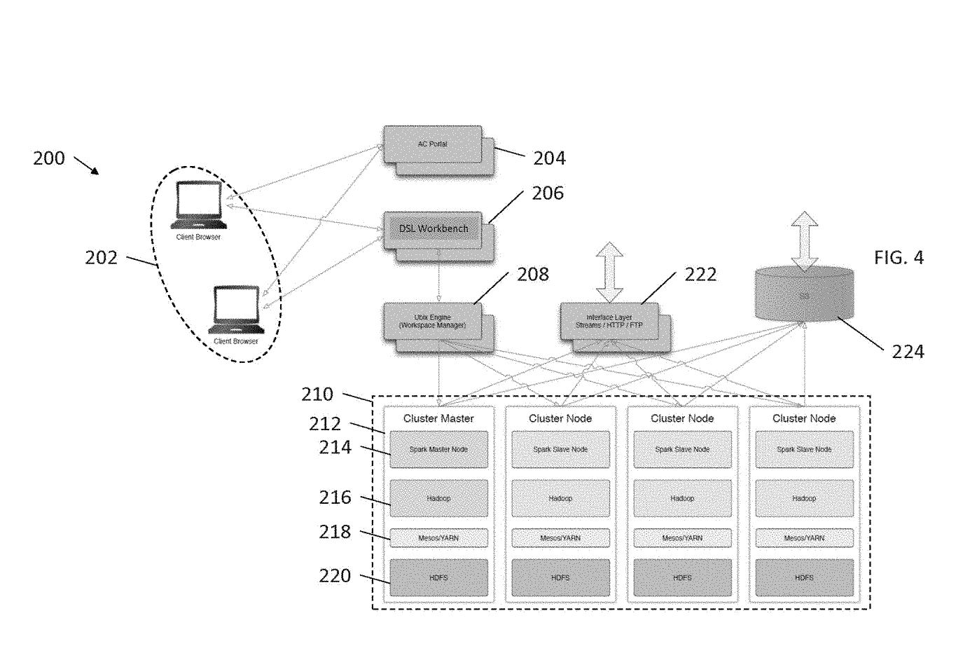

FIG. 4 shows an example embodiment of system architecture diagram 200. In the example embodiment, client browsers on client user devices 202 can access an AC Portal 204 and a DSL Workbench portal 206. DSL Workbench portal 206 can exchange data with a workspace manager or other system engine 208 which can exchange data with one or more of various cluster nodes 210, one of which may be a cluster master 212. Each node of 210 can have a Spark node 214 which may be master or slave depending on its configuration. Each node can also have Hadoop 216, Mesos/YARN 218, and HDFS 220. Nodes 210 can also interact with Interface Layer 222 via Stream protocol, HTTP, and FTP to enable access to external storage such as S3 224.

Mobile applications, mobile devices such as smart phones/tablets, application programming interfaces (APIs), databases, social media platforms including social media profiles or other sharing capabilities, load balancers, web applications, page views, networking devices such as routers, terminals, gateways, network bridges, switches, hubs, repeaters, protocol converters, bridge routers, proxy servers, firewalls, network address translators, multiplexers, network interface controllers, wireless interface controllers, modems, ISDN terminal adapters, line drivers, wireless access points, cables, servers, and others equipment and devices as appropriate to implement the methods and systems described herein are contemplated.

User devices in various embodiments can include smart phones, phablets, tablets, laptops, desktops, video game consoles, wearable smart devices, and various others which have one or more of at least one processor, network interface, camera, power source, non-transitory computer readable memory, speaker, microphone, input/output interfaces, touchscreens, displays, operating systems, and other typical components and functionality that are operably coupled to create a device that provides functionality to perform the processes and operations for the subject matter disclosed herein.

As contemplated herein, one or more network servers that is communicatively coupled to a network can include applications distributed on one or more physical servers, each having one or more processors, memory banks, operating systems, input/output interfaces, power supplies, network interfaces, and other components and modules implemented in hardware, software or combinations thereof as are known in the art. These servers can be communicatively coupled with a wired, wireless, or combination network such as a public network (e.g. the Internet, cellular-based wireless network, or other public network), a private network or combinations thereof as are understood in the art. Servers can be operable to interface with websites, webpages, web applications, social media platforms, advertising platforms, public and private databases and data repositories, and others. As shown, a plurality of end user devices can also be coupled to the network and can include, for example: user mobile devices such as smart phones, tablets, phablets, handheld video game consoles, media players, laptops; wearable devices such as smartwatches, smart bracelets, smart glasses or others; and other user devices such as desktop devices, fixed location computing devices, video game consoles or other devices with computing capability and network interfaces and operable to communicatively couple with the network.

In various embodiments, a server system can include at least one end user device interface and at least one system user device interface implemented with technology known in the art for facilitating communication between customer and system user devices respectively and the server and communicatively coupled with a server-based application program interface (API). API of the server system can be communicatively coupled to at least one web application server system interface for communication with web applications, websites, webpages, websites, social media platforms, and others. The API can also be communicatively coupled with one or more server-based databases and other interfaces. The API can instruct databases to store (and retrieve from the databases) information such as user information, system information, results information, raw data information, or others as appropriate. Databases can be implemented with technology known in the art, such as relational databases, object oriented databases, combinations thereof or others. Databases can be a distributed database and individual modules or types of data in the database can be separated virtually or physically in various embodiments. Servers can also be operable to access third-party databases via the network in various embodiments.

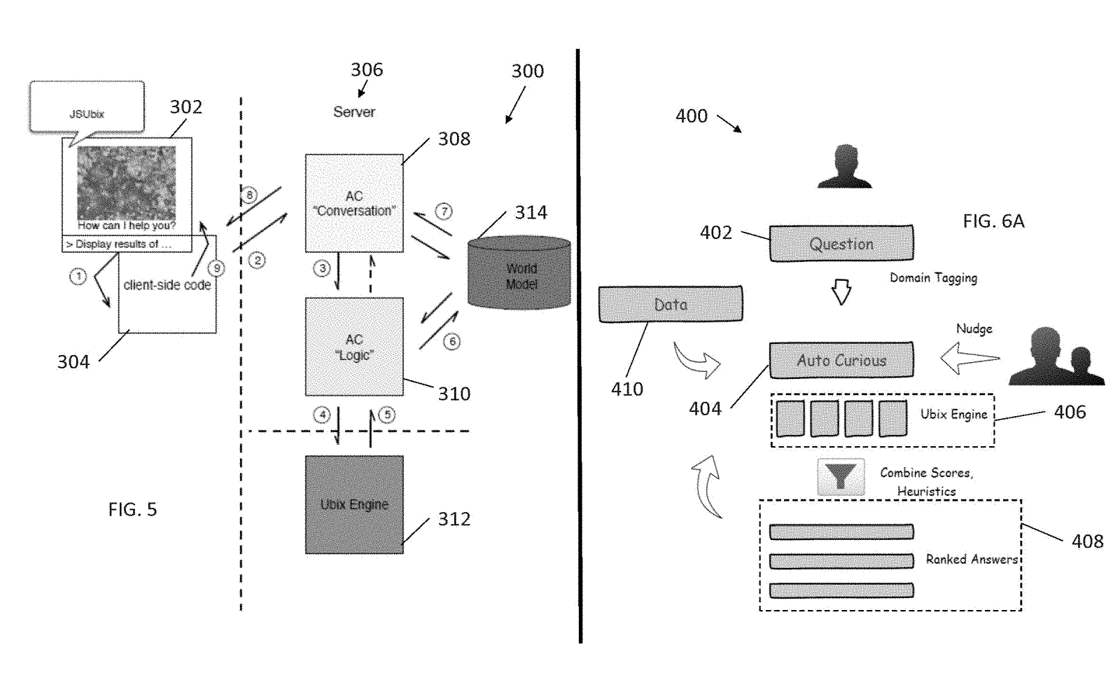

FIG. 5 shows an example embodiment of a data flow diagram 300. In the example embodiment a user interface 302 on a user interface device can initially prompt a user to enter an inquiry into the system via a client-side code 304. This can be transmitted to a server 306 to create a set of user and system interactions referred to as an AC Conversation 308. The AC Conversation is mediated using AC logic 310. After this, a system engine 312 including modules and processors can return results that are further processed by AC logic 310. The AC logic module 310 can use a World Model from a database 314. The AC World Model 314 can be characterized as an analytical knowledge base. Thereafter interaction can continue until the AC conversation 308 returns results that may be run through client-side code 304 for display to the user and further user interaction.

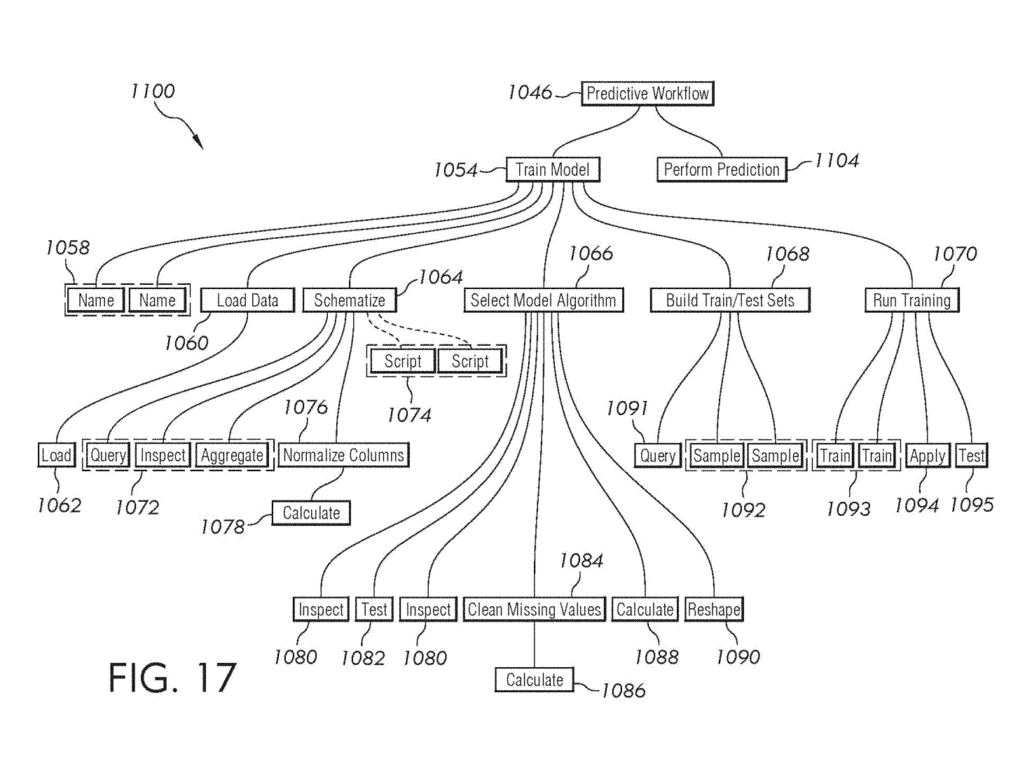

FIG. 6A shows an example embodiment of a logical system operation diagram 400. In the example embodiment, a user can ask a question 402 via a user interface of a user device that is domain tagged and sent to an auto curious module 404 by transmitting it to the system via a network. The question can be in the form of natural language or packaged as more complex user interface interactions. The auto-curious module 404 can also receive data 410 and nudges (AC user inputs received from other users that have reviewed information from the first user) to be processed using a system engine 406 that can combine scores and heuristics in order to output ranked answers 408 to be returned to the auto curious module 404. Nudges are further discussed herein for more explanation (see description of FIG. 17).

FIG. 6B shows an embodiment of a more detailed logical architecture 450 of a system platform. As shown in the example embodiment, system data and machine learning services 452 and enterprise data lake 454 can be major system components.

As shown, system data and ML services 452 can include system tables 456; ingestion 458; transformation and query 460; streaming, graph, and search 462; machine learning 464; DSL workbench 468; system DSL 470; and others. Examples of system tables 456 can include H* Dense/Sparse, C* Lookup and TimeSeries, C*+ES Indexed Lookup, and others. Ingestion 458 can include load http/sftp/S3/json/paquet/av ro/tsv/csv/api, push2stream, stream producers: tcp/twitter/ubix_table, insert C*, index ES, direct Kafka/Hive, and others. Transformation and query 460 can include filter, join, groupby, sort, expr, transpose, factor, wf, span, describe, variance, as, append, update, create/drop/generate, min, max, stddev, sum, count, pipe, fetch, sample, stream ws, and others. Streaming, graph, search 462 can include stream process/listen/pyMap, emit sns, smtp, rabbitmq, kafka index, search, graph, subgraph, vertices, edges, and others. Machine learning 464 can include train, predict evaluate, regression in linear or log, classification in bin or multi, clustering in kmeans or gmm, topic discovery in Ida, feature selection, Spark MILib and ML, VW, R in rMap and rubix, python in PyMap, upyx, gbt, rf, dt, nb, ridge, lasso, svm, and others. System DSL can include http, ws, akka API, and others.

Also, as shown enterprise data lake 454 can include various modules such as storage and computation module 472, resource and configuration management module 474, virtualization module 476, administration portals 478, and others. Storage and computation module 472 can use H 2 O, Vowpal Wabbit, Spark, python, R, kafka, mongoDB, HDFS, Cassandra, elasticsearch, and others. Resource and configuration management module 474 can include Mesors, YARN, and others. Virtualization module 476 can be a docker and can include a public cloud such as EC@ and Route 53, VPC, On-Premise, and others.

Further, a Deployment and management console 480 and a monitoring, instrumentation, logging, and ELK module 482 can be provided.

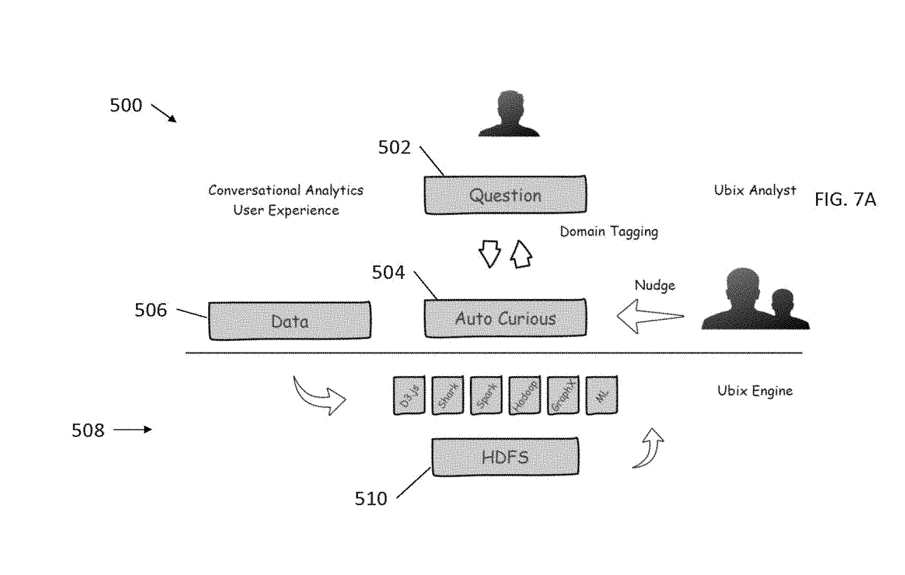

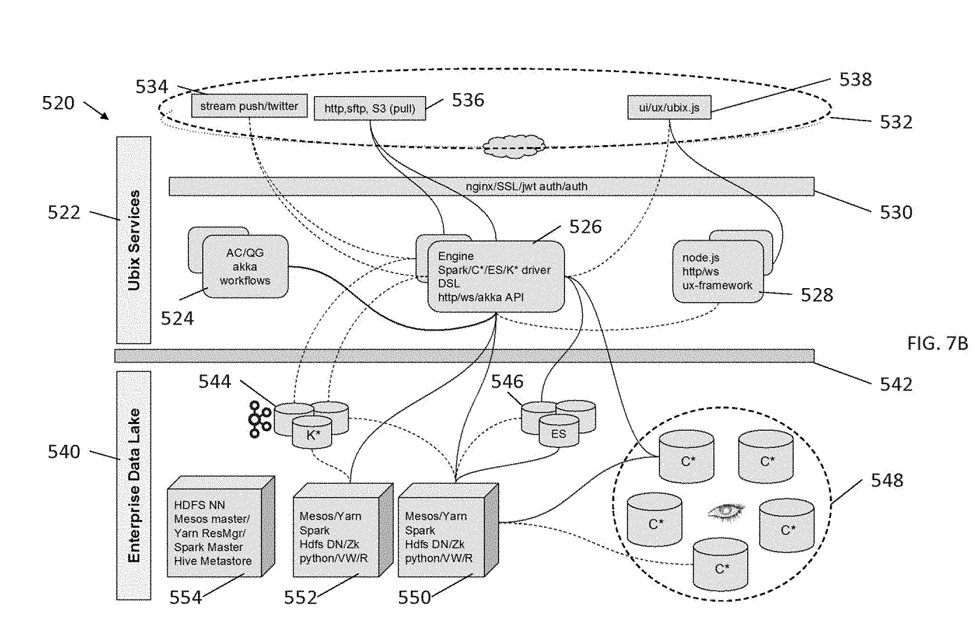

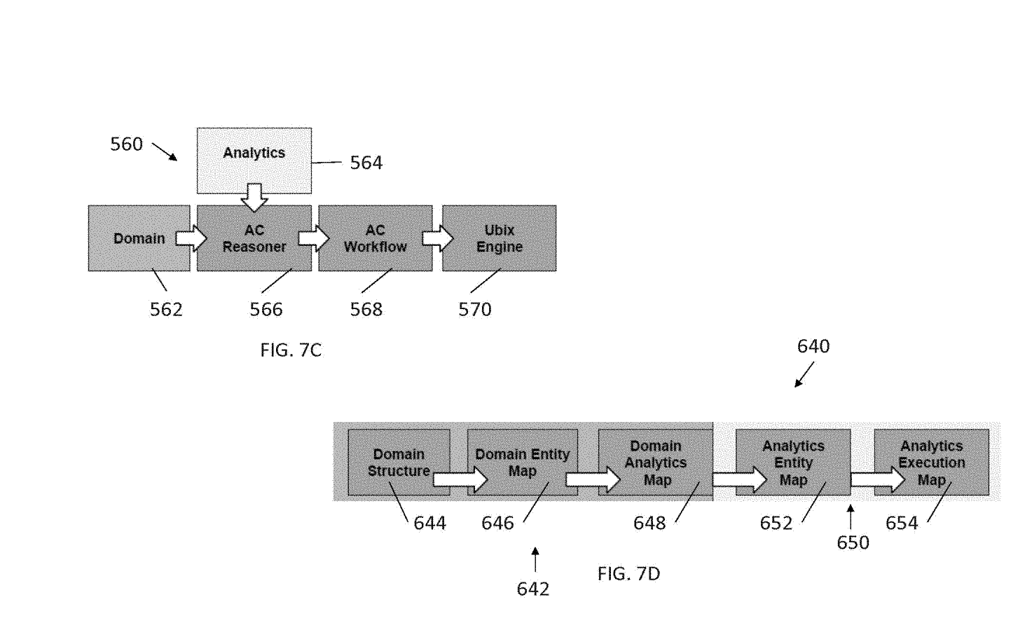

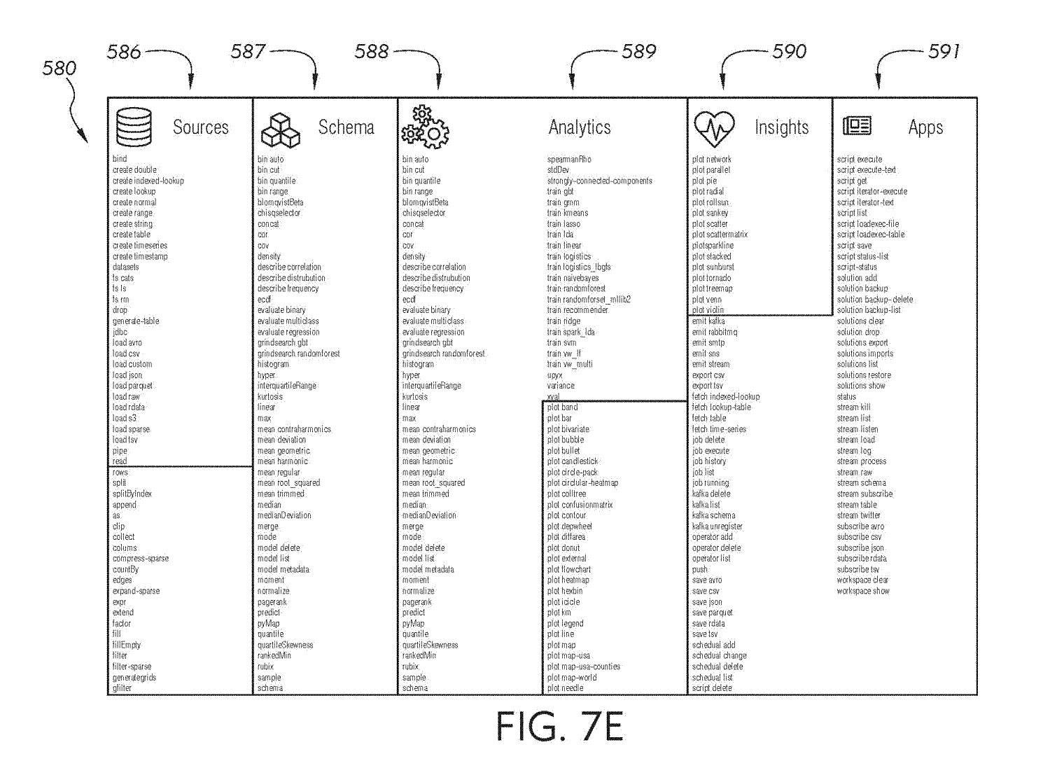

FIG. 7A shows an example embodiment of a physical system operation diagram 500. In the example embodiment a user can ask one or more questions 502 by entering them into a user interface of a user interface device that are domain tagged and processed by auto curious 504. Auto curious 504 can receive or otherwise access data 506 nudges from system or other analysts and interact with a system engine 508 including D3. js, shark, spark, Hadoop, GraphX, ML which can also receive or access data 506. HDFS can then return results 510.

FIG. 7B shows an example embodiment diagram 520 of a more detailed physical architecture of a system platform. As shown, this can include a system services side 522 and an enterprise data lake side 540. System services side 522 can include AC/QG akka workflows module 524, which can be coupled with Engine 526 that can include Spark/C*/ES/K* driver, DSL, http/ws/akka API, and others. Additionally, node.js, http/ws, and ux/framework module 528 can be coupled with Engine 526. A nginx/SSL/jwt auth/auth layer 530 can allow ENGine to couple with modules 532, which can include stream push/twitter module 534 and http, stfp, S3 (pull) module 536, in addition to uil/ux/ubix.js module 538. Module 538 can also be coupled to module 528. Engine 526 of system services side 522 can also be coupled across layer 542 to enterprise data lake side 540, such as ES (Elastic Search—distributed search services) database(s) 546, K* (Kafka—distributed streaming services) database(s) 544, and C* (Cassandra—low latency noSQL database) database(s) 548. Both databases 546 and 548 can be coupled with module 550, which can include a Mesos/Yarn, Spark, Hdfs DN/Zk, puthon/VW/R, which Engine 526 can be coupled with as well. A separate module 552, which can include a Mesos/Yarn, Spark, Hdfs DN/Zk, puthon/VW/R, can also be coupled with Engine 526, and databases 544. Also included on enterprise data lake side 540 can be a module 554 that includes HDFS NN, Mesos master/Yarn ResMgr/Spark Master, Hive Metastore and others.

FIG. 7C shows an example embodiment of the integration of different aspects of analytic content into a logical system operations diagram 560 of an auto-curious module. As shown, Domain 562 and Analytics 564 can be fed to an AC reasoner 566, which can then produce an AC workflow 568 that is processed by a System engine 570.

FIG. 7D shows an example embodiment of a detailed integration points of different tasks and analytic content into an abstract logical system operations diagram 640 of the auto-curious module. Users add Source nudges to define first the most basic domain structures, such as columns, rows, and raw domain names 644. Based on additional layers of abstraction of user domain specific “jargonization” into industry specific terms and semantic meaning, users then add Domain type nudge to define domain entities ad a domain entity map 646. A combination of Domain and Schema nudge types will then form the raw data features whose analytic context and content will be available for mapping to Analytic Domain features of metaspace points as an analytics entity map 648. Once Auto-curious has a complete metaspace points mapped, it can persist a user domain independent representation of the metaspace in a semantic index for an analytics entity map 654. Auto-curious can resolve the semantics contained in the index of analytic entities and make suggestions on overall behaviors of analytics to execute and collect information on the features of the metaspace that users reinforce as novel or strengthening existing models in reinforced learning models as an analytics execution map 654.

In general, domain structure 644 can include business entities, a relationship graph, and others. Domain entity map 646 can include synonyms, hierarchies, column roles, table relationships, a semantic map, and others. Domain analytics map 648 can include business rules, logical constraints, analytic priorities, derived features, semantic facets, and others. Analytics entity map 652 can include transform libraries, data type usage, accretive workstreams, semantic index, and others. Analytics execution map 654 can include goal planning, inferred metadata, parallel execution, management, machine-learning (ML) tasks, persistence, stream execution, data operations, feature index, and others.

FIG. 7E shows an example embodiment diagram 580 of a mapping between command types in a system data science language and machine learning process architecture. As shown in the example embodiment, various groupings, as described with respect to FIG. 1, can be used, including sources group 586, schema group 587, rules group 588, analytics group 589, insights group 590, apps group 591, and others.

To elaborate, as shown, the example embodiment of a mapping between the types of commands in a Ubix Data Science Language and the machine learning process architecture diagram 580. Source nudges define tasks in a machine learning workflow that directly influence the physical contract and format of the streaming data in motion or static data in batch or incremental loads of source group 586. Domain nudges can directly influence mappings of the Analytic Domain and do not have direct physical operations on any data, but can map to one of the other nudge types for a related task. Schema nudges can change the analytic context for raw data where new metaspace points will be added with the same or different levels of detail, sometimes with an aggregation into smaller rowsets or an expansion into larger number of cases of schema group 587. Analytics nudges provide direct statistical and machine learning algorithm related analytic content of data schematized by Domain, Schema and/or Source nudges in 588. Insight nudges provide a visual analytic workflow that may combine with Schema nudges are tasks in order to construct a Domain specific rendering through Auto-curious meta-perception that can be server to users and provide feedback on insight recognition in group 590. App nudges help data scientists send data outside of a Data Science Language system for application integrations and other external analytic workflows in group 591.

Additionally, sources group 586 can include bind, create double, create indexed- lookup, create lookup, create normal, create range, create string, create table, create timeseries, create timestamp, datasets, fs cat, fs ls, fs rm, drop, generate-table, jdbc, load avro, load csv, load custom, load j son, load parquet, load raw, load rdata, load s3, load sparse, load tsv, pipe, read, and others.

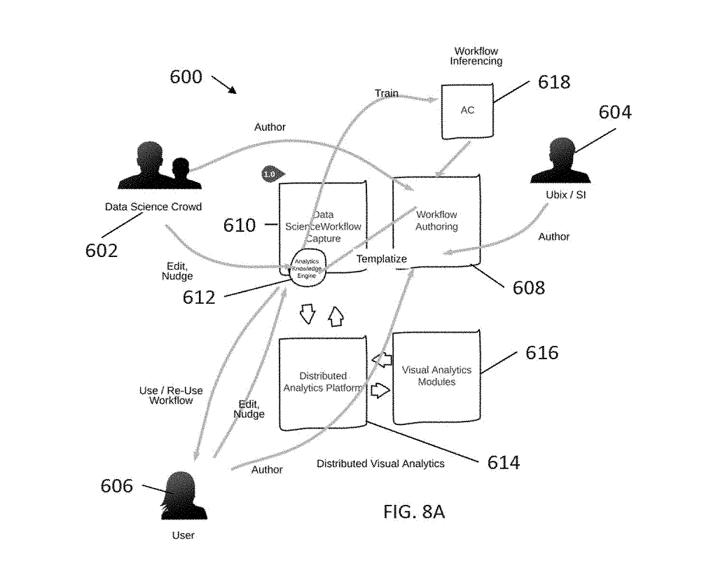

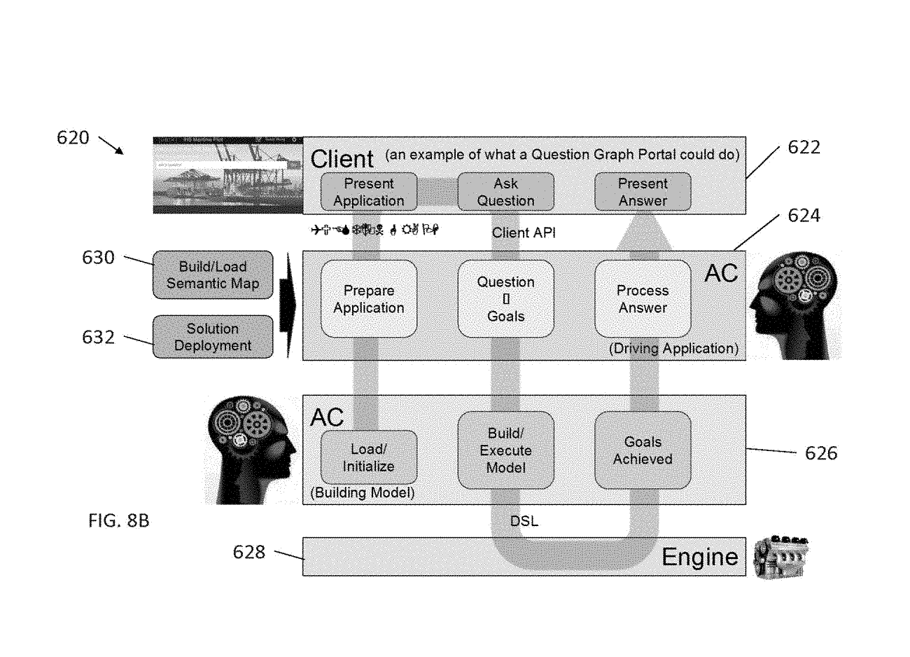

FIG. 8A shows an example embodiment of a system architecture diagram 600. In the example embodiment, Data Scientists 602, System Administrators 604, and User personas 606 are shown interacting with the AC system. System administrators 604 can perform workflow authoring 608 and other administrative tasks. These can be templatized for data science workflow capture 610 which can perform analytics knowledge engine processing 612. This can be communicatively coupled with one or more distributed analytics platforms 614 that can be coupled with one more visual analytics modules 616. Users 606 can also perform workflow authoring and can edit and nudge workflows processed by the analytics knowledge engine 612 whose workflows can be used and re-used by users 606. A nudge can be a user 606 interaction with the system that is needed to inform AC's workflow decision making process. Data scientists 602 can edit and nudge workflows using the analytics knowledge engine 612 and can also author workflows directly. Normally users 606, such as a business analyst, can interact with the system through nudges. Data scientists 602 may edit AC workflows directly via the AC Workflow authoring module 608. Both user 606 nudge input and data scientist 602 authoring can be used to assist the Analytics Knowledge Engine 612 to train models that can perform data science workflow inferencing through AC 618, which can in turn influence workflow authoring module 608.

FIG. 8B shows an example embodiment of a high-level Solution Architecture 620. As shown in the example embodiment, a client portion 622, AC driving application portion 624, AC model building portion 626, and Engine 628 can all be utilized when building solutions. As shown, initially a semantic map can be built or loaded in 630 and solution deployment 632 can be employed at AC driving application portion 624 to prepare an application. Additionally, AC model building portion 626 can load or initialize the model for AC driving portion 624. Next, the prepared application can be sent to the client portion 622 for presentation and a question may be asked at client portion 622. Question and goals can be set up by AC driving application portion 624, before AC model building portion 626 builds and executes a model and sends it via DSL to Engine 628 for processing. After processing and when goals have been achieved in AC model building portion 626, AC driving application portion 624 processes the answer and sends to client portion 622 for presentation. The process can be repeated or refined at this point, if more questions are asked.

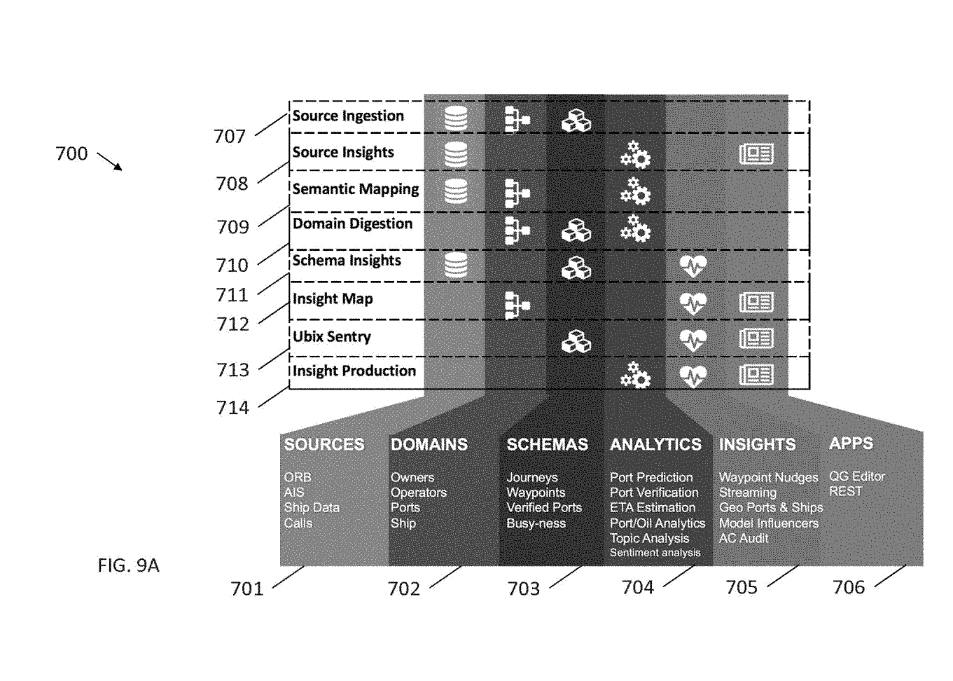

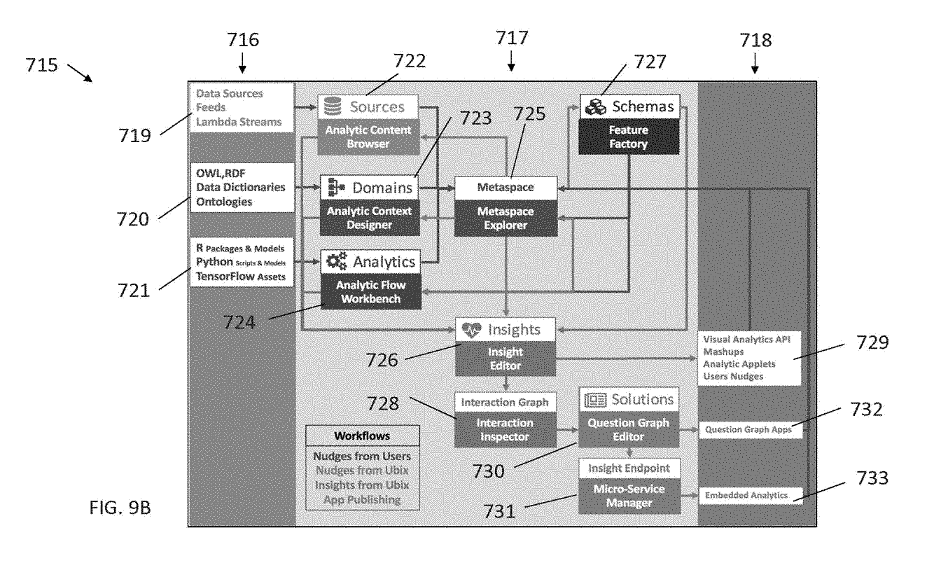

FIG. 9A shows an example embodiment diagram 700 of semantic relationships in a user's domain. As shown, the example embodiment can be represented as a system architecture diagram that includes analytic content mapped to analytic domain ontologies for user focused analytic tasks. Here, sources 701, domains 702, schemas 703, analytics 704, insights 705, and apps 706 may be used, applied, or accessed for various functions. These functions can include source ingestion 707, source insights 708, semantic mapping 709, domain digestion 710, schema insights 711, insight maps 712, system sentry 713, insight production 714, and others.

As shown in the example embodiment, source ingestion 707 can include application of data from sources 701, domains 702, and schemas 703. Source insights 708 can include application of data from sources 701, analytics 704, and apps 706. Semantic mapping 709 can include application of data from sources 701, domains 702, and analytics 704. Domain digestion 710 can include application of data from domains 702, schemas 703, and analytics 704. Schema insights 711 can include application of data from sources 701, schemas 703, and insights 711. Insight map 712 can include application of data from domains 702, insights 705, and apps 706. System sentry 713 can include application of data from schemas 703, insights 705, and apps 706. Insight production 714 can include application of data from analytics 704, insights 705, and apps 706.

Sources 701 in the example embodiment include ORB, AIS, Ship Data, and Calls. Domains 702 in the example embodiment include Owners, Operators, Ports, and Ships. Schemas 703 in the example embodiment include Journeys, Waypoints, Verified Ports, and Busy-ness. Analytics 704 in the example embodiment include Port Prediction, Port Verification, ETA Estimation, Port/Oil Analytics, Topic Analysis, and Sentiment Analysis. Insights 705 in the example embodiment include Waypoint Nudges, Streaming, Geo Ports and Ships, Model Influencers, and AC Audit. Apps 706 in the example embodiment include QG Editor and Rest.

An example of a complex and real-world data science workflow is the IHS multiclass classification problem of determining the destination ports of oils vessels. The workflow has historical data that users can understand better and generate analytic content by using Source nudges 701. Users can enhance semantic understanding through friendly labels and relationships that Auto-curious can use to find analytic domain entities that map to their analytic content 702. In order to apply semantic suggestions for the machine learning workflow, aggregations, unsupervised clustering and multi-resolution feature engineering by Schema nudges 703. Based on the metaspace pints generated on additional schematization, Auto-curious can review the analytic content and context and start building machine learning models by Analytic nudges 704. The details of the model performance, resource optimization and all audit features, including visual analytic workflows that answer specific questions not stored in the exact format needed by Insight nudges 705. Users can then navigate those results, recognize insights and curate their experience into a question graph portal, headless machine learning service for applying to new streaming data or other analytic content and content consumption via App nudges 706.

In order to optimize performance, storage and extensibility, some physical structures will need to store semantic indexes in different formats as metaspace nudge composite types. These types of composite nudge types can include different combination of the six nudge types 79017906) in different combinations (707-714).

FIG. 9B shows an example embodiment of analytic content inputs and outputs mapped to nudge types, general workflows and feedback loops associated with user controls in a high-level abstract system architecture diagram 715, including semantic relationships in a user's domain. To elaborate, it includes processing flows that can occur for analytic content inputs 716, through the system 717, and their outputs 718. Inputs and outputs shown are mapped to nudge types, general workflows, and feedback loops associated with user controls. Here, inputs 716 can include source inputs 719, domain inputs 720, and analytics inputs 721.

Analytic context comes most from Source nudges applied to data at rest and in motion and will have some raw form 719. Analytic context is derived from past analytic tasks in several formats. Some form a language, jargon or other user domain dialect to which users apply Domain nudges to construct a user domain representation and begin finding suggestions of semantic mapping 720. The language may have been designed for humans, but source code from previous analytic assets can be used as inputs for NLP and other corpus analytics in order to provide additional Analytics nudges 721.

Users wishing to create autonomous machine learning workflows need several user interfaces to have an optimal view into the inner workings. Browsing analytic content, its summary statistics and other deterministic analytics and implicit models, machine learning algorithms applied in several configurations that provide an enhanced version of relationships between features that would not be visible otherwise and form a basis for performing Source, Domain and Analytics nudges from an Analytic Content Browser 722. Exchanging sematic web, importing data dictionaries, building and merging ontologies and otherwise navigating the logical layers that organize the Source data can provide a user interface for performing Domain, Analytics and Schema nudges from an Analytic Context Designer 723. Once users define domain relationships or accept suggestions derived from Source Insight visual and workflow analytic tasks, Auto-Curious will generate metaspace points that will help users understand the semantic and statistical context of their data and ontologies and perform Domain nudges from a Metaspace Explore, or Metaspace Mapper 725. Building new columns on row level expressions, new aggregate metrics based on complex join and data shaping, and viewing data through visual analytic workflows where users perform Schema, Analytics and Insight nudges can form a Feature Factory 727. A user can review Auto-Curious audit trails of workflow activity, compose new workflows from editing existing workflows, executing models, configuring model and metamodel configurations, including gestalt modeling configurations, and reviewing training or other samples when machine learning models are created and applied, including editing of R, Python, Java and DS Land perform Analytics, Schema and Insight nudge can form an Analytic Flow Workbench 724. Users can understand the raw audit of all nudges performed and the related workflows by exploring the raw analytic conversation between a subset or the entire aggregate of workflows be performed on a common solution and perform Insight, App, and Analytics nudges can form an Interaction Explorer 728. Users can curate interaction graphs and publish question graph apps 732, where any type of nudges can be performed as allow by security policies can form a Question Graph Editor 730. Additional analytics and integration accessed from REST endpoint publishing, integration with Qlik or other embedded analytic 733, and other can form a Microservice Manager 731. Users can perform Insight, Analytics and App nudges to publish ad hoc visual analytics for AP consumption, mashups, analytic applets and custom nudge apps for data collection from an Insight Factory or Editor 726.

All nudges can be executed by Ubix, or Auto-Curious running workflows in a deep Scout heavy set of simulations of workflows or by users interacting with suggestions produced by Auto-Curious, but some interactions have constraints when viewed as an overall process workflow. Ubix is understood herein to mean the system administrator or operator.

Further, source inputs 719 can be sent to or accessed by sources module 722, which can include an analytic content browser. Source inputs 719 can include data sources, feeds, Lambda streams, and others. Domain inputs 720 can be sent to or accessed by domains module 723, which can include an analytic context designer. Domain inputs 720 can include OWL, RDF, data dictionaries, ontologies, and others. Analytics inputs 721 can be sent to or accessed by analytics module 724, which can include an analytic flow workbench. Analytics inputs 721 can include R packages and models, Python scripts and models, TensorFlow assets, and others.

Data processed by sources module 722, domains module 723, and analytics module 724 can be sent to or accessed by metaspace module 725, which can include a metaspace explorer, based on user nudges or other triggers. Then, metaspace module 725 can process the data and send results back to sources module 722, domains module 723, and analytics module 724 based on nudges provided by the system or others. Additionally, metaspace module 725 can also send data to insights module 726, which can include an insight editor, and schemas module 727, which can include a feature factory, based on nudges provided by the system or others. Schemas module 727 can process data and provide results back to metaspace module 725 and to analytics module 724 based on nudges from users or others. Schemas module 727 can also send data to insights module 726 based on insights provided by the system, system administrators, or other triggers. Data processed by sources module 722, domains module 723, and analytics module 724 can also be sent to insights module 726 based on insights provided by the system, system administrators, or other triggers.

As further shown in the example embodiment, data processed by insights module 726 can be sent to or accessed by interaction graph module 728, which can include an interaction inspector, based on insights provided by the system, system administrators, or other triggers. Data processed by insights module 726 can also be sent to or used in output module 729, which can include visual analytics API, mashups, analytics applets, user nudges, and others, and can then be fed back to metaspace module 725 based on nudges from users or others.

Data processed by interaction graph module 728 can be sent to or accessed by solutions module 730, which can include a question graph editor, based on insights provided by the system, system administrators, or other triggers. Data processed by solutions module 730 can be sent to or accessed by insight endpoint module 731, which can include a micro-service manager, based on insights provided by the system, system administrators, or other triggers. Data processed by solutions module 730 can also be sent to or used by question graph maps 732 based on application publishing or other triggers, which can then be fed back to metaspace module 725 based on nudges from users or others. Data processed by insight endpoint module 731 can also be sent to or used by embedded analytics module 733 based on based on application publishing or other triggers, before being fed back to metaspace module 725 based on application publishing or other triggers.

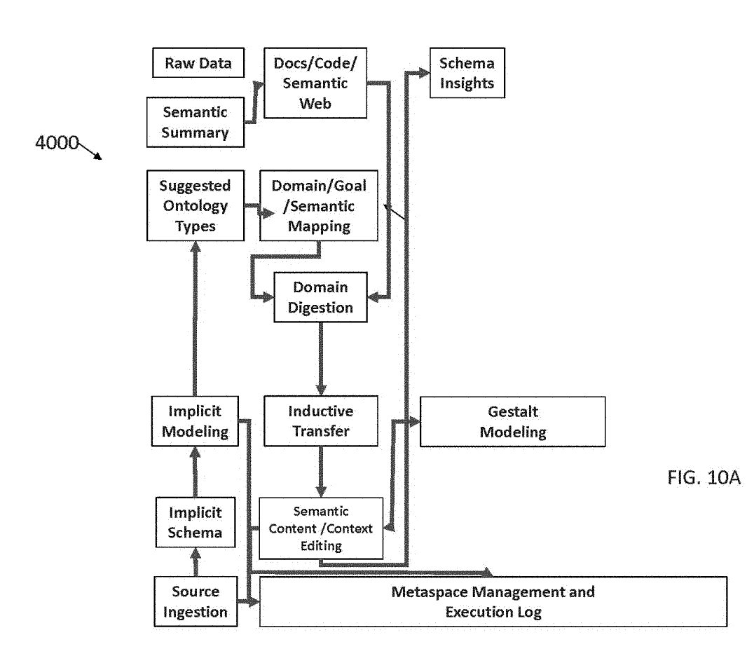

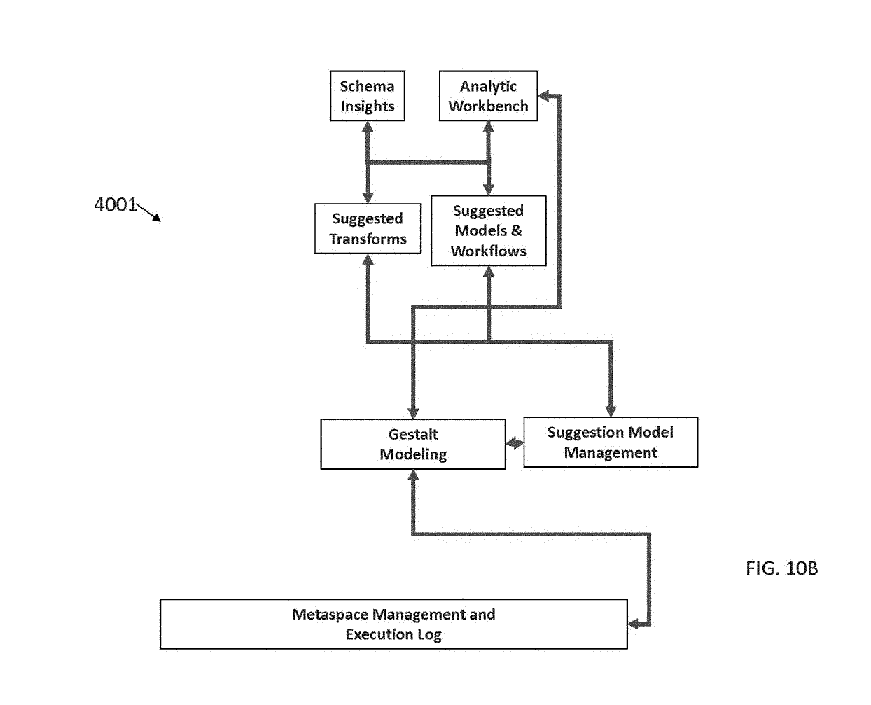

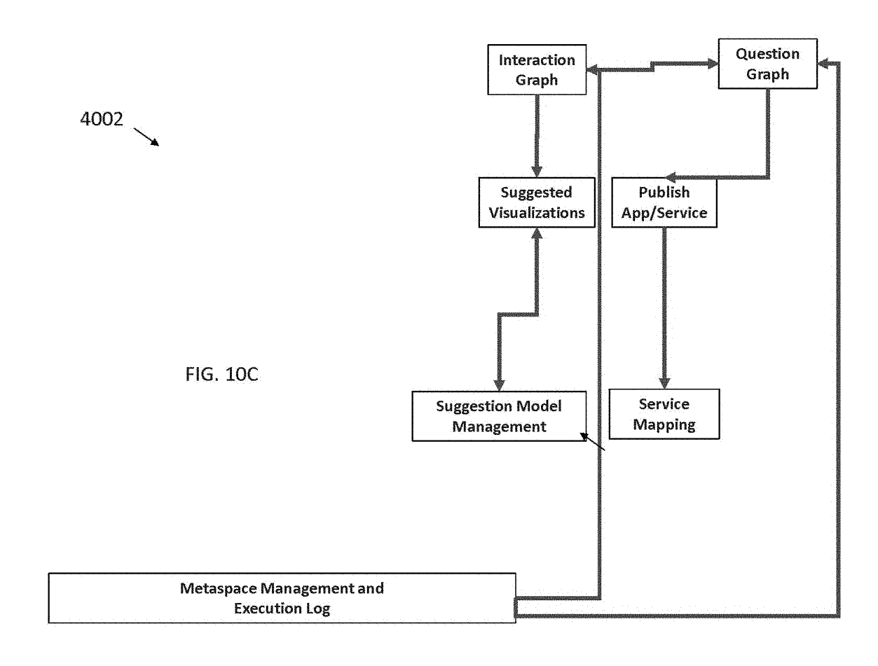

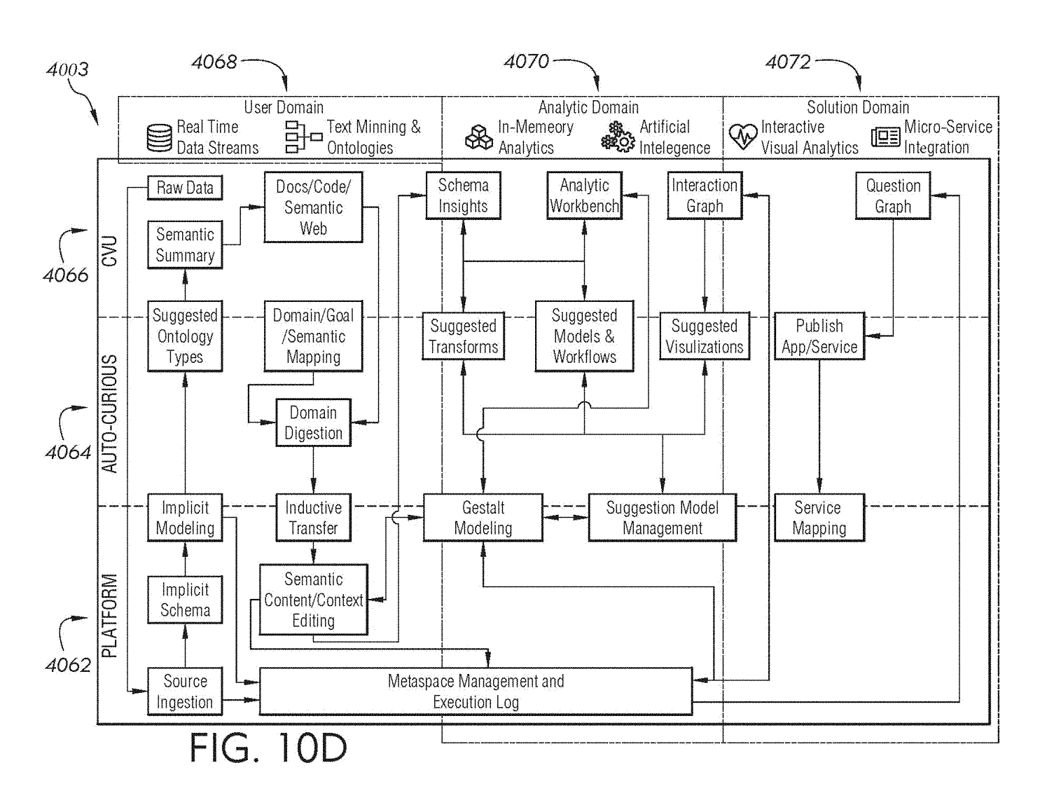

FIG. 10A shows an example embodiment of processes of ingesting source analytic assets, including analytic context from a corpus of documents and code, processing to generate metaspace points that map user domains to analytic domains and drive autonomous machine learning workflows as expressed in a high level architectural diagram 4000. Gestalt Modeling Progressive modeling as a formalized model optimization technique of iteration. Gestalt Modeling and the use of Overkill Analytics as a Scout style workflow for improving automated workflows. Gestalt Modeling and the use of Overkill Analytics as a Scout style workflow for suggesting new workflow. Gestalt Modeling and the use of Overkill Analytics as a Sentry style workflow for improving automated workflows. Gestalt Modeling and the use of Overkill Analytics as a Sentry style workflow for suggesting new workflow. Details of Sentry style workflows and its integration with rules. Details of Scout style workflows and its integration with rules.

FIG. 10B shows an example embodiment of the processes of using metaspace points to provide feedback on quantitative tasks that drive Schema nudges and Analytic nudge types, including workflows from external machine learning algorithms, to drive autonomous machine learning workflows as expressed in a high level architectural diagram 4001.

FIG. 10C shows an example embodiment of the processes of driving metaperception models from source analytic to generate visualizations and applications driven by autonomous machine learning workflows as expressed in a high level architectural diagram 4002.

FIG. 10D shows an example embodiment of the processes of ingesting source analytic assets processing to generate metaspace points that drive autonomous machine learning workflows as they relate to technology layers and nudge types as expressed in a high level architectural diagram 4003.

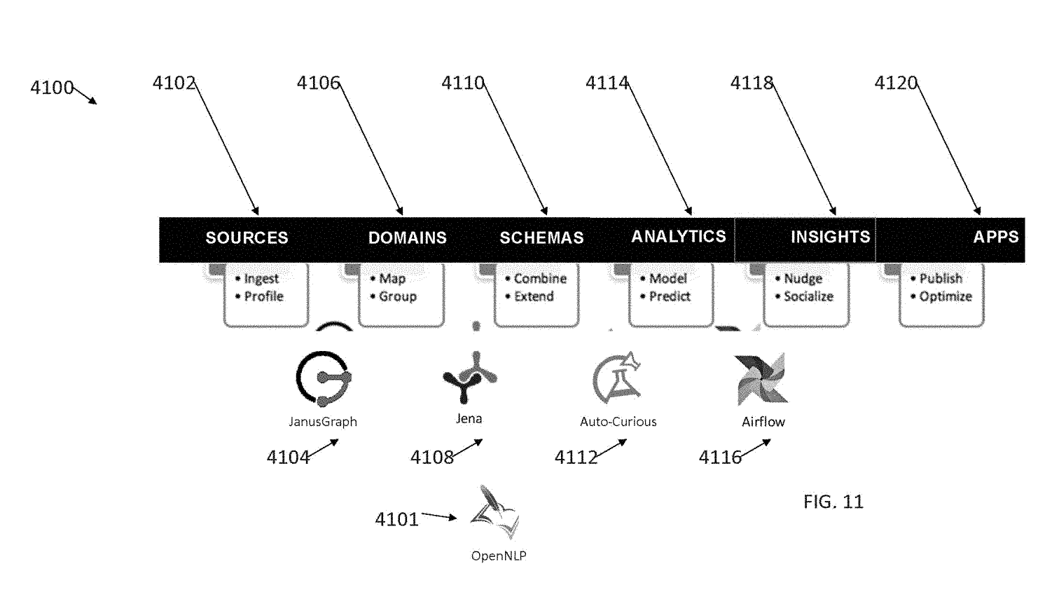

FIG. 11 shows the combined Big Data based technologies and their role in constructing machine learning workflow in a partial physical architecture diagram 4100.

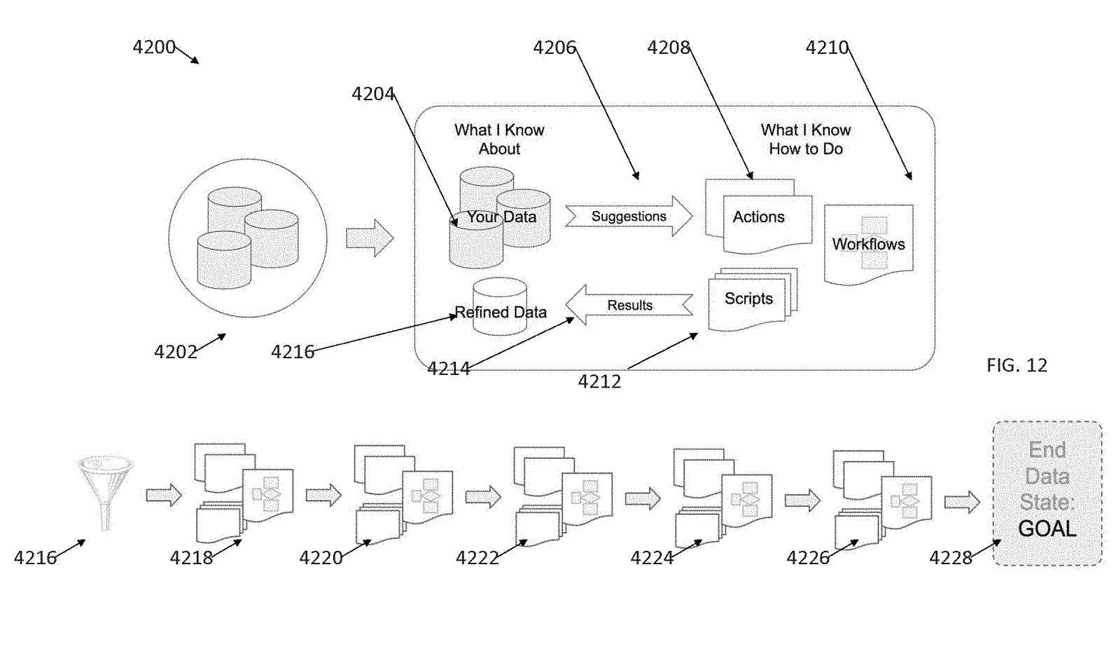

FIG. 12 shows an example embodiment of the core components of an analytic event orchestrator and their role in constructing machine learning workflow through interactions in a partial physical architecture diagram 4200.

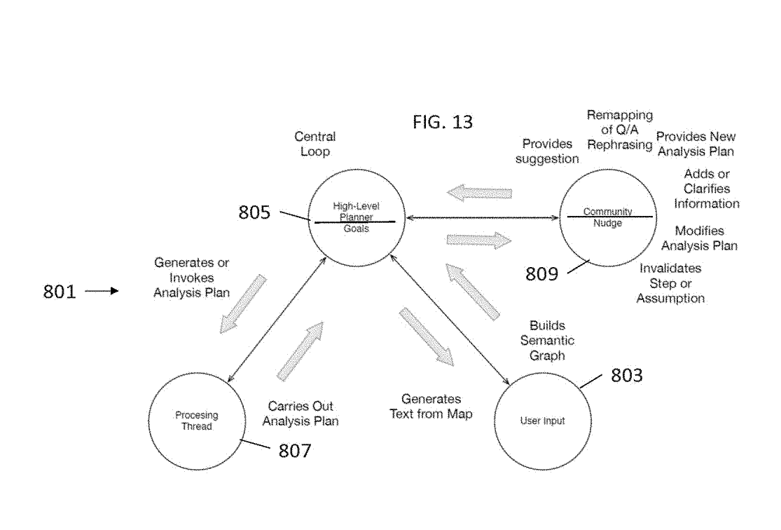

FIG. 13 shows an example embodiment of a high level architectural diagram 801. In the example embodiment a Central loop can include higher level planning goals 805 which can be coupled with a processing thread 807 to generate or invoke an analysis plan. The logic for processing threads 807 can also receive and carry out analysis plans. The high-level planner 805 can also generate objects from one or more maps for transmission to a user 803 whereby user input can help build semantic graphs used by the high-level planner 805. Additionally, high level planner 805 goals can be communicated to the community 809 to produce feedback in the form of nudges that are used to invalidate steps or assumptions, modify analysis plans, add or clarify information, provide new analysis plans, remap question and answer rephrasing and provide additional suggestions to the high-level planner 805. Each of the directional arrows may influence the central loop. In some embodiments, user input 803 and community 809 can influence processing that is occurring and change goals midway through operations.

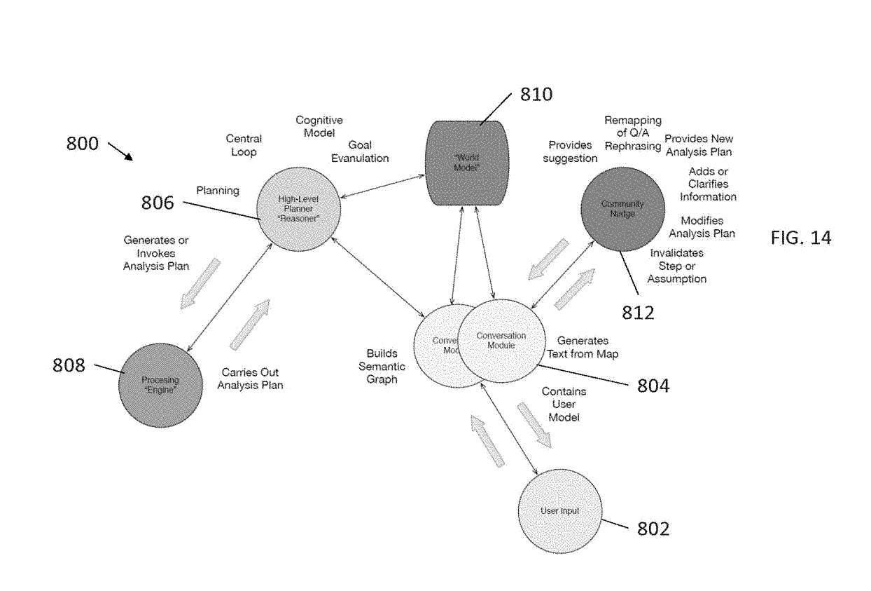

FIG. 14 shows an example embodiment of a high-level abstract system architecture diagram 800. In the example embodiment user input 802 can be received by one or more conversation modules 804 that can help build one or more semantic graphs for transmission to a high-level planner or “reasoner” 806. The reasoner 806 can perform planning and generate or invoke an analysis plan for processing by a processing “engine” 808 which carries out the analysis plan and returns results to the “reasoner” 806. This can assist in the construction of a cognitive model for analytics goal evaluation and transmission to a “world model” 810. The world model 810 can include knowledge about the structure of particular problems and analytics domains. It can also produce actions and recognize states associated with the construction of an analytical workflow. The “reasoner” 806 and “world model” 810 can be communicatively coupled to the conversation modules 804 and generate objects from maps for evaluation by the community 812 in the form of nudges as described above with respect to FIG. 8A. These nudges can include providing suggestions, remapping of question and answers, rephrasing, providing new analysis plans, adding or clarifying information, modification of analysis plans, invalidation of steps or assumptions, and other functions. In some embodiments Global learning from all conversation and analysis can be performed, implying a central learning module. Also, in some embodiments, high level planner 806, conversation modules 804, and others, can be separated and paired together per users 802, clusters, or other logical connections.

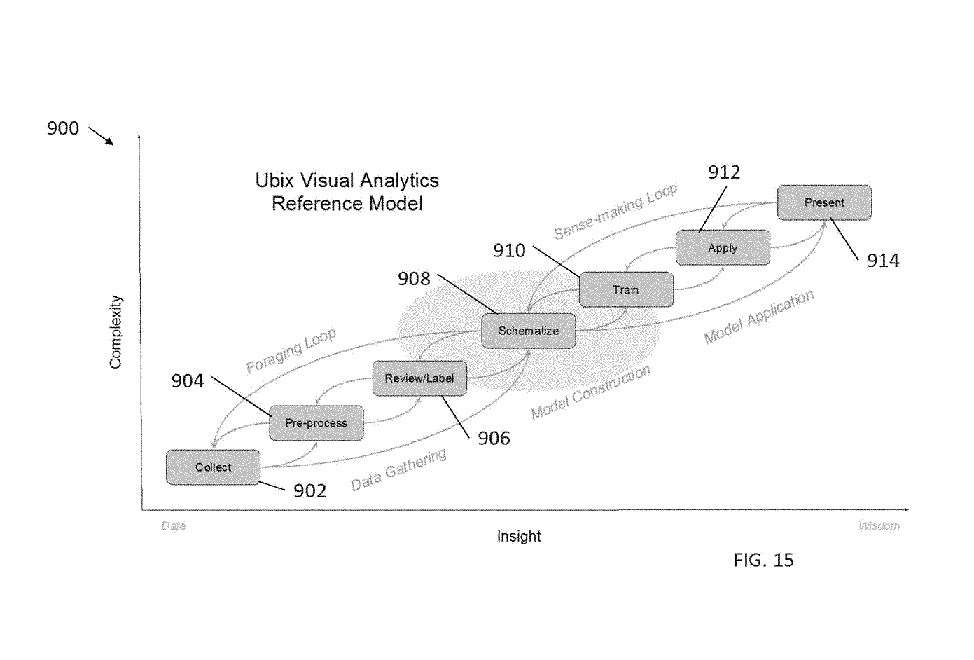

FIG. 15 shows an example embodiment of a Visual Analytics Reference Model diagram 900. In the example embodiment models can include a data-gathering phase that can further include data collection 902, pre-processing 904, and review/labeling tasks 906, and others before schematizing 908. At the end of the data-gathering phase, labeled data or otherwise collected data 902 can pass into a model construction phase where data is transformed (schematized) 908 into a feature space suitable for training 910 machine learning models. In a model application phase, the trained model 910 can be applied 912 to subsequent datasets or data streams for a given application with the results from the application of the model being presented 914 to an analyst using a set of interactive visualizations. Many tasks can result in a flow to the previous task with a new set of goals for that task. This can result in a “task-to-task” loop until the desired end-state or goal for that phase is reached. For example, a task-to-task loop in the data-gathering phase can be thought of as a data foraging loop from schematization 908 to data collection 902. Similarly, the task-to-task loop that results in the model construction and application phases can be thought of as a sense-making loop from presentation 914 to schematization 908. As shown, insight on the x-axis of the diagram can be contemplated from raw or pure data at the origin, to wisdom gleaned from data and presentation. Complexity can be applied on the y-axis.

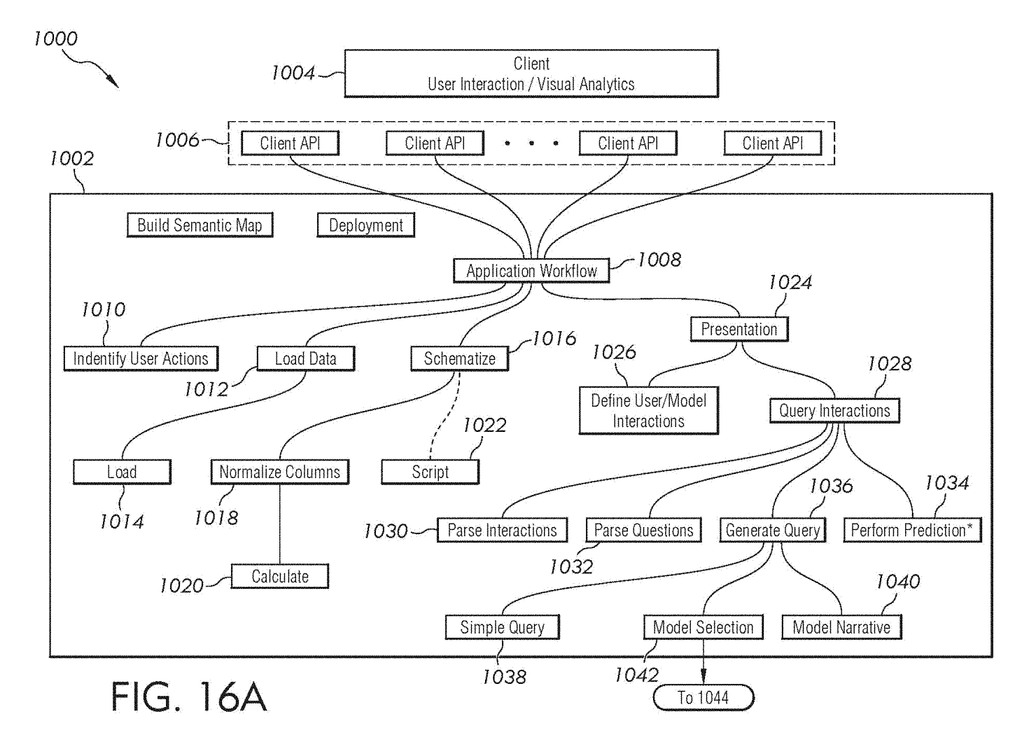

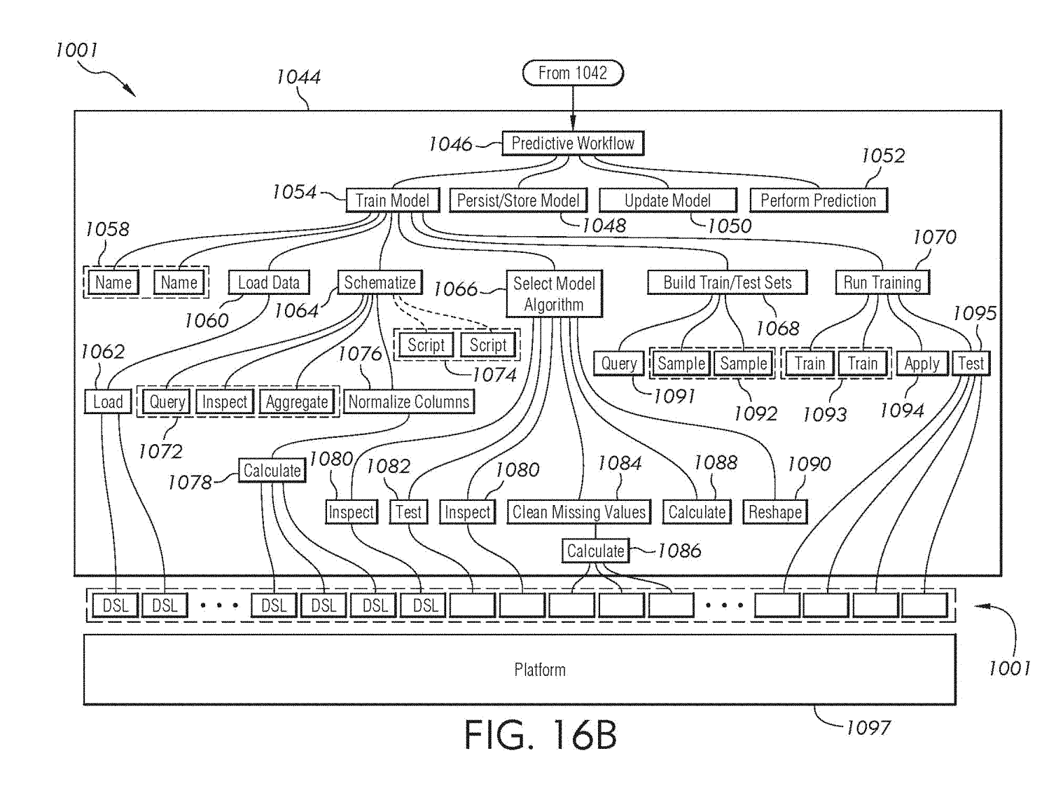

FIGS. 16A-16B show an example embodiment of an overall AC Analytical workflow decision tree diagram 1000 and 1001 respectively, for constructing a system application/solution. In the example embodiment, an AC Analytic Workflow Construction can include an application execution module 1002 for a system solution that includes an Analytics Application Workflow 1008 that can received client user interaction and visual analytics information from 1004 via one or more client API's 1006 as input. It is operable to build semantic maps and employ deployments thereby. As such, it can then identify user actions 1010, load data 1012 by performing one or more load operation 1014. It can also schematize 1016 by normalizing columns 1018 using calculations 1020 and run one or more scripts 1022. Presentation 1024 can include defining user/model interactions 1026 and query interactions 1028. Query interactions 1028 can include parsing interactions 1030, parsing questions 1032, performing predictions 1034 and generating queries 1036. Generating queries 1036 can include simple queries 1038, model narratives 1040, and model selection 1042. Model selection output can be sent to model construction module 1044.

As shown in FIG. 16B, model construction module 1044 for an AC workbench can include a predictive workflow 1046 can include persisting and storing a model 1048, updating a model 1050, performing predictions 1052, and training a model 1054. Training a mode 1054 can include naming 1058, loading data 1060 by loading 1062, schematizing 1064, selecting model algorithms 1066, building train and test sets 1068, and running training 1070.

Schematizing 1064 can include one or more modules 1072 for querying, inspecting, and aggregating, as well as one or more scripts 1074. Schematizing 1064 can also include normalizing columns 1076 by calculating 1078. Selecting a model algorithm 1066 can include inspecting 1080, testing 1082, cleaning missing values 1084 by calculating 1086, performing other calculating 1088, and reshaping 1090. Building train and test sets 1068 can include querying 1091 and sampling 1092. Running training 1070 can include training 1093, applying 1094, and testing 1095. Loading 1062, calculating 1078, inspecting 1080, testing 1082, calculating 1083 and testing 1095 can go to a DSL layer 1096.

Defining user/model interactions can include constructing a start page, selecting models and constructing model narratives. Selecting models can further interact with a model construction module. Schematization can include steps for an open-ended set of data transformations such as column normalization or custom transformations via a script block.

A Presentation step can include a process step for defining user/model interactions, and a query interface step. The Query Interface step includes steps for parsing user interaction, parsing user questions, generating queries, and performing predictions. Query generation can include steps for simply query construction, model selection, and model narration.

A model construction module can include predictive analytics workflow that includes training models, persisting and storing models, updating models, performing predictions with the models and others. Training a model can include naming, loading data, schematizing, selecting model algorithms, configuring algorithms, building model training and testing sets, running model training sessions and others.

Loading data can include loading data from an analytic space that can be schematized and aggregated by running domain-specific rules (denoted in the diagram as Script Blocks).

Schematizing can include developing and implementing rules to inspect domain solution space (SM) in order build a preliminary feature space for building a predictive model. Schematizing can also include inspecting persona-specific and domain-specific information, aggregating, normalizing columns using calculations and running other customized domain rules in Script Blocks.

Selecting model algorithms can include inspecting, testing, further inspecting, cleaning missing values using calculations stored in learning databases, calculating and reshaping the algorithms to prepare a finalized feature space appropriate for the selected algorithm and others. Testing can include training the models by schematizing and selecting model algorithms.

Building, training and testing sets can include querying and sampling the sets. Running training sessions can include training the model, applying information learned and testing the model again.

FIG. 17 shows an example embodiment of an AC Analytic workflow tree 1100, as shown and described with respect to FIG. 16B above. Like numbers in FIG. 16A match those of FIG. 16B. In the example embodiment, a top-level goal can be realized using a hierarchically organized rule set where one rule set is associated with an instance of a rule-based agent. In some embodiments, this may only be one rule based agent. A planner or agent can output plan blocks that instantiate output agents. Output agents can produce blocks that subsequently generate actions. These actions include DSL commands to the system engine and other agent environment updates.

In AC, resulting analytical workflow tasks can reside in a goal hierarchy where goals contain sub-goals. At leaf nodes of the goal hierarchy are task execution “blocks” that can generate actual commands for the analysis (e.g. see FIG. 10). Each task can involve one or more decisions that determine how to conduct the analysis.

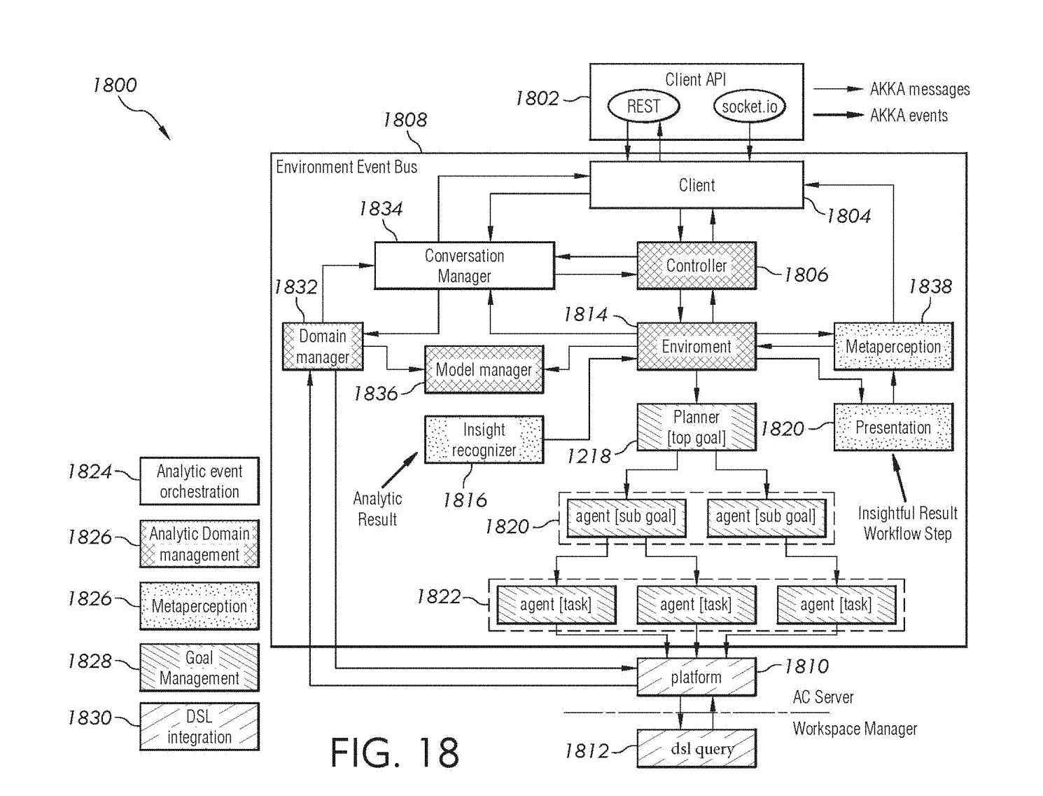

FIG. 18 shows an example embodiment of an actor-based agent framework with and logical task groupings diagram 1800 shows an example embodiment of an actor-based agent framework diagram. In the example embodiment, a Client API 1802 can include REST module and socket.io. An environment event bus 1808 interacts with a client via the Client API 1802 through client 1804 and controller 1806. The environment event bus 1808 can send output to a platform 1800 on an AC server, which can be communicatively coupled to send and receive data from a workspace manager side dsl query module 1812.

Environment event bus 1808 can include an environment actor 1814 that can broadcast and listen to messages on an Environment Event Bus 1808. An insight recognizer 1816, planner (top goal) 1818, and visualization module 1820 also broadcast and listen to messages on the Event Bus 1808. The environment actor 1814 instantiates insight recognizer 1816, planner 1818, and visualization actors such as presentation module 1820. The planner (top goal) 1818 agent can instantiate block-based sub-agents 1820 associated with sub-goals in the AC agent workflow goal/task hierarchy. Task sub-agents 1820 can emit task sub-sub agents 1822 with task actions that are associated with platform commands. These can take the form of messages sent to the platform actor 1810 which then issues finalized DSL queries 1812 to the system platform workspace manager. The platform agent 1810 can also receive results of the DSL queries 1812 from the system platform workspace manager. Analytic results inputted into the insight recognizer and Insightful result workflow steps sent to the visualization module can be AKKA, such as a scala actor framework, events while all other interactions described in the example embodiment can be AKKA messages.

Metaperception—Explicit data access enforcement, Color Scheme, Read metadata, Import and qualitative knowledge Schema Domain Mapping Find a spatial association for an entity, Use a default generic one for its domain, Device capacity, Number of axes, Number of data points, Distribution of data points, Analytic Context, User Preferences, Domain/Persona Constraints, Surface Types (2D vs 3D), Projections onto surface, Moving vs. Static, Pre-render Transforms/Workflows, Post-render Transforms/Workflows, Data types, Data shape (Hierarchy/Graph/Tabular), Operations can't see Financial data, Plot Primitive Suggestions from Visual Analytic Metafeatures, Device, Macro—Analytic Role, Micro—Workflow Context, Process Feedback via Reinforcement Learning from Users, Measure and Reduce Cognitive Load, Visual Analytic Workflow Inference , Rules/Models for constructing interaction Metaperception Model—Visual Analytics semantic map/rules Drive External Plots (Qlik or HighCharts) from AC, Inference of Landing Page Idealized Workflow.

In various embodiments, semantic resolution can be important, especially from source ingestion. In such embodiments, various goals can include: automated topic mapping, automated metric mapping, formalized data mapping for adding relationships between question regions, filtering from a possible set of mapping options, presenting options to a user for feedback, managing via Kafka stream reads Sentry activity, and others. For example, source ingestion can be used to make tables, read metadata, import and qualitatively discern knowledge, create or update schema, and others. As another example, domain mapping can be used to find a spatial association for an entity, use a default generic one for its domain, and others.

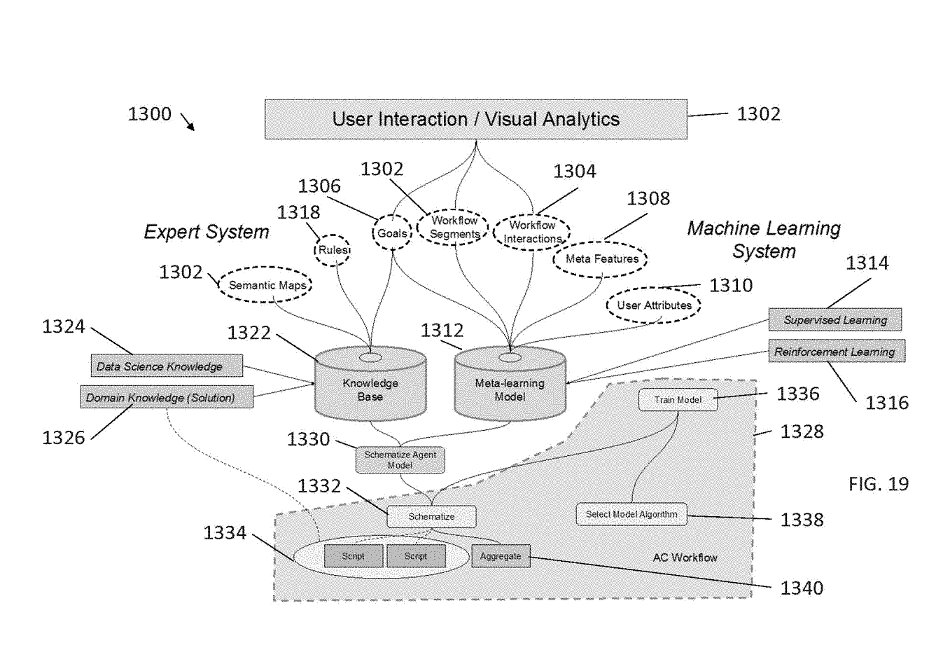

FIG. 19 shows an example embodiment of a combined knowledge-based and machine learning meta-learning architecture diagram 1300. In the example embodiment, a dual learning environment for AC can include a machine learning system and an expert learning system. In order for AC to learn which analytical steps to take, and how to make analytical decisions at each step in a workflow, AC can employ a dual learning scheme that is designed to automate the construction of the workflows and associated decision-making. This dual learning mechanism can combine a knowledge-based expert system approach with a data-driven machine learning approach. Both learning mechanisms can be used to inform AC's data science decision-making at any given step in an analytical workflow. For example, a “schematize model agent” can be used for combining expert schematize decisions and data-driven schematize decisions. Similar agents can be used for sampling data, data normalization, training and test set construction, feature selection, algorithm selection, hyper-parameter selection, presentation and others.

Stated differently, n the example embodiment a data-driven machine learning system can include workflow segments, workflow interactions, goals, meta-features and user attributes as inputs to a meta-learning model stored in a database. The meta-learning model can be trained using supervised learning and reinforcement learning machine learning techniques. A parallel expert system can use rules and semantic maps stored in a knowledge-base. The knowledge-base can contain both general data science and domain-specific knowledge where the domain refers to the specific problem domain in which AC learning is to be applied. These can be used to output AC workflow decisions (shown within the dashed line perimeter). Decision recommendations from the expert system and machine learning system can be constructed for each step in the AC workflow. At each step in the AC goal and task workflow hierarchy a specialized agent can be constructed that is responsible for combining workflow recommendations arising from the expert system and machine learning system.

An embodiment of this is represented in the diagram as a Schematization Agent Model that creates steps in the AC Workflow for Schematization where schematization is the process of transforming raw data into a form such as a machine learning feature space, that is suitable for constructing a problem domain model. In this diagram, a schematization step is illustrated in more detail. The schematization agent model uses both the knowledge base and meta-learning model to make schematization decisions. Decisions are created by a schematization agent that can receive input from other agents using the knowledge base and meta-learning model. In addition, the schematization may also use custom rules and knowledge through the use of script blocks. A training model module can interact with a model selection algorithm module and the schematization module. Other steps in the workflow such as a select model algorithm, parameter selection, and building training and test sets (not shown in the diagram) work in analogous fashion using the AC Dual Learning mechanism.

In order for AC to learn which analytical steps to take, and how to make analytical decisions at each step in a workflow, AC can employ a dual learning scheme that is designed to automate the construction of the workflows and associated decision-making. This dual learning mechanism can combine a knowledge-based expert system approach with a data-driven machine learning approach. Both learning mechanisms can be used to inform AC's data science decision-making at any given step in an analytical workflow. For example, a “schematize model agent” can be used for combining expert schematize decisions and data-driven schematize decisions. Similar agents can be used for sampling data, data normalization, training and test set construction, feature selection, algorithm selection, hyper-parameter selection, presentation and others.

For the data-driven side of AC, a data attribute set is built for the dataset to be analyzed by AC. These dataset attributes can be referred to as meta-features. Meta-features can include the dimensionality of the datasets, data-types and descriptive statistics within and across features, the degree of missing data, signal-to-noise-ratios and others. Each dataset can have a characteristic set of meta-features and can be used as the basis of comparison to determine similarity among datasets. The collection of meta-feature sets over many datasets can constitute an AC Metaspace.

Data-driven machine learning system can include workflow segments 1302, workflow interactions 1304, goals 1306, meta-features 1308, and user attributes 1310 as inputs to a meta-learning model 1312 stored in a database. The meta-learning model 1312 can be trained using supervised learning 1314 and reinforcement learning 1316 machine learning techniques. A parallel expert system can use rules 1318 and semantic maps 1320 stored in a knowledge-base 1322. The knowledge-base 1322 can contain both general data science knowledge 1324 and domain-specific knowledge 1326 where the domain refers to the specific problem domain in which AC learning is to be applied. These can be used to output AC workflow decisions 1328. Decision recommendations from the expert system and machine learning system can be constructed for each step in the AC workflow. At each step in the AC goal and task workflow hierarchy a specialized agent can be constructed that is responsible for combining workflow recommendations arising from the expert system and machine learning system.

An embodiment of this is represented in the diagram 1300 as a Schematization Agent Model 1330 that creates steps in the AC Workflow for Schematization where schematization is the process of transforming raw data into a form such as a machine learning feature space, that is suitable for constructing a problem domain model. In this diagram a schematization step 1332 is illustrated in more detail. The schematization agent model 1330 uses both the knowledge base 1322 and meta-learning model 1312 to make schematization decisions. Decisions are created by a schematization agent 1332 that can receive input from other agents using the knowledge base 1322 and meta-learning model 1312. In addition, the schematization may also use custom rules and knowledge through the use of one or more script blocks 1334 and can perform aggregation 1340. A training model module 1336 can interact with a model selection algorithm module 1338 and the schematization module 1332. Other steps in the workflow such as a select model algorithm, parameter selection, and building training and test sets (not shown in the diagram) work in analogous fashion using the AC Dual Learning mechanism.

Meta-perception can be Explicit data access enforcement, Color Scheme, Read metadata, Import and qualitative knowledge Schema Domain Mapping Find a spatial association for an entity, Use a default generic one for its domain, Device capacity, Number of axes, Number of data points, Distribution of data points, Analytic Context, User Preferences, Domain/Persona Constraints, Surface Types (2D vs 3D), Projections onto surface, Moving vs. Static, Pre-render Transforms/Workflows, Post-render Transforms/Workflows, Data types, Data shape (Hierarchy/Graph/Tabular), Operations can't see Financial data, Plot Primitive Suggestions from Visual Analytic Metafeatures, Device, Macro—Analytic Role, Micro—Workflow Context, Process Feedback via Reinforcement Learning from Users, Measure and Reduce Cognitive Load, Visual Analytic Workflow Inference , Rules/Models for constructing interaction Metaperception Model—Visual Analytics semantic map/rules Drive External Plots (Qlik or HighCharts) from AC, Inference of Landing Page Idealized Workflow.

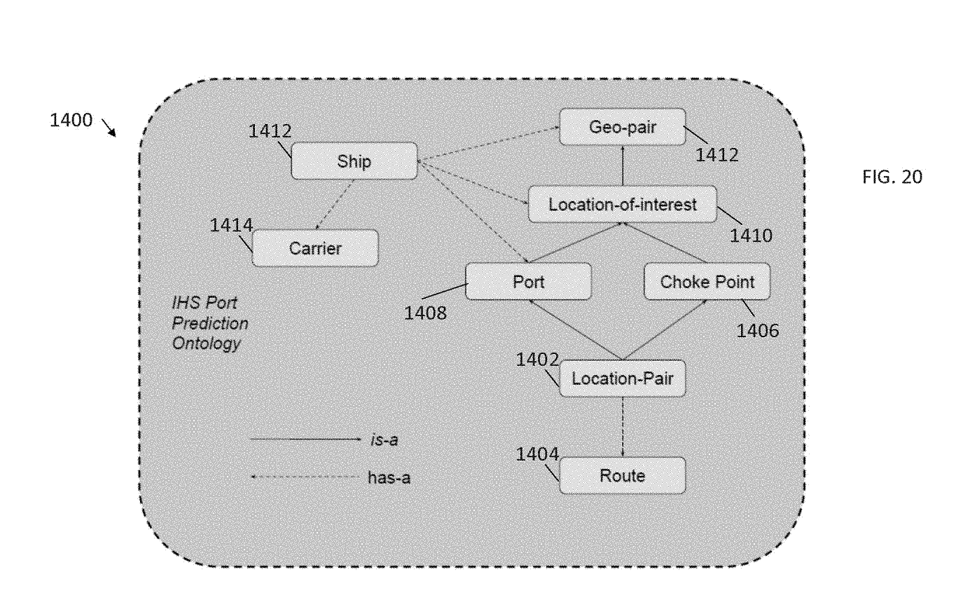

FIG. 20 shows an example embodiment of an IHS Port Prediction Ontology diagram 1400. As shown, the Ontology can include analysis and reporting on location pairs 1402 that have a route 1404 and are choke points 1406 and ports 1408. Ports 1408 and choke points 1406 can be locations of interest 1410, which can in turn be a geo-pair 1412. Shipping 1412 can have carriers 1414, ports 1408, locations of interests 1410, and geo-pairs 1412 and therefore the overall system can be analyzed.

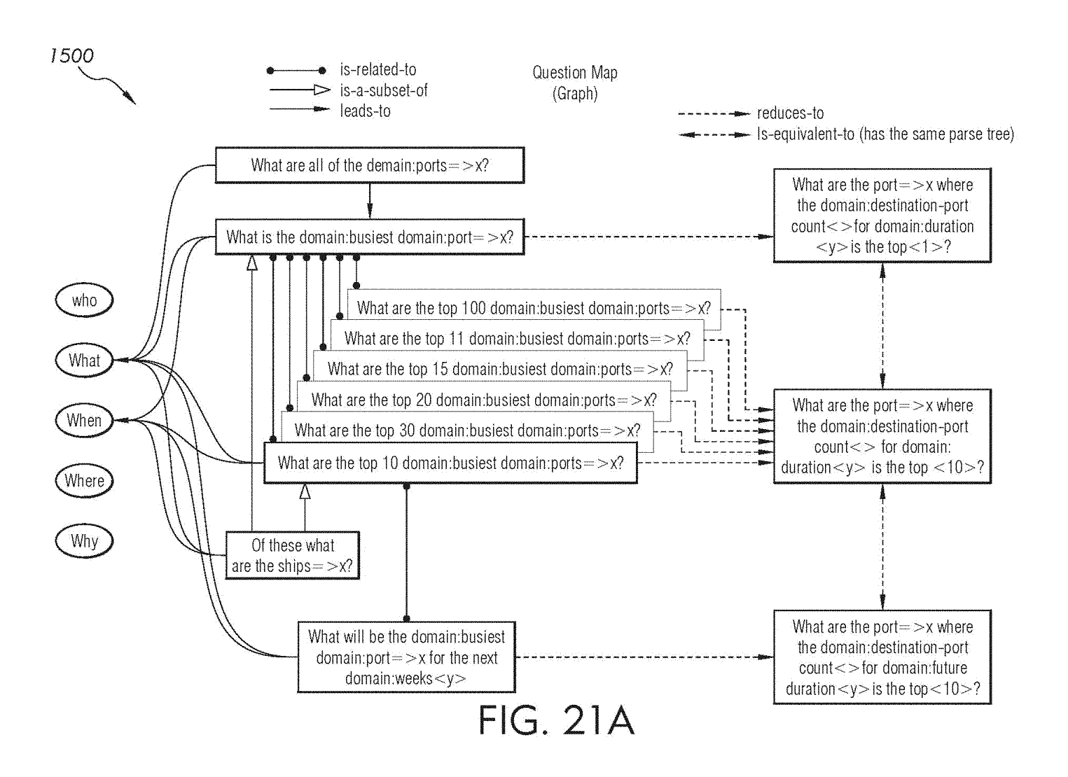

FIGS. 21A-21B show an example embodiments of question graph diagrams 1500, 1550. As shown, various questions and relations can be used to determine who, what where, when, why and how results are influenced and results generated.

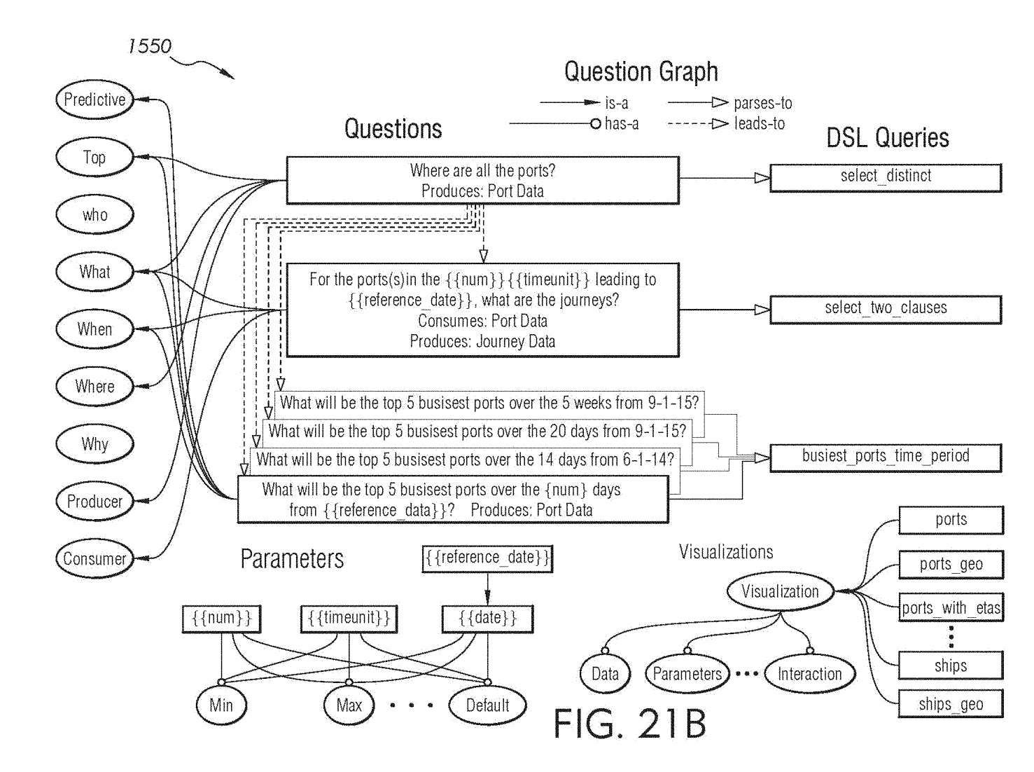

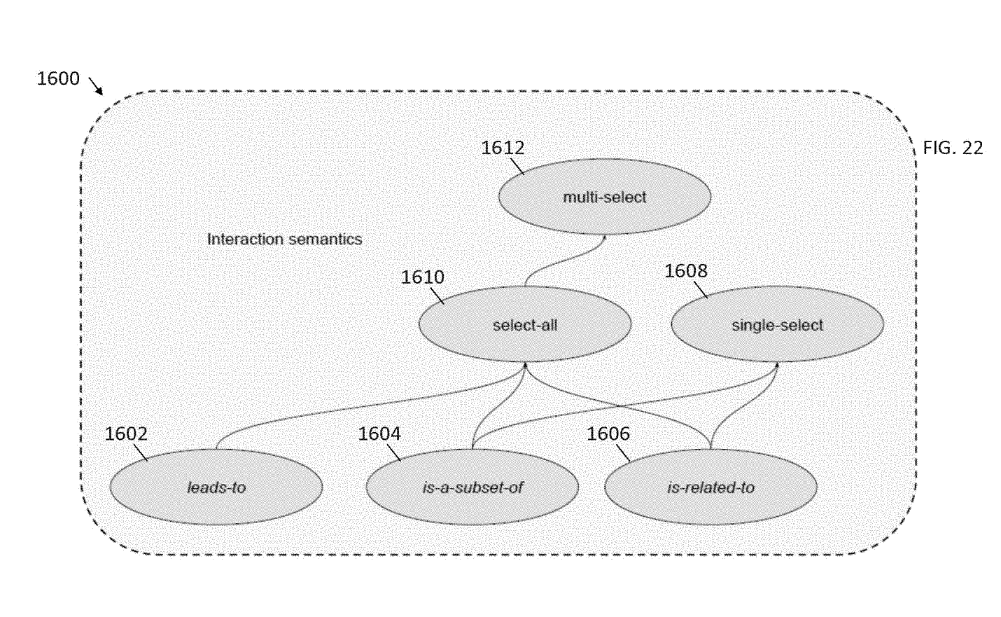

FIG. 22 shows an example embodiment of an interaction semantics diagram 1600. As shown in the example embodiment, these can include leads-to 1602, is a subset of 1604, is related to 1606, single select 1608, select all 1610, and multi-select 1612 according to various relationships. As shown, leads to 1602, is a subset of 1604, and is related to 1606 can lead to select all 1610. Is a subset of 1604 and is related to 1606 can be related to single select 1608. Select all 1610 can be related to multi-select 1612.

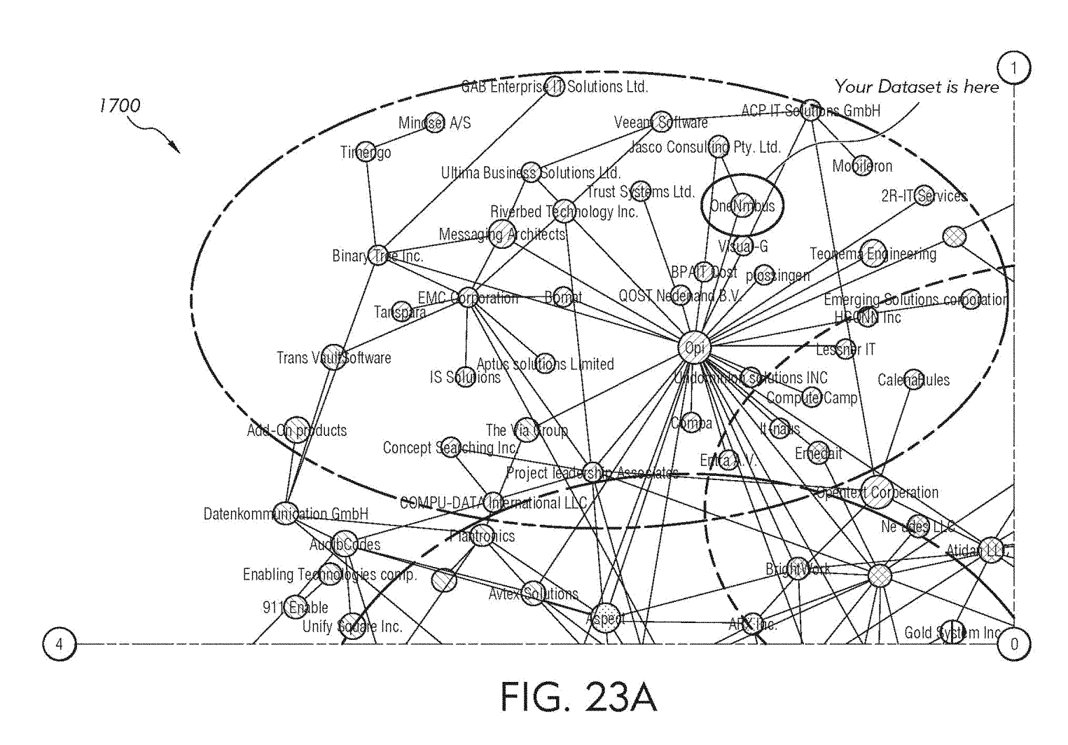

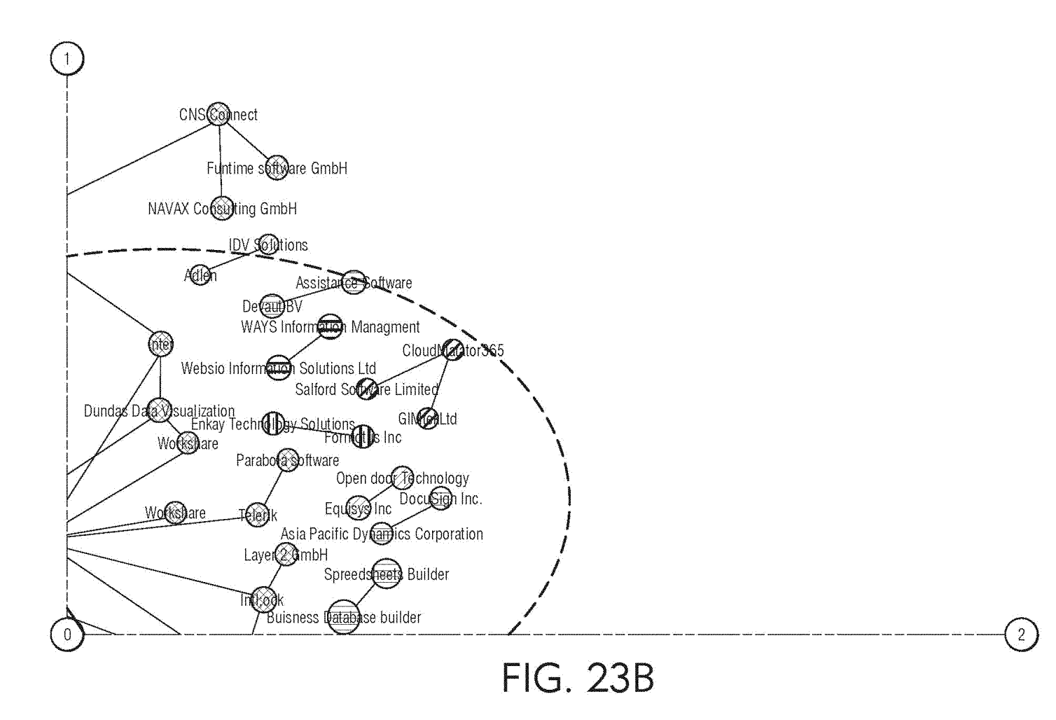

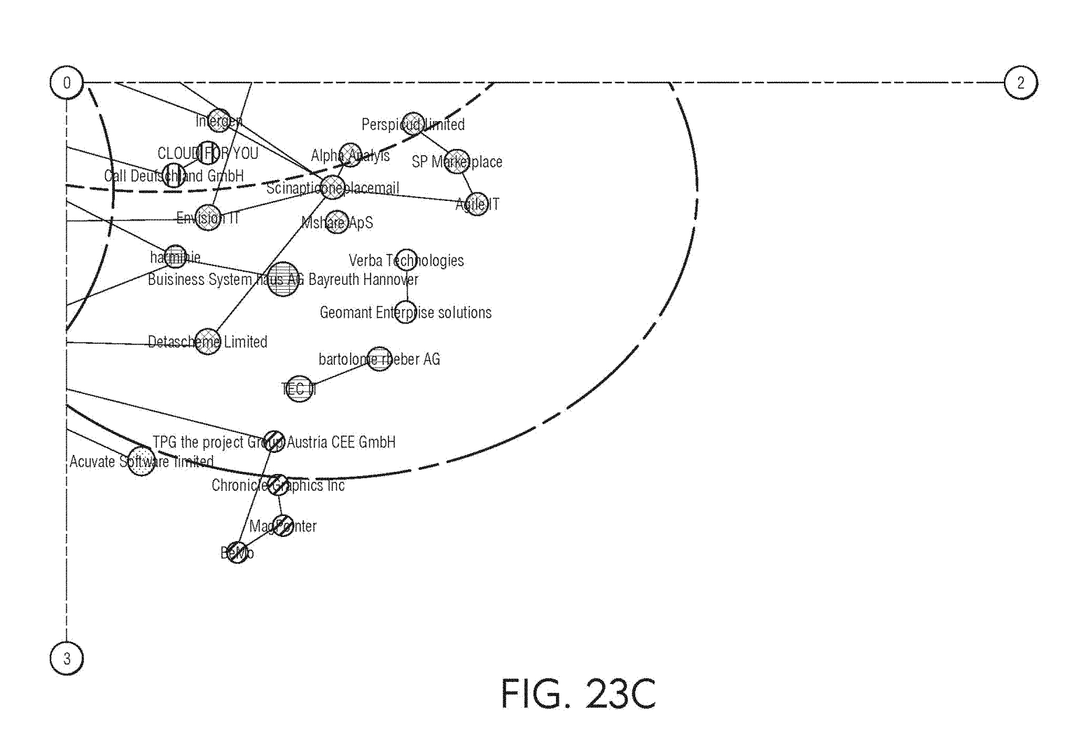

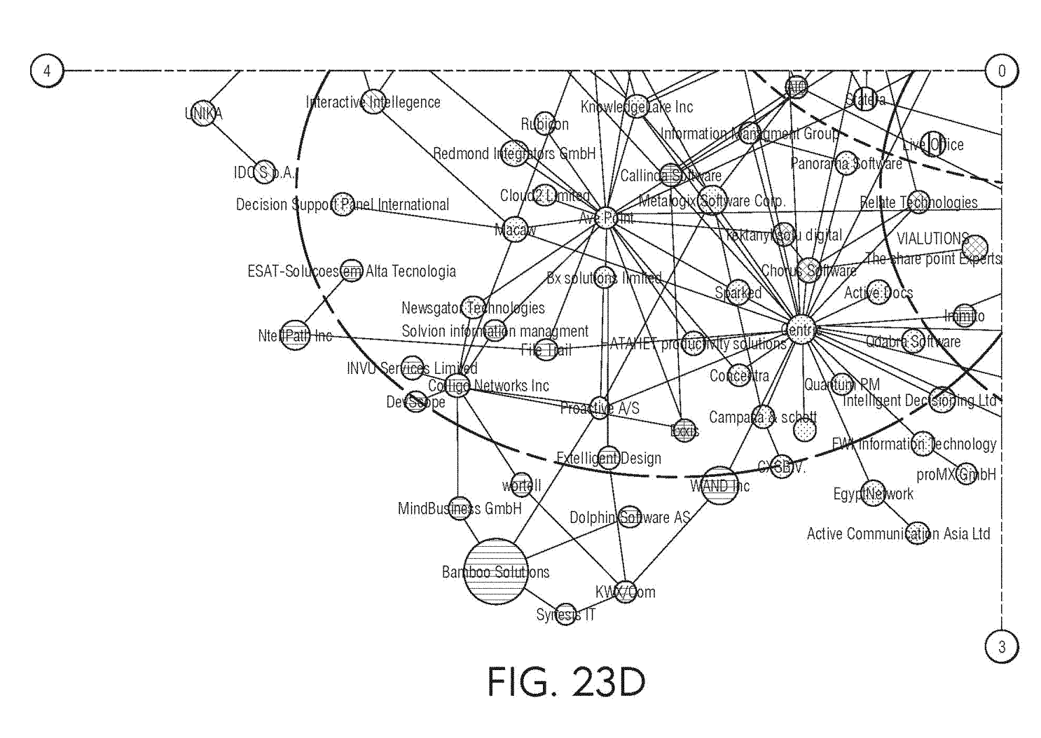

FIG. 23A-23D show an example embodiment of an AC Metaspace Metamapper diagram 1700. In the example embodiment, a given dataset can have a set of meta-features that exist as a many-dimensional point in the AC Metaspace. The AC Metaspace can be used to train meta-models for reasoning about analytical tasks. As an example, an algorithm selection machine learning task can be modeled by associating meta-features with model accuracy for a collection of machine learning algorithms.

The AC Metaspace can be data-mined and visualized as in the above illustration. In the example embodiment, datasets can be clustered using meta-features and projected onto a 2-D surface. Users who share or import a dataset with AC, which can then display to the user where the dataset resides in comparison to other similar datasets in the AC Metaspace. Similar datasets can appear to be clustered together. If they achieve a threshold of sufficient similarity as measured by comparative algorithms, a line can be shown between them. As shown in FIGS. 23A-23D, points that have the same color can represent clusters. A blue cluster can be typical of very-high dimensional sparse datasets that contain continuous values. This type of data can be typical of text classification or unstructured data. A red cluster can contain data sets that possess semi-structured data and have a mix continuous and nominal values. An orange cluster can be a collection of lower dimensional datasets that have a dense representation.

Hovering a cursor over a point in the AC Metaspace can yield a thumbnail graphic that is representative of at least one solution for that dataset. Selecting or clicking on points in the diagram can yield interactive visualizations of the associated workflows.

Points that cluster together may come from entirely different problem domains. For example, a financial dataset may appear next to a genomics dataset but would generally not be considered similar problem domains. In many instances examination of workflows and decisions of other similar datasets can lead to unique insights. In the example case, it can be useful to think about stock forecasting in terms of genomic diagnosis and survivability. Likewise, it may be useful to think of certain genomics problems in terms of related indicators to predict the effect of a certain mutation.

When a new dataset is added to the AC meta-space the system can incorporate the new meta-features into its meta-models to enhance the meta-models. For example, if a new machine-learning algorithm is discovered for high-dimensional image recognition, AC can incorporate the knowledge by spreading a new algorithm recommendation to one or more other workflows associated with datasets in the same cluster. Similarly, if an AC user selects a different hyper-parameter setting for a given algorithm that results in an improvement of model accuracy, AC can propagate that new setting to other corresponding workflows for datasets in that cluster. As such it can execute a principle of inductive transfer over datasets.

Workflow learning can come from new data added to the AC Metaspace via dataset ingestion or from user interaction with AC workflow during AC execution. Learning that is captured from direct user interaction can be bound to dataset type (as is the case for meta-learning), problem domain, user preference, or specific application. These direct user interactions can be referred to as nudges.

Workflow learning can also take place using a reinforcement learning (RL) mechanism. For example, the RL utility function may be to optimize for highest accuracy. AC can continuously explore a workflow parameter space across all of datasets in the AC Metaspace for optimum analytical decisions that yield the highest utility. When found, workflow parameters can be transferred to other workflows referenced in the meta-space.

In some embodiments, a natural place to begin populating the AC Metaspace may be with datasets from public domain machine learning repositories where metrics and algorithms are already known for a particular dataset. Repositories such as OpenML (http://www.openml.org/) can contain collections of preprocessed datasets along with meta-features (OpenML properties) and associated machine learning workflows (runs) that can be readily exploited by AC to populate its initial meta-space. Nudge-based learning can come from one or more of a plurality of AC users, “the crowd,” and an AC application can be designed to promote and collect such nudges at scale in order to build an effective meta-learning scheme.

Workflow automation could be applied to other analytical processes involving something other than pure data science and machine learning. For example, the same mechanism could be crafted to build workflows for other engineering process such chemical engineering, manufacturing automation or others.

Some Basic AC Functional Definitions can include: Domain—User's/customer's problem space (e.g., genomics); Solution—Domain-specific AC application; AC Engine—AC's reasoning engine; Platform—Distributed computing platform supporting DSL; Agent—Independently acting process acting on states and executing actions; Actor—Implementation of agent as an asynchronous message-based process; Goal—End state to be achieved by the agent; Sub-Goal—Goals created in the service of achieving the main goal; Task—Repeatable collection of blocks; Block—Abstraction for a logical group of actions including platform commands; Visual Analytics—Analysis done using visualization to interact with the data; Knowledge-Driven—Mechanism that uses pre-existing knowledge (rules and semantics) to make a decision; Data-Driven—Mechanism that uses data and examples to make a decision and others.

Some Agent related Definitions can include: Environment—Workflow analytics model and state; State—Snapshot of the environment at a given time; Percept—Agent's “perception” of environmental objects; Action—Executable action that the AC engine will perform, therefore moving to the next state; Semantic Map—Declarative entity-relationship map that describes domain concepts; Analytics Domain—Domain specific to data-science concepts that AC is using; Rules—Condition-action pair that pattern matches against percepts (states) that can result in a list of actions; Expert System—System that executes rules using pattern matching and conflict resolution against a knowledge base; Reinforcement Learning—Machine learning that uses search to optimize a utility function; Recommender—Machine learning technique that learns “user/item” pairs; Agents can be knowledge-drive (rules and heuristics), data-driven (models), or both and others.

Some UI/UX-related Definitions can include: Conversation—Series of steps taking the user from question to answer; Branch—Sub-section of a conversation, exploring workflow decision variations; Tile—UI representation of a partial state of the environment; Insight—A useful and often non-obvious result returned from action execution supplied to the user; Nudge—Feedback provided by the user to guide the conversation; AC Decision—Condition in which AC is making a data-science choice.

An AC Codebase can include at least: a UI module—ac-client's javascript code base; controller module; io.ubix.common utility module; io.ubix.ac; agent; blocks; rule; conditions; data; access; semantic; reasoner; actors; util; io.ubix.ai.agent; simplerule and others.

An AC Codebase Unit Testing and Configuration can include: Client Unit tests; Scala unit tests; Scalatest (FunSpec+akka testkit for actors); Scalamock; Dependency Injection-cake pattern; application.conf (play configuration); routes JSON; Configuration; Semantic Maps; Rules and others.

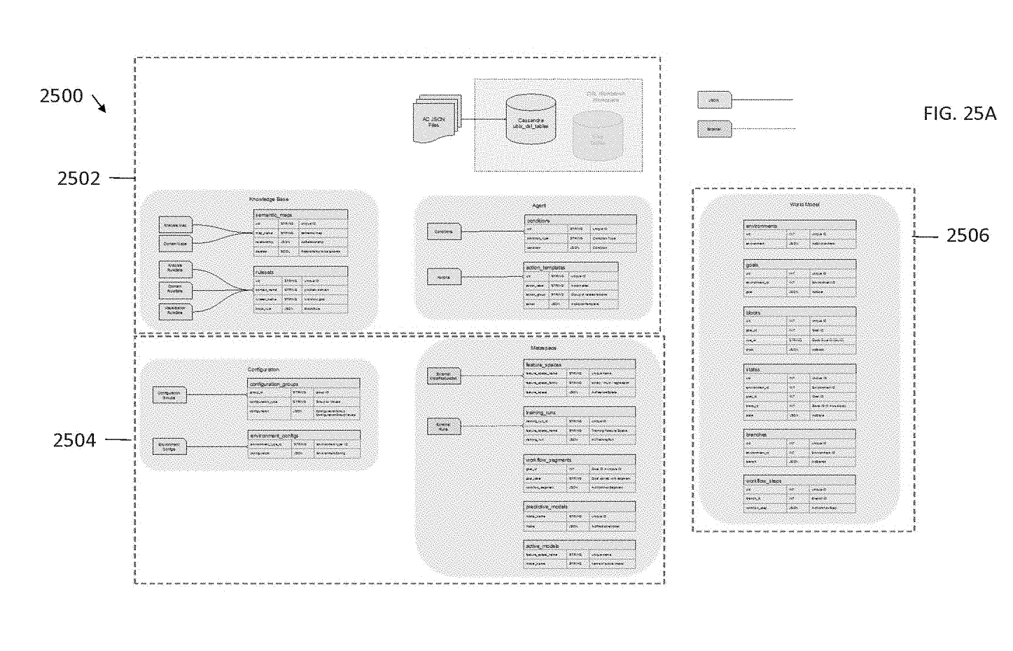

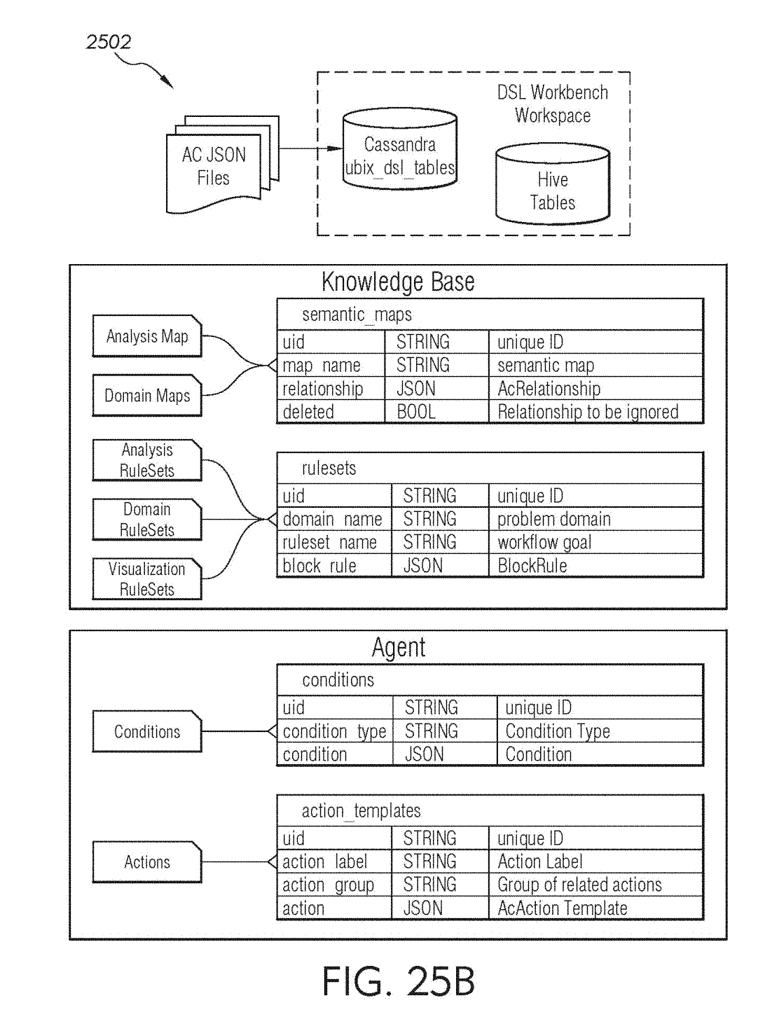

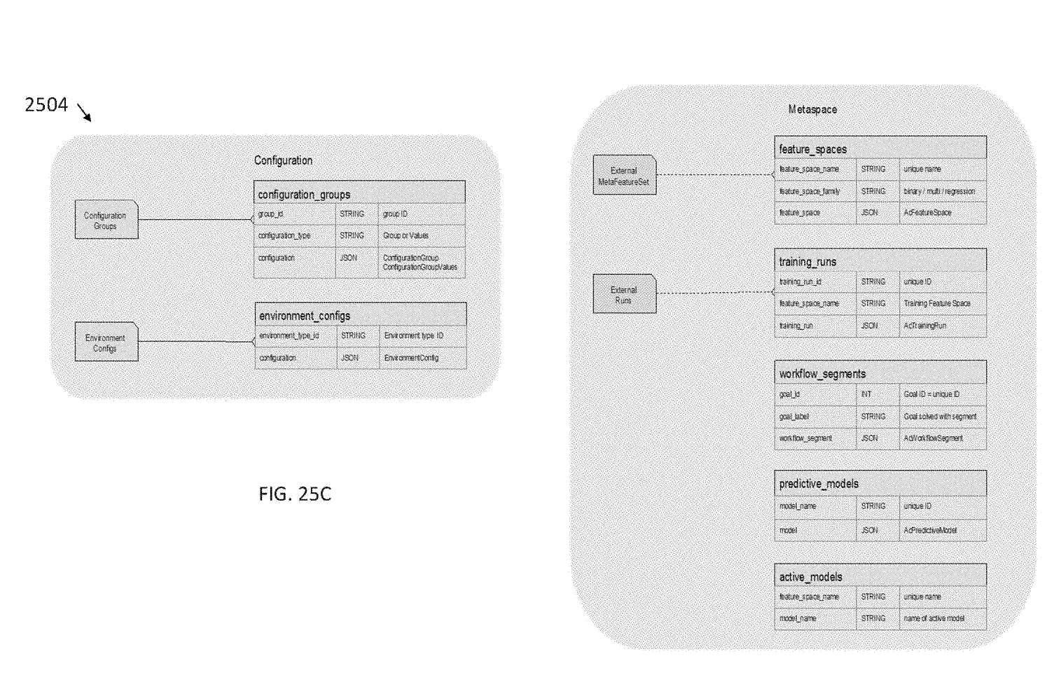

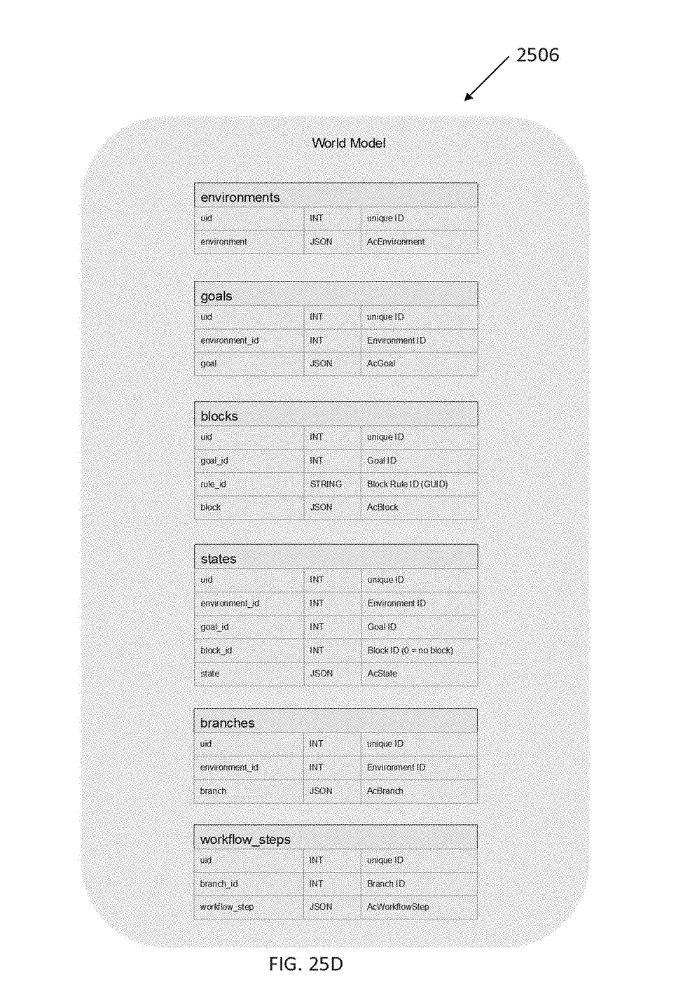

AC Persistence can include Requirements such as Mutability; multiusers; consistency; scalability (nosql) including relational and key value schemas and others. An AC metamodel can include storage and solution storage and others. AC Persistence can include HBase, Cassandra (see FIGS. 25A-25D), MongoDB and others.

Some questions an AC Roadmap can consider include: Business Objectives such as Audience, Investors, Customers, Board of Directors (BoD) and others. An AC interpretation of customer main questions can include: “Can I “predict” the thing I'm interested in?” “What can I do with the prediction?” “What are the key influencers of the prediction?” “How do they affect me?” “What is similar to the thing I'm interested in?” “How do I group things?” Explanation of “how it works, and how it learns to investors” and its execution. It can help to consider who competitors are or may be.

Some tactical considerations for AC development include: Solution/Engine including Analytic or Domain SM, Analytic or Domain Rules, Configuration, and consumer IP, Domain Specifications, Proprietary WFs, technical roadmaps, Transforms and others. Domain specific information such as Blocks, Insight Recognition, Interaction Inferencing and others. AC can support Structured, Semi-structured and Unstructured data. An Expanded Feature Space can include: Metalearning, Explanations, Persistence, Builds/Versioning, WF Interaction (for Subject Matter Experts), WF Authoring (for data scientists), Rules Engine work and others. In some embodiments AC can combine knowledge-driven decision making with data driven decision-making under such scenarios as “Overkill” analytics where AC can build thousands of models in parallel, and subsequently use the optimum model or combine the models into a massive ensemble. Other AC features include: Parallel model building, Searching/RL, Model aggregation, Ensemble construction and others, such as online learning, classification, and regression via streaming.

In some embodiments, AC Rules can be governed by Rule structure such as Condition, Actions/Blocks, Controlling the order of rule execution by way of Conflict Resolution; Weight, wherein Higher weights increase rule priority; Complexity, wherein Higher complexity increase rule priority and Conditions introduce complexity; Refraction, wherein Rules do not fire within the set refraction count. An AC Engine may use Analytics Rules, and Rule Sets may be organized in a goal (plan) hierarchy. Domain Rules can be configured in j son/presetValues.j son. Other j son files can include Conversation Names and Types, Conversation configurations, Domain & Palette configuration groups, Preset Values (static configuration/domain), Decision +Insights +WF Step Conditions (used by Insight Recognizer). AC can also include Visualization Rules.

Semantic Map content can include: a collection of many-to-many, Entity-Relationships (ER). Relationships can include: MAPS_TO, KEY_OF, IS_A, HAS_A, EXPLAINS, LABEL_FOR, DEPENDS_ON, JOINS_WITH and others. Entities can be based on: domain, columns, columnValue, label, narrative, calculatedColumn, row, table, domainValue, joinKey, and others. These can be organized into WorkSpace-to-domain relationships, domain-to-domain relationships. An AC solution will contain an Analytic Map, Analytical Ruleset, paired with a set of Domain Maps and rulesets. Semantic maps can be represented in j son and configured with preset values. AC's question graphs (QGs—FIGS. 16A, 16B) are encoded in a semantic map as a set of entity relationships that use the IS_A, HAS_A, PARSES_TO, RELATES_TO, and LEAD_TO relationships.

In various embodiments, semantic resolution can be important, especially from source ingestion. In such embodiments, various goals can include: automated topic mapping, automated metric mapping, formalized data mapping for adding relationships between question regions, filtering from a possible set of mapping options, presenting options to a user for feedback, managing via Kafka stream reads Sentry activity, and others. For example, source ingestion can be used to make tables, read metadata, import and qualitatively discern knowledge, create or update schema, and others. As another example, domain mapping can be used to find a spatial association for an entity, use a default generic one for its domain, and others.

Additionally, semantic layers of AC processing may be defined for: raw data, published contracts, content profiles, raw semantic descriptions, ontology tokenizes into system analytic domain features, vocabulary tokens in a deep learning model that may produce output by analyzing a group of tables, and others.

In some embodiments, exact content, not format, may be contained in a datasheet and may require implementation of data detection. This can be where domain mapping is generalized into a text classification problem based on one or more of: data dictionary, raw vocabulary input, taxonomy relevance, entity inventory, structural planning, schematization tokens through DSL and text curation beyond DSL which leads back to the UI, and others.

A Source to Schema Metric Set Construction example will now be described. In general, this can include a series of steps. Here, six steps will be described.

First, source data in raw form from FortuneTrend can be:

```
operator add -n source_add_jdbc -f
    -e “operator add -n {{stream_name}} -f -e \“jdbc -r
jdbc\:{{driver}}\:\/\/{{hostname}}\:{{port}}\/{{catalog}} -u {{user}} -s
{{password}} -t {{query}}\ ””
source_add_jdbc
    --stream_name fortunetrend mysql
    --driver mysql --hostname 13.124.85.133
    --port 3306 --user root
    --password tdx@2017 --catalog ab
    --query “{{query}}”
fortunetrend_mysql --query
  “
    (
      SELECT
        T001 as Date,
        T002 as Industry,
        T003 as Company_prosperity_index,
        T004 as Enterprise_realtime_index,
        T005 as Enterprise_expectation_index,
        T006 as Entrepreneur_confidence_index,
        T007 as Entrepreneur_realtime_index,
        T008 as Entrepreneur_expectation_index
        from ab.200908016
    )
      as t200908016
  ”
| as t200908016
```

Second, shaping needs for tables can be identified. In various embodiments, there have generally been two shaping patterns for changing metrics: Power Generation and Renewable Energy, where tables merge with an CompanyName key and only distinct metrics are shown, and Coal where the names of some metrics were duplicates where they had similar metrics at different grains (QinHuangDa Port and all of China inventory) When combining tables, if the metrics can collapse into one entity that maps to a location or organization, then unpivoting one value as a new row can occur. If they have no logical merging, then the system can perform an outer join on dates and increase column width to accommodate both sets of columns

Third, building friendly names can occur. Canonical column names can replace spaces with underscores and eliminate any special characters. If there is an Enumeration table value, that can indicate a category that has a join with a filtered value from t100000003_EN. For example:
pipe EnumerationsTranslated|where T001=1136 |columns T002, T003_EN rename column-f1,2-t AreaKey,AreaValue|as Enumeration_Area

The filter column and enumeration column may vary in different embodiments. In an example embodiment with two reference derived dimensions from a table, this could be:
Enumeration 1136=Enumeration_Are
Enumeration 1019=Enumeration_Industry

Fourth, location, organization, or combination keys can be built.

Fifth, topics and metrics can be updated. For example, generating rows based on region and organization members can be accomplished with code, such as:

pipe Investment
| where Location = ‘BeiJing, Capitol of China’
| describe distribution
| sql-expr -n Location “BeiJing, Capitol of China”
| sql-expr -n Topic ‘Location’
| sql-expr -n Term “BeiJing, Capitol of China”
| sql-expr -n metric group ‘Investment’
| where Measurement_Level = ‘Interval/Ratio’ and Distinct_Values > 1 and
ABS(Stdev)+ABS(ModeCount)+ABS(Mean) != 0 and type != ‘timestamp’
| as TopicAndMetricsBase

Because separate passes are added for each topic, it may be necessary to run similar operations for Organization. Further, adding a row per metric per distinct location or Organization name may be required.

Sixth can be regeneration of terms and metrics. Once the rows for topics and metrics have been added, either manually or otherwise, users can run something similar to the following sample code and export it for use.

pipe TopicsAndMetrics | countby
metric_set,topic,OrganizationName,Sector,Industry,Location,ProvinceName,RegionNam
e,CountryName
| transpose unpivot -o topic_label -i
OrganizationName,Sector,Industry,Location,ProvinceName,RegionName,CountryName
| clip count_1
| rename column -f transposed_1,Topic -t topic_term,topic_name
| where length(topic_term)
| as TermsAndMetrics

Additionally, semantic layers of AC processing may be defined for: raw data, published contracts, content profiles, raw semantic descriptions, ontology tokenizes into system analytic domain features, vocabulary tokens in a deep learning model that may produce output by analyzing a group of tables, and others.

In some embodiments, exact content, not format, may be contained in a datasheet and may require implementation of data detection. This can be where domain mapping is generalized into a text classification problem based on one or more of: data dictionary, raw vocabulary input, taxonomy relevance, entity inventory, structural planning, schematization tokens through DSL and text curation beyond DSL which leads back to the UI, and others.

A first step can be to take an existing Organization dimension and build a rule based taxonomy relevancy and some intermediate assembling DSL. An industry and sector can be manually engineered, and source documents, tables, or others can also be used for mappings. A metadata structure may not be desirable in the form of a raw FT spreadsheet. As such, automation of a metric set and implementing it by integration using an existing organization table can be performed. Then a domain can be added from a dictionary.

To elaborate, as an example, Renewable_Energy and Power_generation can be added from a data dictionary inputs and DSL. Next, “Victory 1” can use a current organization table, since it may have curation of a raw vocabulary as the relationship between OrganizationName and higher levels may be coming from users. Next, “Victory 2” can be building an organization table with nudges via DSL, such that data dictionary leads to raw vocabulary input, which leads to taxonomy structure. Next, “Victory 3” can be putting them together. “Victory 4” can be determining multiple related domains that operate the same way. “Victory 5” can be looping back on all other transforms. “Victory 6” cab be automating all of source to insight.

An Analytic Event Orchestrator (AEO) can be used to perform analytics at rest or analytics in motion. AEO can include an NLP signature that may have multi-resolution; an analytic domain map that requires geospatial images and is used in feature generation; operations including conditions, implementations, DSL parameters for some cases, non-DSL execution paths for others; others; and results, which can include visualization suggestions.

Analytics at rest can include various procedures. For example, the system or system administrators may create initial AEO. Then users may bring or enter problems, data, and analytic assets to the system. Users can provide textual descriptions of assets for system use and the system can suggest mapping to one or more Analytic Domains. The user can confirm mappings and then some or all assets may be available for use in any new AC workflows.

Similarly, analytics in motion can include various procedures. For example, initial AEO chains for workflow or sub-workflow can be created. Then workflows can be built for different model types before defining complex OKA of possible paths. The system can then generate a myriad of different models using AC Sentry before results of internal predictive models are examined using the nuances of data and transformations to analyze their impacts on results and cohorts are considered. Next, models can be applied for subsequent user inputs and, when a user tries novel approach, AC can use Sentry to assess the impact on existing models.

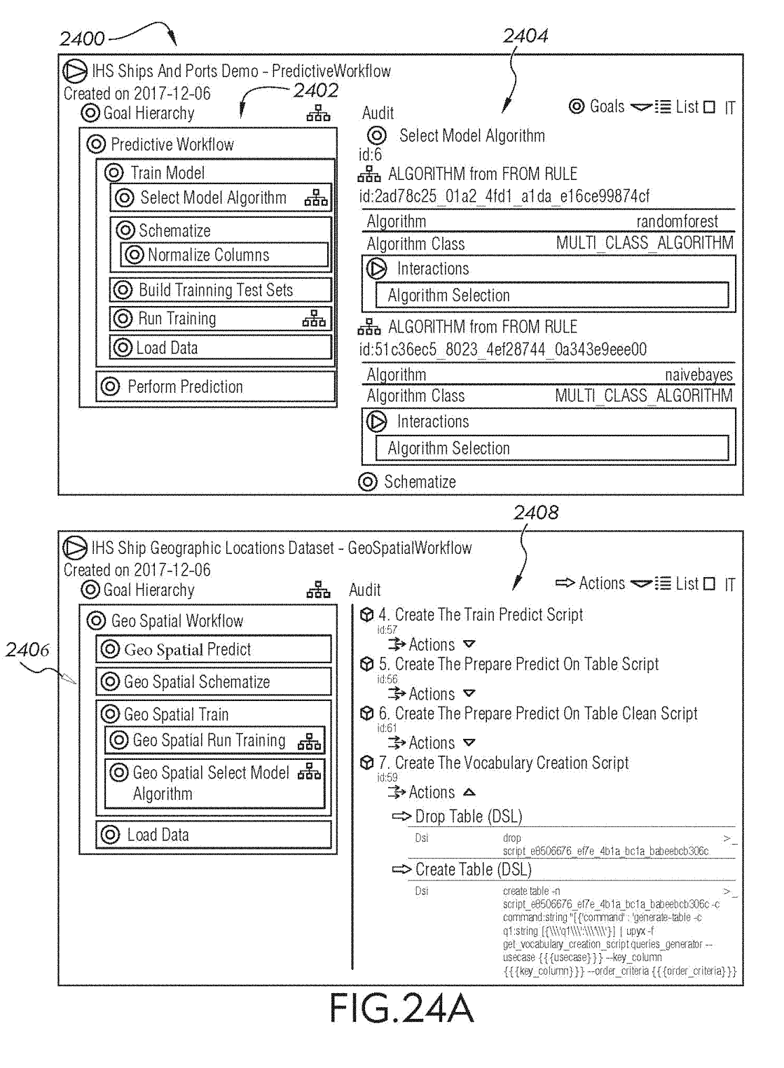

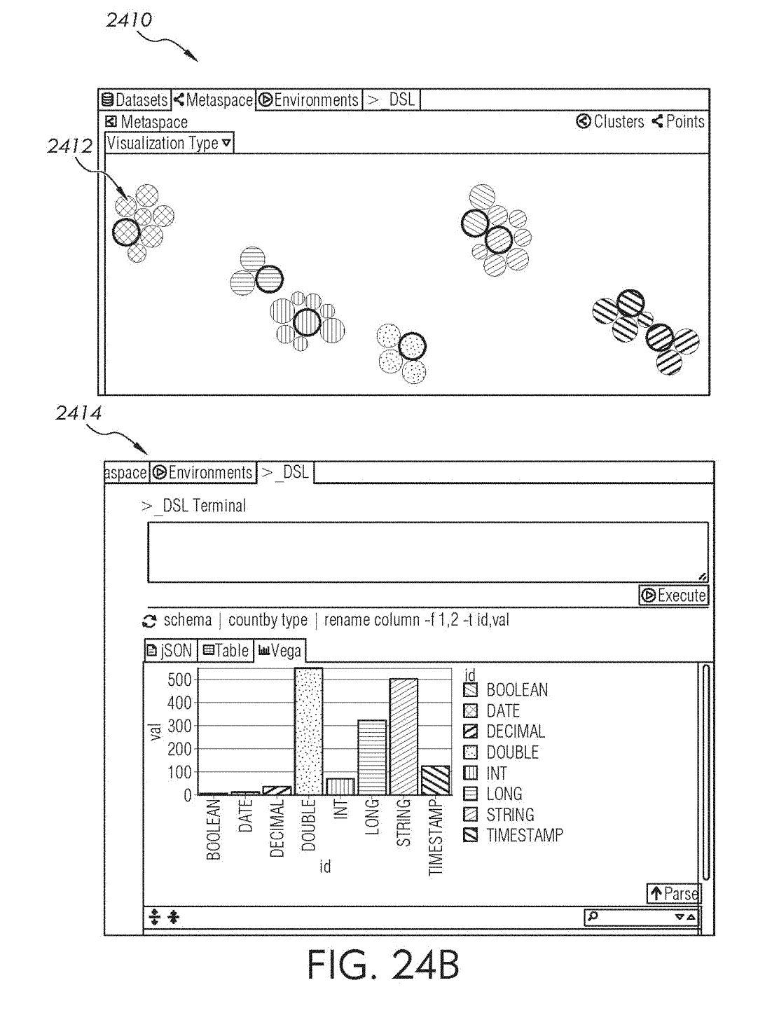

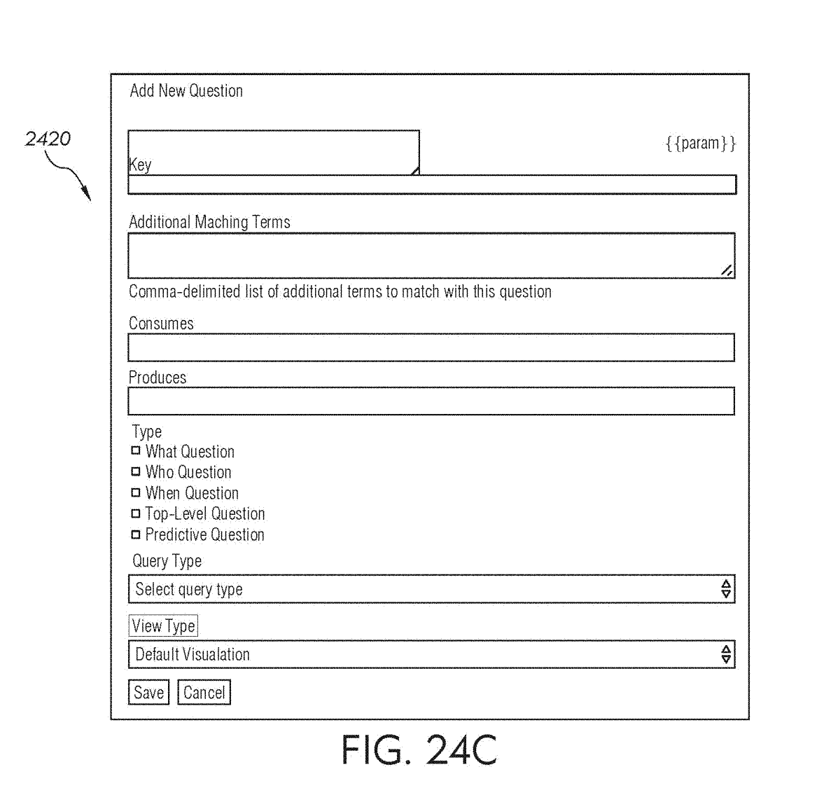

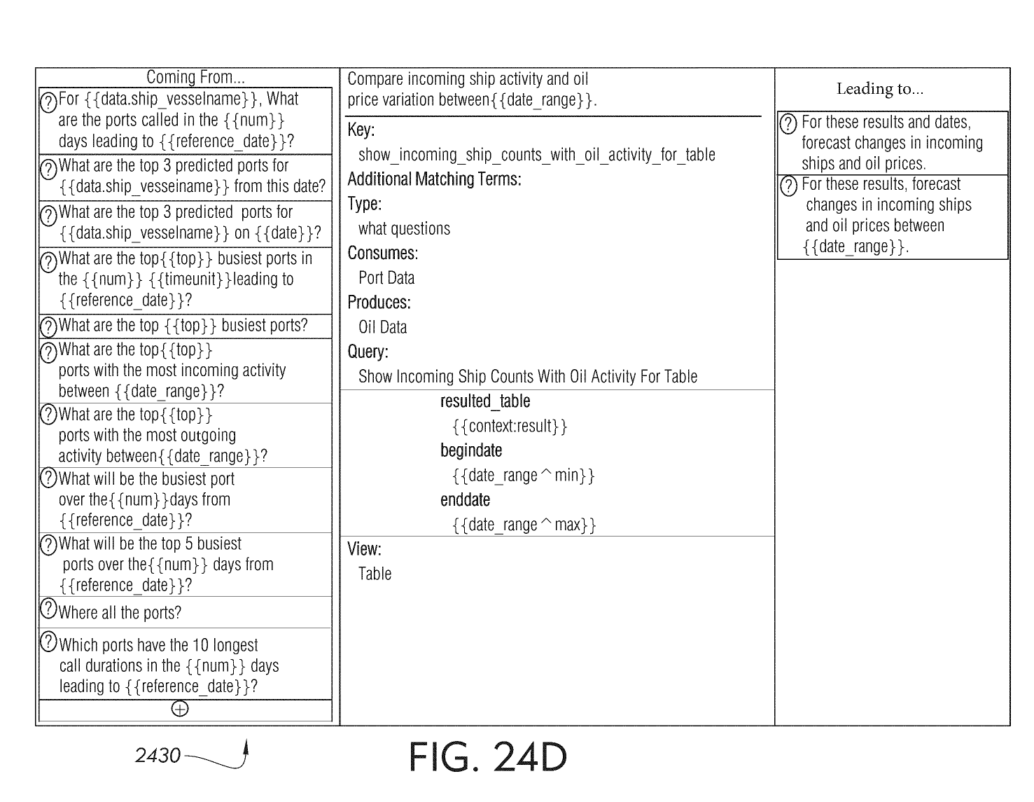

FIG. 24A shows an example embodiment of an AC Metaspace used for driving suggestions in a partial user experience flow diagram 2400. The goal hierarchies 2402 and 2406 are summary goals that produce an audit trail that at its highest level shows Auto-Curious Decisions and Goals 2404. Blocks can be viewed in the audit down the Bock and Action (DSL or Auto-Curious) level 2408.

FIG. 24B shows an example embodiment of an AC Metaspace visualizations used for driving the appropriate user experience in a machine learning workflow diagram 2410. A detail of the metaspace mapper can show a user different clusters 2412 of analytic context that can be used to suggest which models to use in a machine learning workflow. Executing DSL can also use metaperception suggestions and generate visualizations with a visual analytic workflow 2414.

FIG. 24C shows an example embodiment of a user interface screen 2420 for adding a custom question graph item. See FIGS. 20-22 or more details on the question graph. As shown, various fields and buttons can be used for interaction with the system via a network.

FIG. 24D shows an example embodiment of a user interface screen 2430 for navigating and viewing information on existing question graph items. See FIG. 20-22 or more details on the question graph.

FIGS. 25A-25D show an example embodiment of AC's persistence schema. As shown, the persistence schema for AC's architecture can include a knowledge base, configuration, agent, metaspace and world model. In this implementation, the non-relational schema is realized using a low latency noSQL DB such as Cassandra.

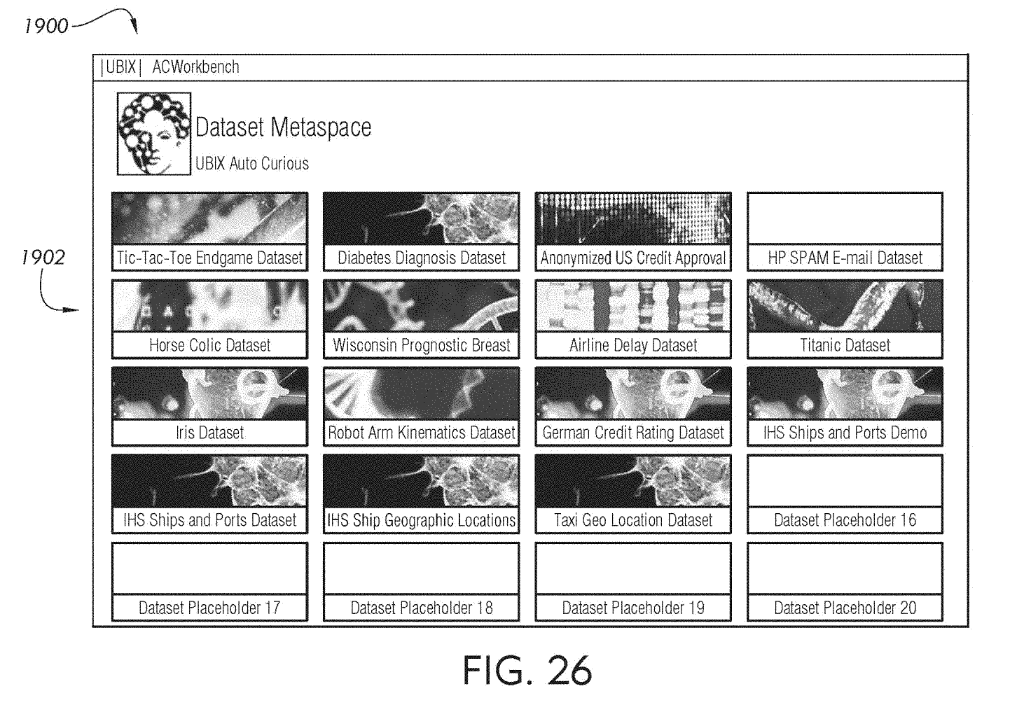

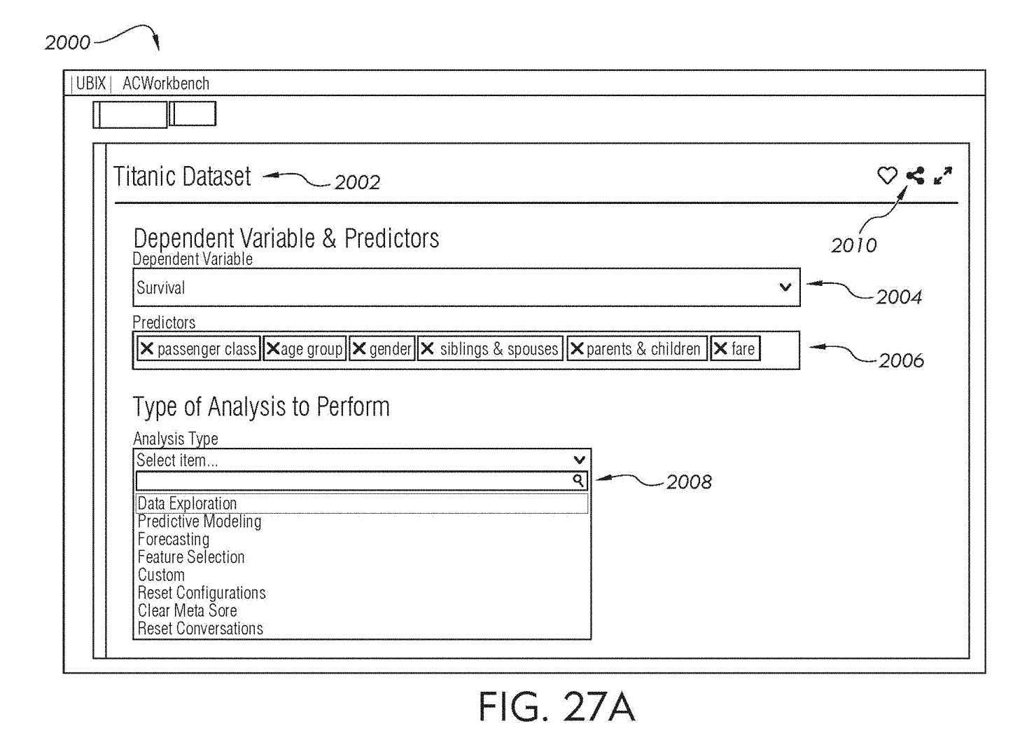

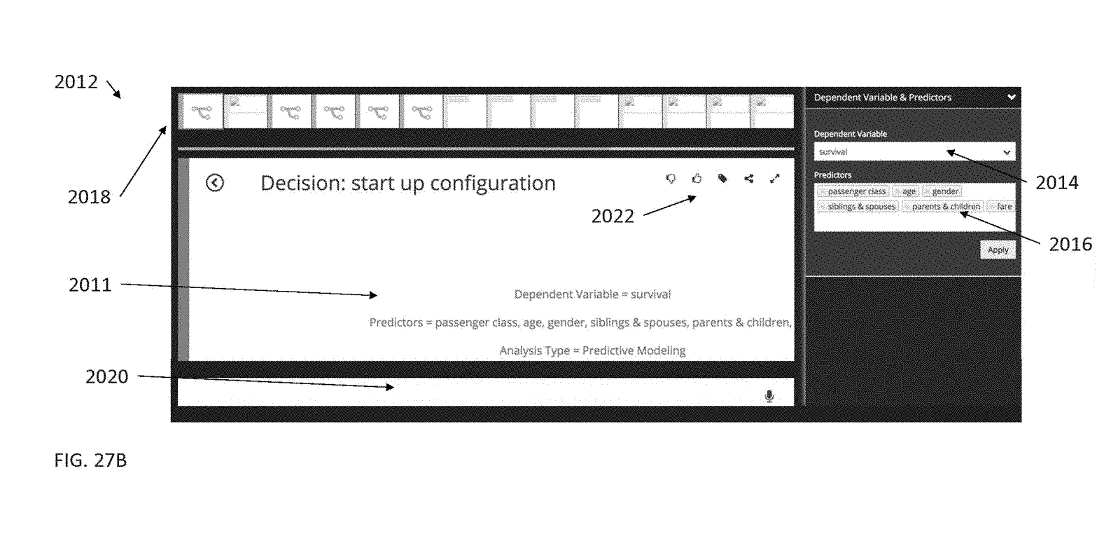

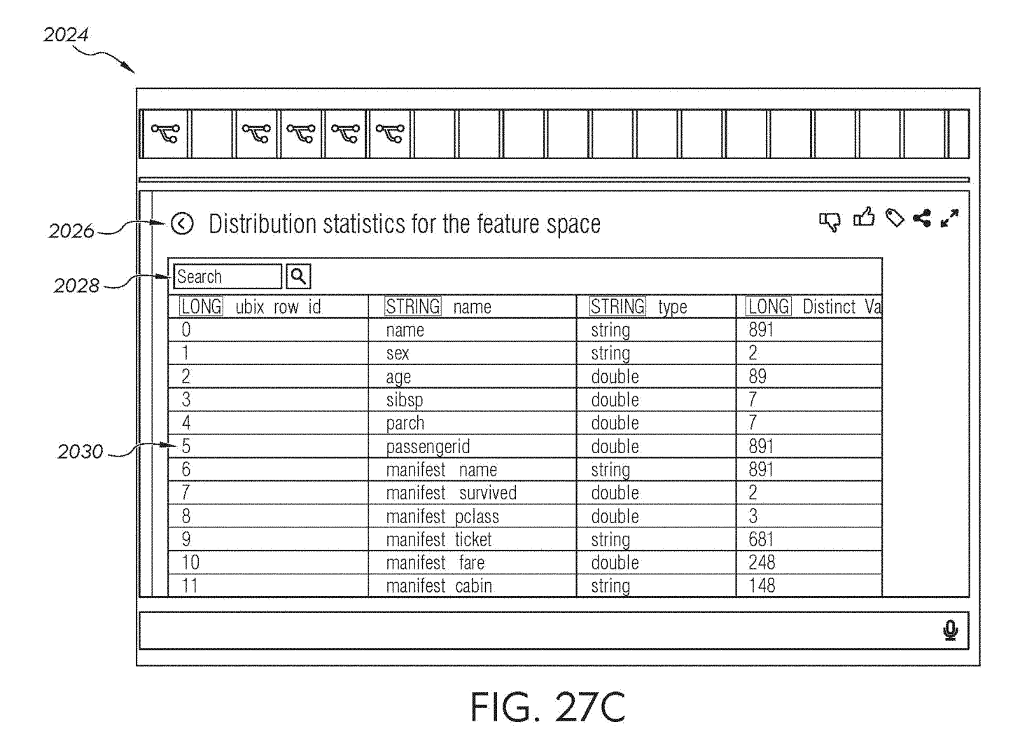

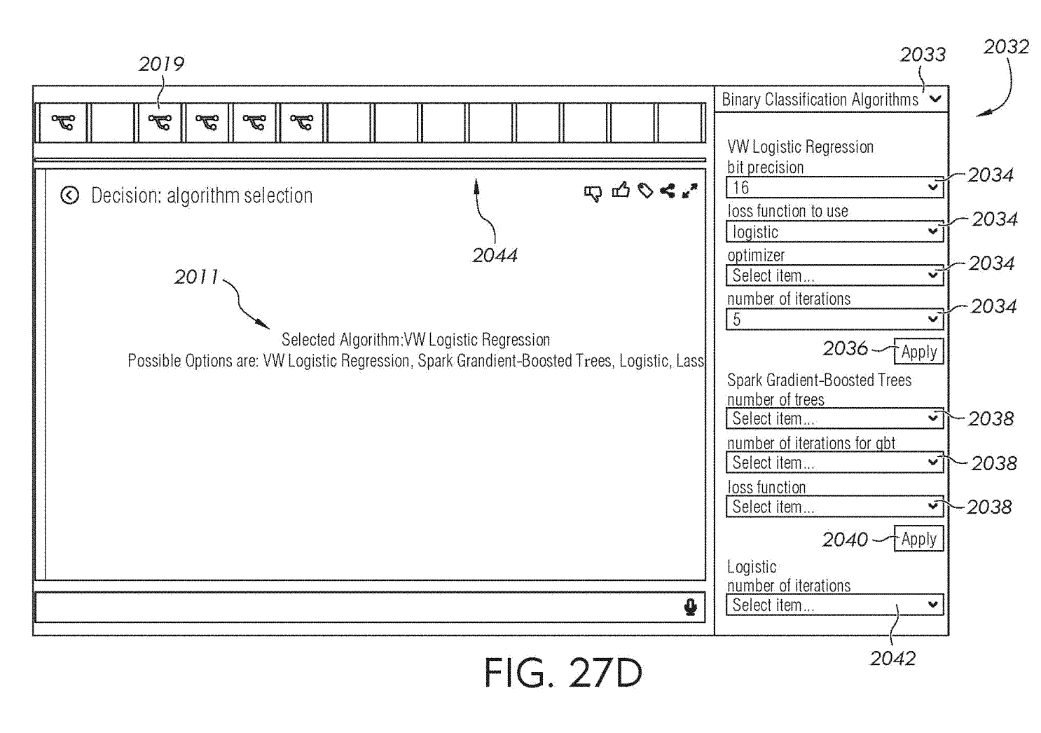

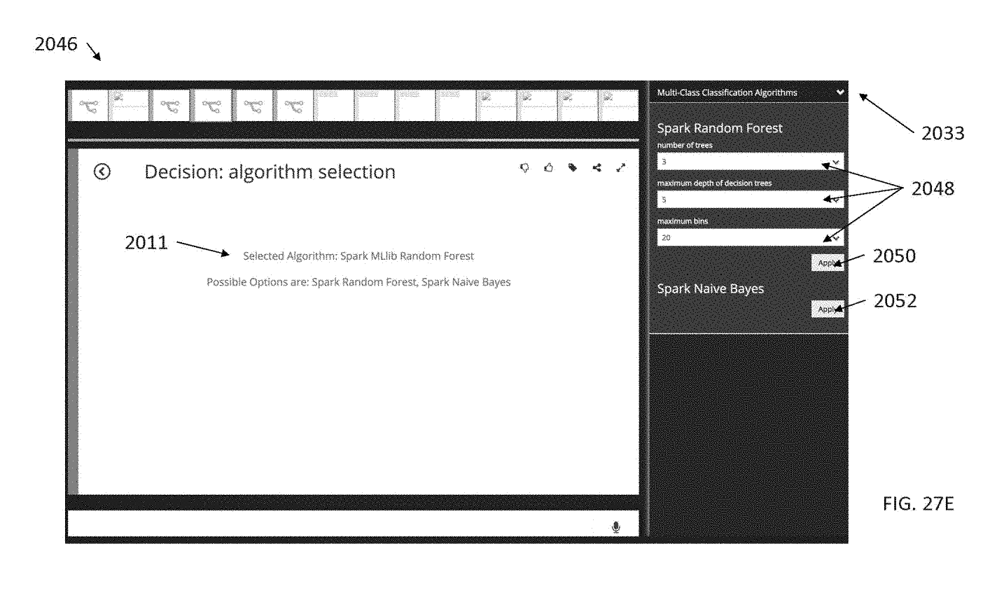

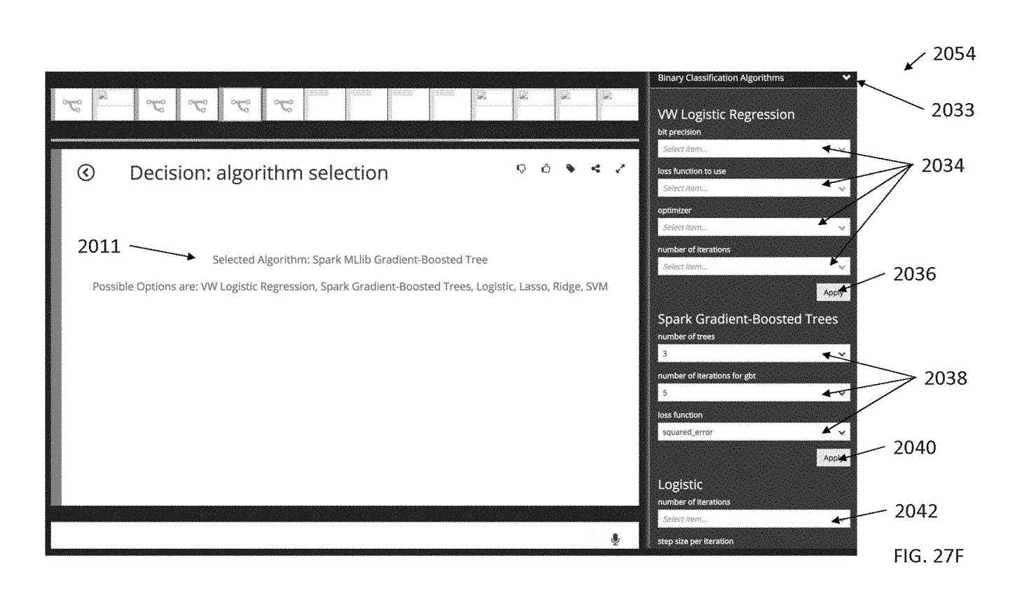

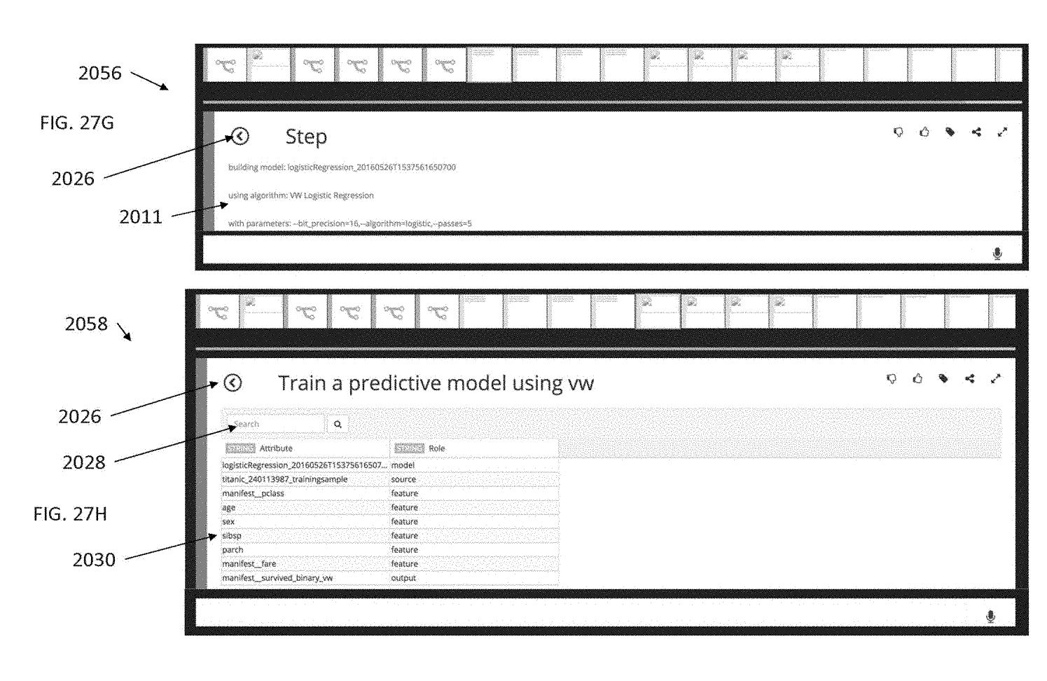

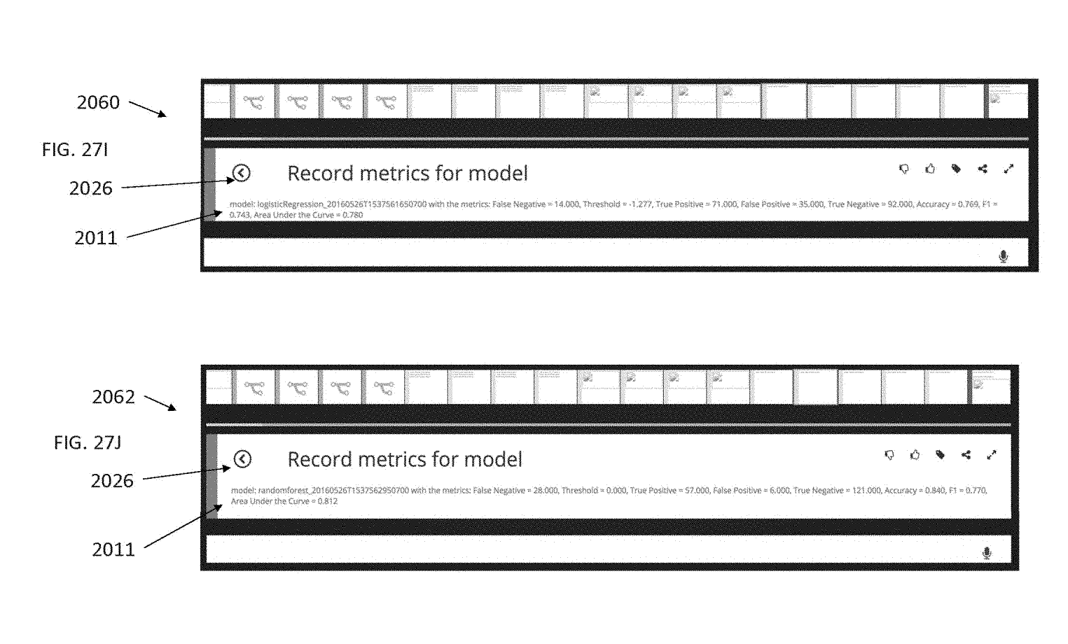

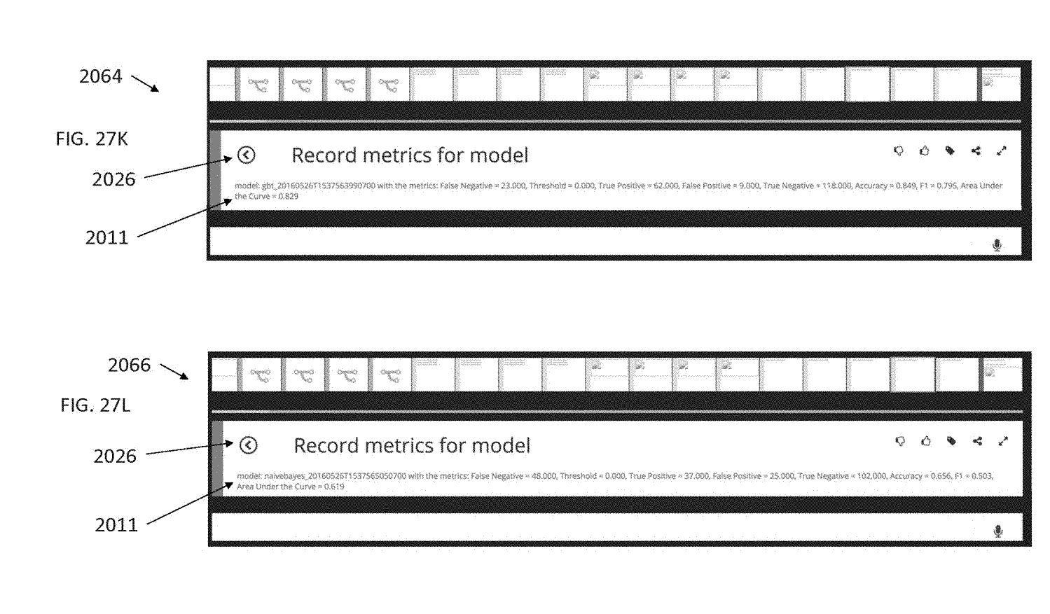

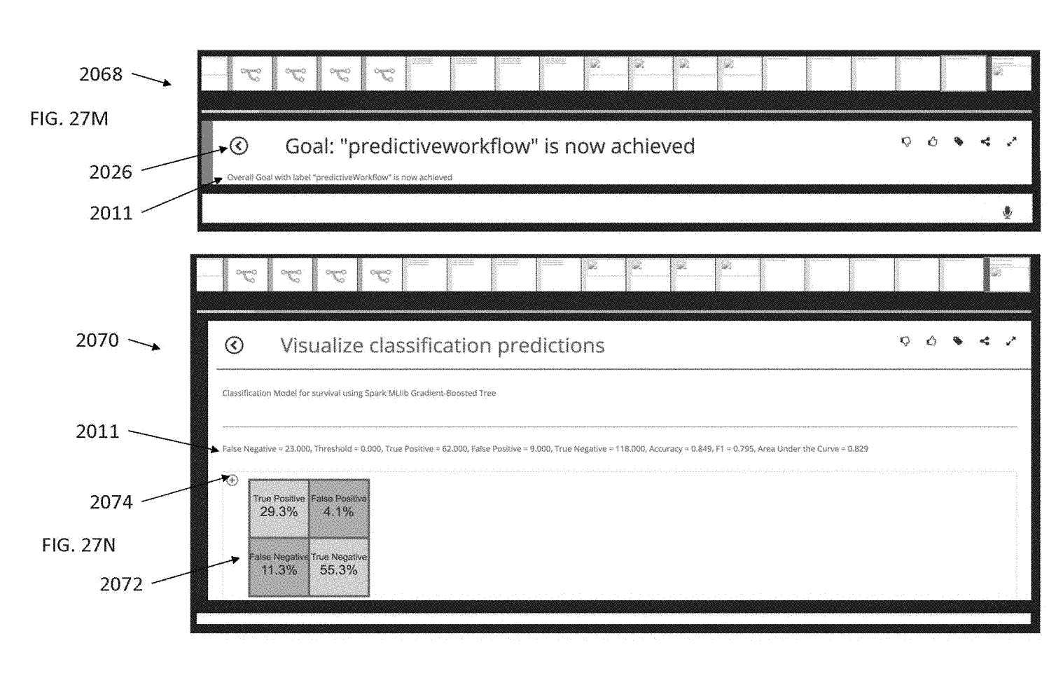

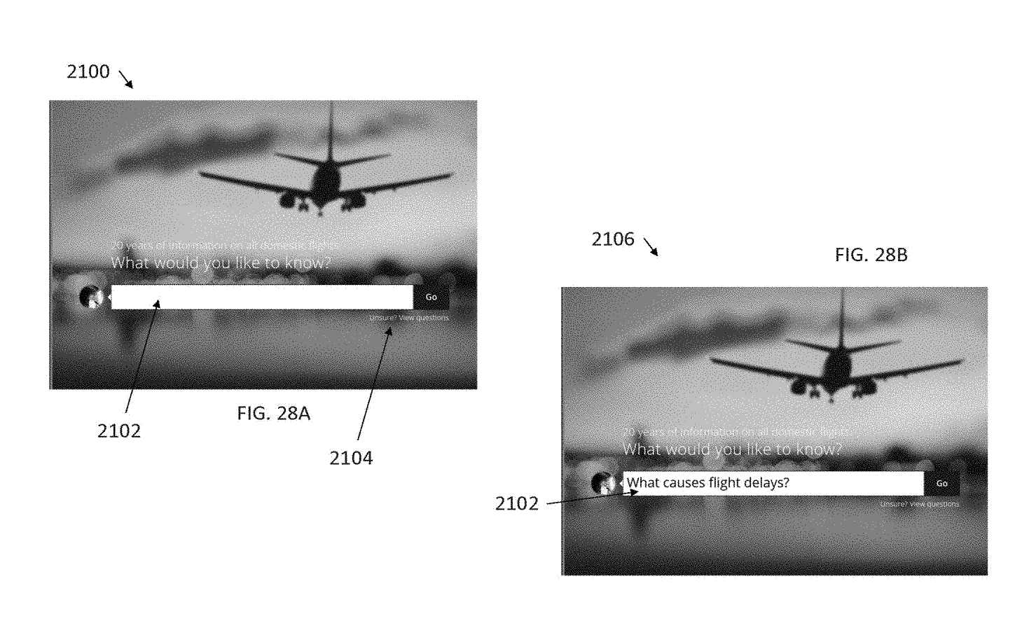

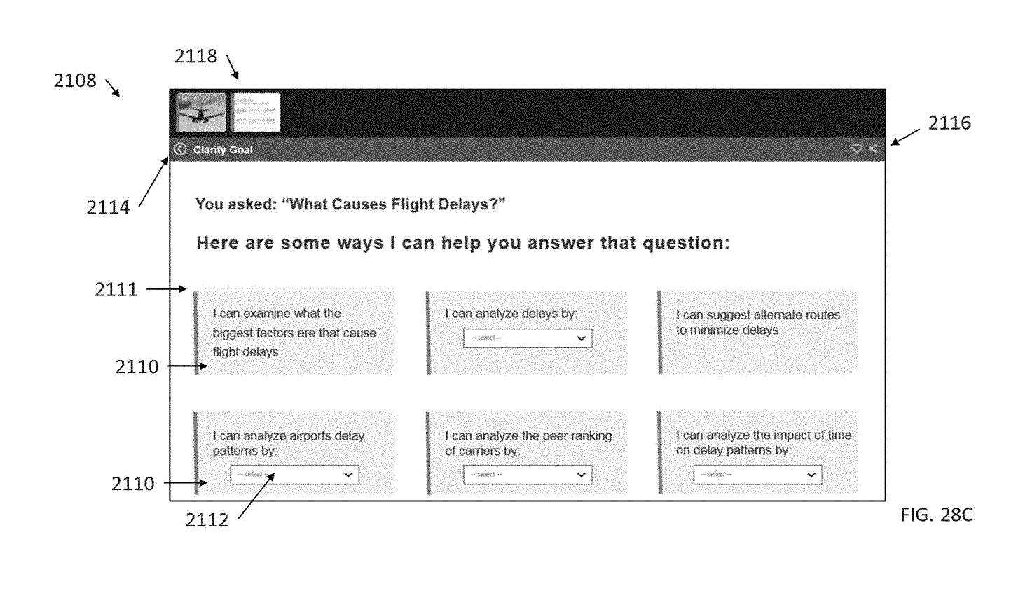

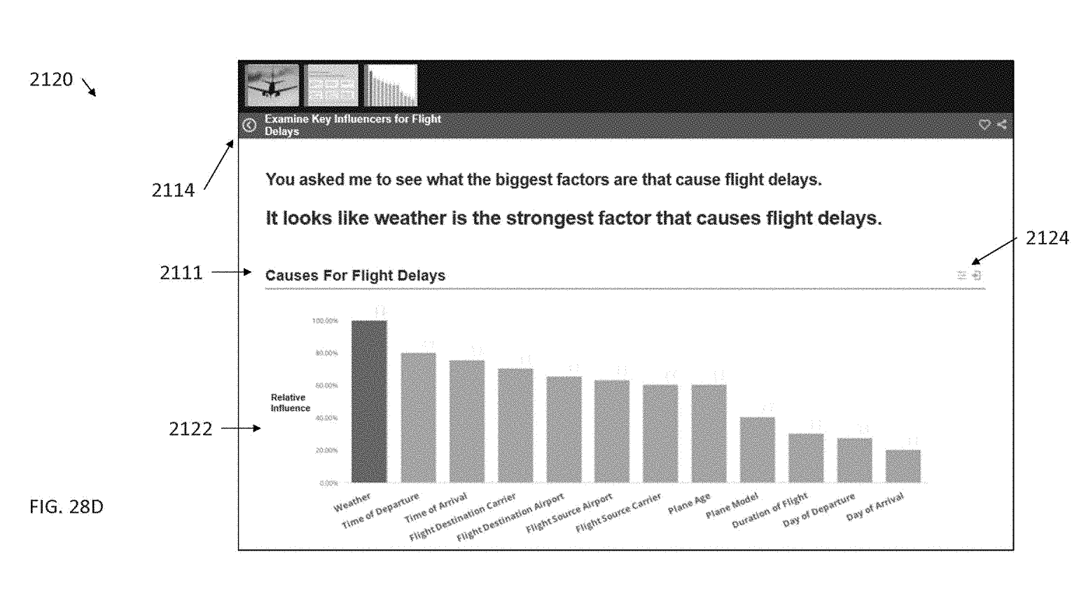

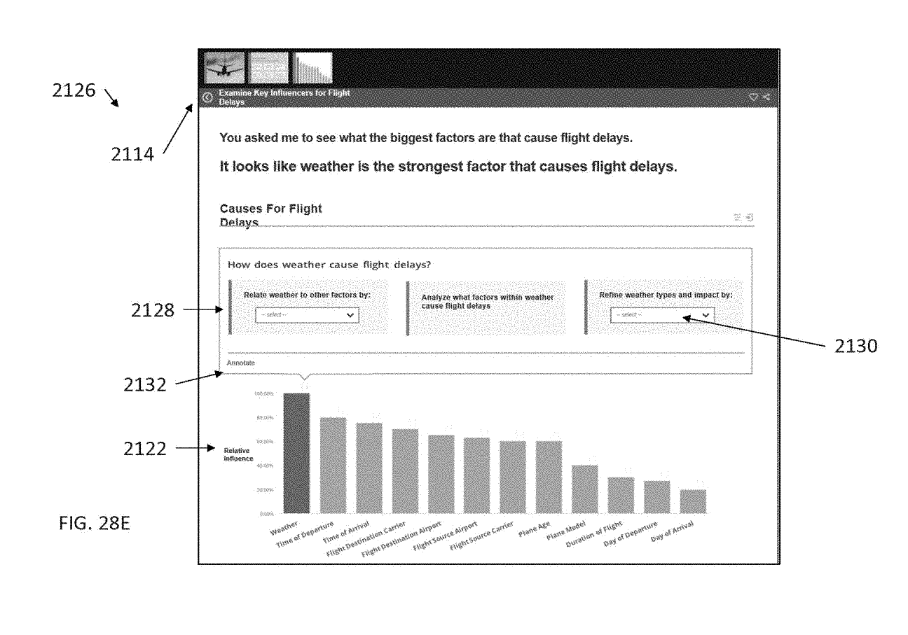

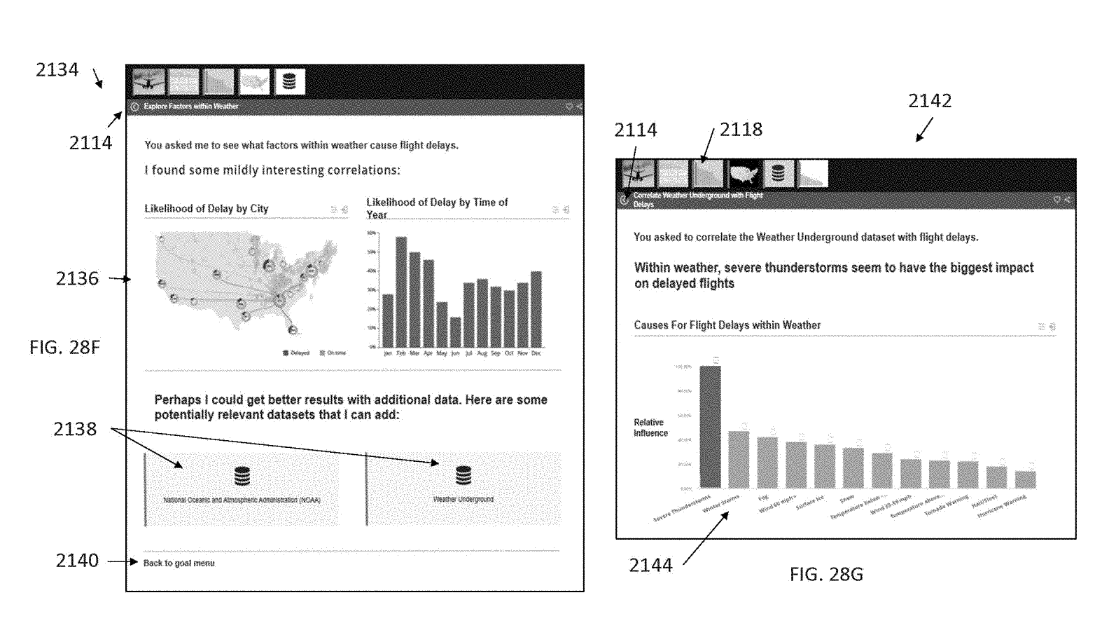

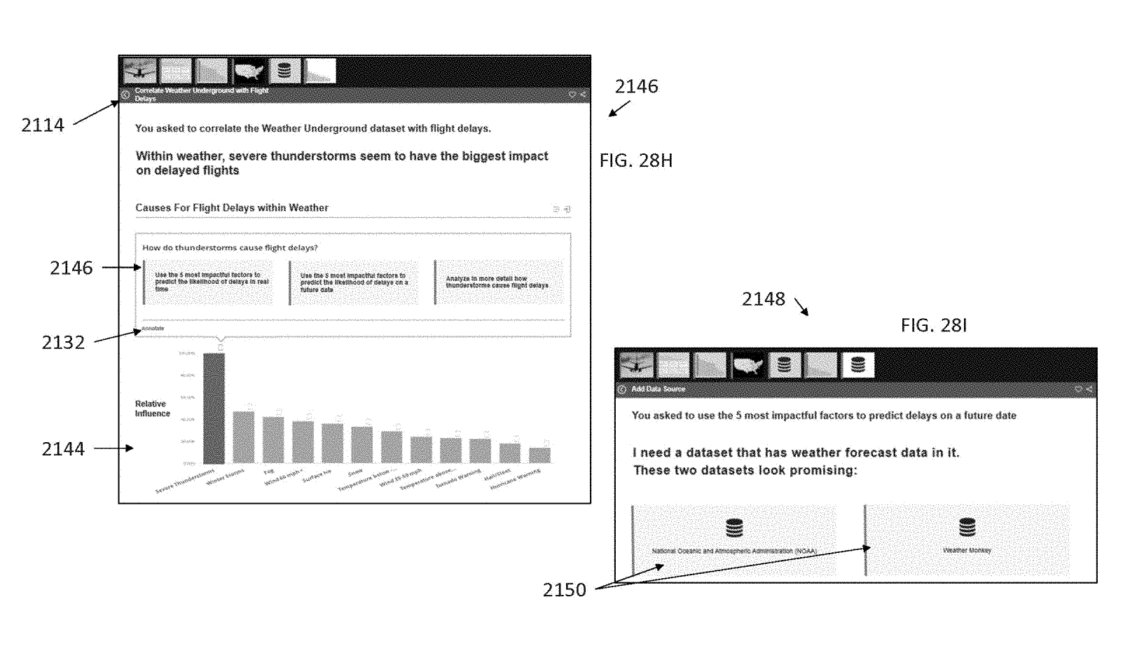

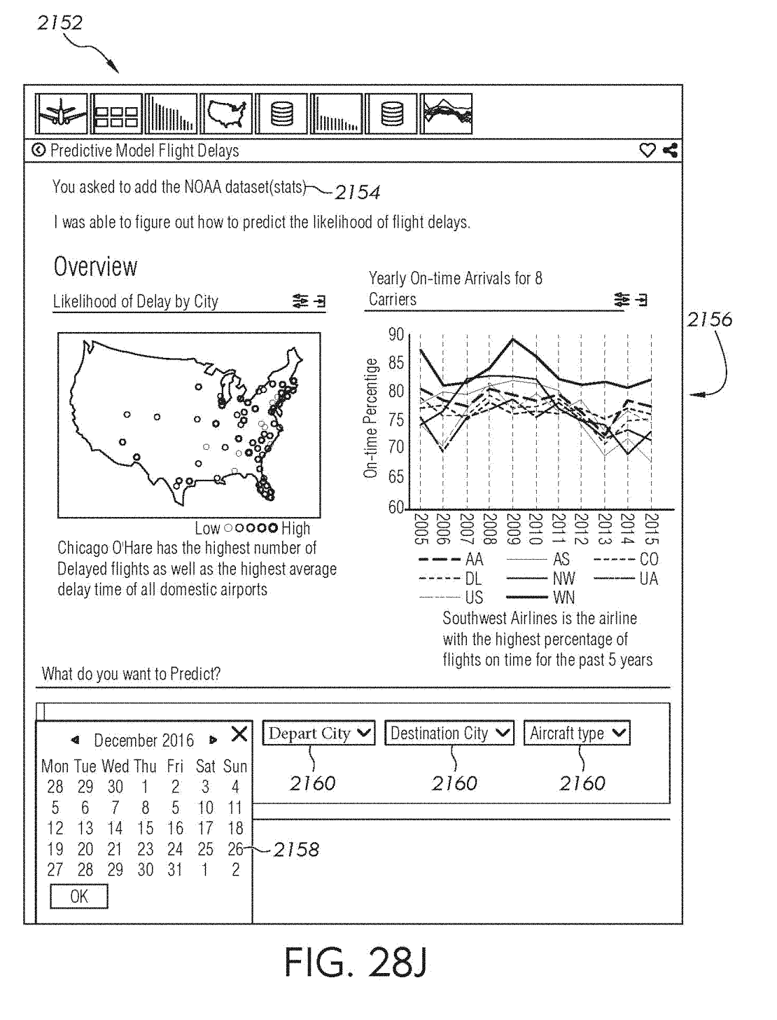

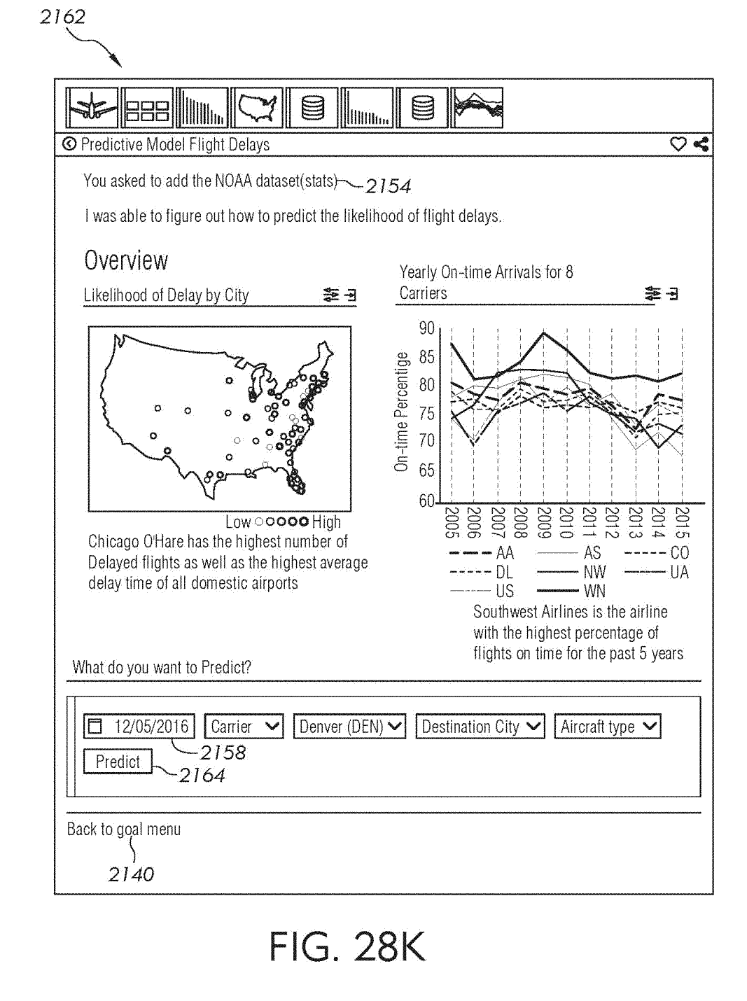

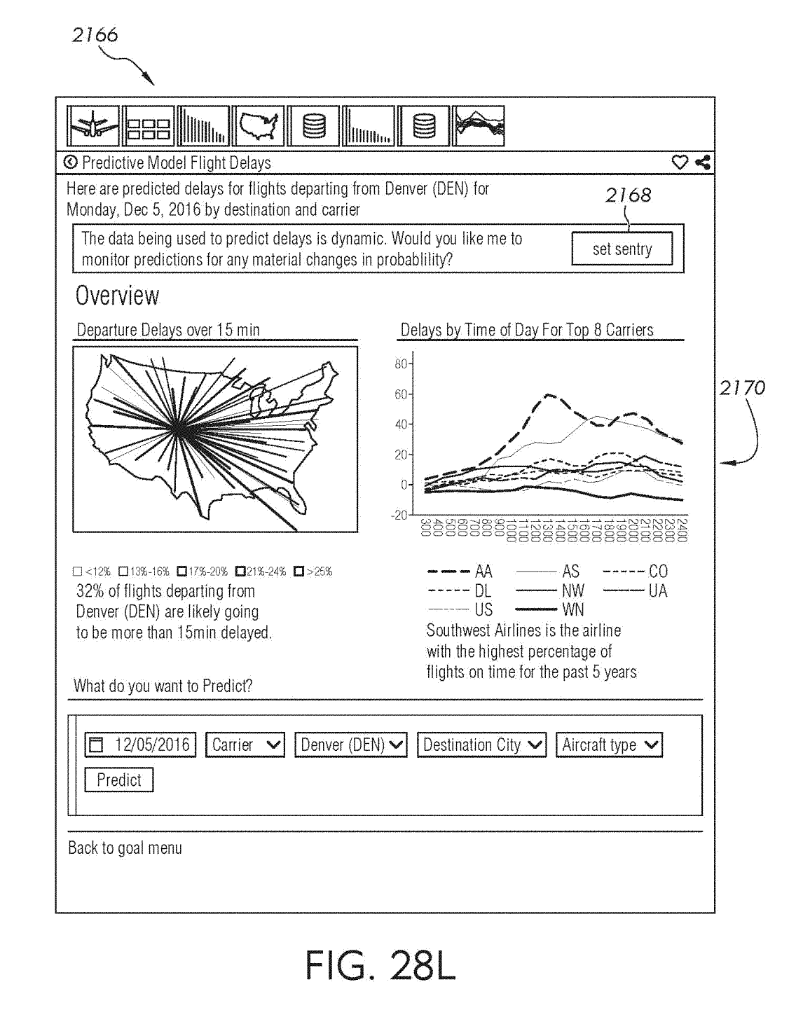

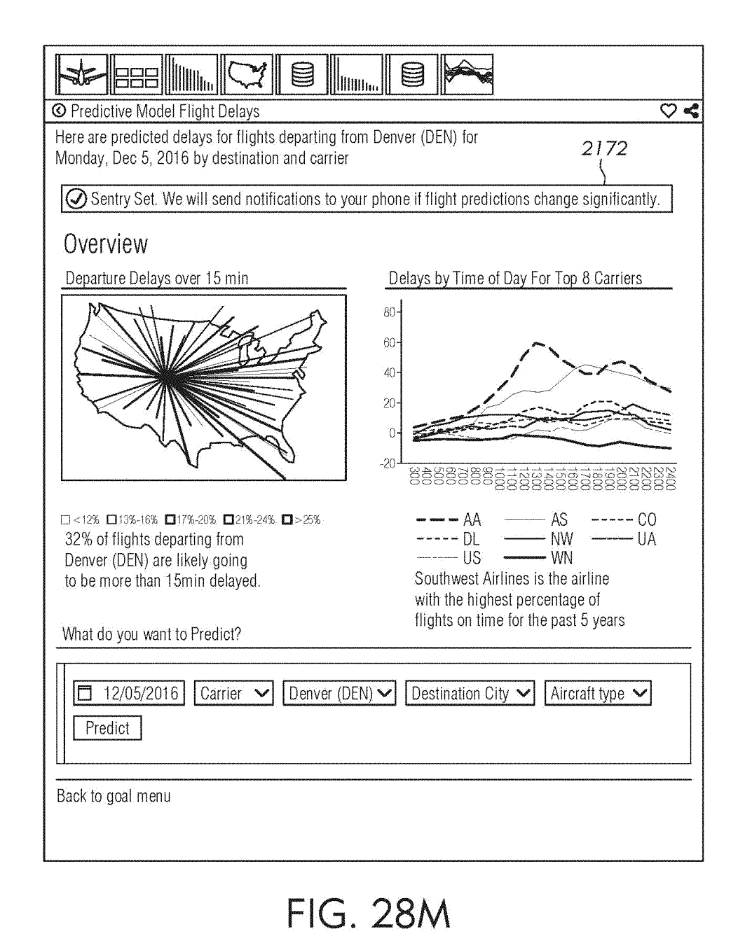

FIG. 26 shows an example embodiment of a user interface screen 1900 for an initial inquiry in many use cases. In the example embodiment a user can select various datasets from listing area 1902 to perform or view analysis on, such as: horse colic, robot arm kinematics, tic-tac-toe endgame, Wisconsin Prognostic Breast Cancer, Iris, Diabetes diagnosis, placeholder analysis, airline delay (see FIGS. 28A-28M), anonymized U.S. credit approval, German credit rating, Titanic (see FIGS. 27A-27N), HP spam email, HIS Ships and Ports, HIS Ship Geographic Locations, Taxi Geo Location. Users can also select buttons for home, saved, settings, and others.

FIG. 27A shows an example embodiment of a first user interface screen 2000 for a Titanic workflow use case. In the example embodiment a user can view a title 2002 and select various dependent variables and predictors from a menu, such as a drop down menu 2004. Here, these include selections 2006 such as passenger class, age group, gender, siblings and spouses, parents and children and fare that are displayed in a selected predictors area. A user can then select or enter a type of analysis to perform in a search area 2008 such as data exploration (highlighted as selected), predictive modeling, forecasting, feature selection, custom, reset configurations, clear meta store and reset conversations. Users can also favorite, perform analysis, expand or minimize the screen, or perform other functions by selecting appropriate buttons 2010.

FIG. 27B shows an example embodiment of a second user interface screen 2012 for a Titanic workflow use case. As shown in information display 2011, a user has selected a dependent variable to be survival, which is modifiable in field 2014; predictors elected, modifiable in predictors field 2016, are passenger class, age, gender, siblings and spouses and parents and children; and an analysis type chosen is predictive modeling. A predictive modeling workflow has been initiated as indicated by the “insight tiles” 2018 across the top of the diagram 2012. In the example embodiment users can also enter data into field 2020 or speak into a microphone to modify various factors, and can select buttons 2022 to like, dislike, tag, run, and change screen sizes.

As AC generates and executes a workflow it also decides what workflow steps and results to display to the user. In this diagram the first step in the workflow is shown.

FIG. 27C shows an example embodiment of a third user interface screen 2024 for a Titanic workflow use case. As shown, a user can enter a term into search field 2028 in order to view and select distribution statistics of the feature space to be displayed in chart 2030 rows by names and having particular types and variable numbers. Users can also return to a previous screen by selecting back button 2026.

FIG. 27D shows an example embodiment of a fourth user interface screen 2032 for a Titanic workflow use case. The selected “insight tile” 2019 at the top of the screen is showing a “decision tile” is selected. As shown, a user can perform a decision regarding algorithm selection. Here, the user can select a type of classification algorithm by selecting button 2033 which can then display a popup menu, dropdown menu, or other types of information displays. As shown, the user has selected binary classification algorithms. In the example embodiment, information display 2011 shows selected and possible options for a VW Logistic regression including VW Logistic Regression, Spark Gradient-Boosted Trees, Logistics and others. The VW Logistic Regression can be further tuned by selecting customization buttons 2034. Here these include a bit precision number, a loss function to use, an optimizer, and a number of iterations before applying the changes with the apply button 2036. The Spark Gradient Booster Trees can be further tuned by selecting buttons 2038, such as a number of trees, a number of iterations for GBT, and loss functions, before applying them with apply button 2040. Logistics can be tuned by selecting button 2042, here including a number of iterations. Also shown is a status indicator bar 2044, showing that the current algorithm being run is more than halfway complete.

FIG. 27E shows an example embodiment of a fifth user interface screen 2046 for a Titanic workflow use case. As shown, a user can perform a decision regarding algorithm selection. Here, the user can select a type of classification algorithm by selecting button 2033 which can then display a popup menu, dropdown menu, or other types of information displays. As shown, the user has selected multi-class classification algorithms. This has in turn caused the information display 2011 to show selected interactive algorithm of Spark MLlib Random Forest algorithm with possible options including Spark Random Forest and Spark Naive Bayes. Spark Random Forest can further be tuned by selecting customization buttons 2048, including a number of trees, a maximum depth of decision trees, and a maximum number of bins before applying the algorithm with apply button 2050. Alternatively, the user can select the apply button 2052 to run Spark Naive Bayes algorithm.

FIG. 27F shows an example embodiment of a sixth user interface screen 2054 for a Titanic workflow use case. Information display 2011 shows selected and possible options for an algorithm selection for Spark MLlib Gradient-Boosted Tree can include options such as VW Logistic Regression, Spark Gradient Boosted Trees, Logistics, Lasso, Ridge and SVM. As shown, a user can perform a decision regarding algorithm selection. Here, the user can select a type of classification algorithm by selecting button 2033 which can then display a popup menu, dropdown menu, or other types of information displays. As shown, the user has selected binary classification algorithms. The VW Logistic Regression can be further tuned by selecting customization buttons 2034. Here these include a bit precision number, a loss function to use, an optimizer, and a number of iterations before applying the changes with the apply button 2036. The Spark Gradient Booster Trees can be further tuned by selecting buttons 2038, such as a number of trees, a number of iterations for GBT, and loss functions, before applying them with apply button 2040. Logistics can be tuned by selecting button 2042, here including a number of iterations.

FIG. 27G shows an example embodiment of a seventh user interface screen 2056 for a Titanic workflow use case. As information display 2011 shows, an algorithm analysis step can include various options selected by a user. Here the user is using a building model named logisticRegression_20160526T1537561650700, an algorithm named VW Logistic Regression, and listed parameters including —bit_precision=16, —algorithm+logistic, —passes=5. Users can also return to a previous screen to edit these choices by selecting back button 2026.

FIG. 27H shows an example embodiment of an eighth user interface screen 2058 for a Titanic workflow use case. As shown, a user can enter a term into search field 2028 in order to view and select string attributes and role of the feature space to be displayed in chart 2030, where rows describe names and roles of each option. As shown, roles can be model, feature, output, and others. Users can also return to a previous screen by selecting back button 2026. In other words, rows that are displayed reveal the feature space and target output variable that is used to train a predictive model using vw.

FIG. 27I shows an example embodiment of a ninth user interface screen 2060 for a Titanic workflow use case. As information display 2011 shows, evaluation metrics for the vw logistic regression model screen here are a first set of metrics resulting from its model training phase. These can be recorded or otherwise stored in non-transitory memory for later use. Various types of information can be displayed here. In the example embodiment, these include model name and metric types, including False Negative, Threshold, True Positive, False Positive, True Negative, Accuracy, F1, and Area Under the Curve. Here, False Negative=14.000, Threshold=−1.277, True Positive=71.000, False Positive=35.000, True Negative=92.000, Accuracy=0.769, F1=0.743, and Area Under the Curve=0.780. Users can also return to a previous screen by selecting back button 2026.

FIG. 27J shows an example embodiment of a tenth user interface screen 2062 for a Titanic workflow use case. As information display 2011 shows, evaluation metrics for the random forest model screen here are a first set of metrics resulting from its model training phase. These can be recorded or otherwise stored in non-transitory memory for later use. Various types of information can be displayed here. In the example embodiment, these include model name and metric types, including False Negative, Threshold, True Positive, False Positive, True Negative, Accuracy, F1, and Area Under the Curve. Here, False Negative=28.000, Threshold=0.000, True Positive=57.000, False Positive=6.000, True Negative=121.000, Accuracy=0.840, F1=0.770, and Area Under the Curve=0.812. Users can also return to a previous screen by selecting back button 2026.

FIG. 27K shows an example embodiment of an eleventh user interface screen 2064 for a Titanic workflow use case. As information display 2011 shows, evaluation metrics for the evaluation metrics for the gradient-boosted tree (GBT) model screen show a third set of metrics resulting from its model training phase. These can be recorded or otherwise stored in non-transitory memory for later use. Various types of information can be displayed here. In the example embodiment, these include model name and metric types, including False Negative, Threshold, True Positive, False Positive, True Negative, Accuracy, F1, and Area Under the Curve. Here, False Negative=23.000, Threshold=0.000, True Positive=62.000, False Positive=9.000, True Negative=118.000, Accuracy=0.849, F1=0.795, and Area Under the Curve=0.829. Users can also return to a previous screen by selecting back button 2026.

FIG. 27L shows an example embodiment of a twelfth user interface screen 2066 for a Titanic workflow use case. As information display 2011 shows, evaluation metrics for the evaluation metrics for the naive bayes model screen can display and record a fourth set of metrics chosen for the model. These can be recorded or otherwise stored in non-transitory memory for later use. Various types of information can be displayed here. In the example embodiment, these include model name and metric types, including False Negative, Threshold, True Positive, False Positive, True Negative, Accuracy, F1, and Area Under the Curve. Here, False Negative=48.000, Threshold=0.000, True Positive=37.000, False Positive=25.000, True Negative=102.000, Accuracy=0.656, F1=0.503, and Area Under the Curve=0.619. Users can also return to a previous screen by selecting back button 2026.

FIG. 27M shows an example embodiment of a thirteenth user interface screen 2068 for a Titanic workflow use case indicating in information display 2011 that the instance of the predictive modeling workflow for the Titanic dataset has completed. Users can also return to a previous screen by selecting back button 2026.

FIG. 27N shows an example embodiment of a fourteenth user interface screen 2070 for a Titanic workflow use case. As shown in information display 2011, users can be prompted for or otherwise shown a visualization of classifications for the winning (most accurate) predictions. Here, this is shown in a chart 2072 with true positive and true negative in green and false positive and false negative in red. As shown, information regarding the simulation of Classification Model for survival using MLlib Gradient-Boosted Tree is False Negative=23.000, Threshold=0.000, True Positive=62.000, False Positive=9.000, True Negative=118.000, Accuracy=0.849, F1=0.795, and Area Under the Curve=0.829. As such, in chart 2072, True Positive=29.3%, False Positive=4.1%, False Negative=11.3%, and True Negative=55.3%. Users can expand the area including chart 2072 by selecting 2074, which can enlarge chart 2072 or show additional visualization options as appropriate.

FIG. 28A shows an example embodiment of a first user interface screen 2100 for a flight delay workflow use case. As shown in the example embodiment, a user can enter a question in an input field 2102 and select a go button to begin a search or, if a user would like suggestions, they can select previous questions for viewing by selecting help button 2104.

FIG. 28B shows an example embodiment of a second user interface screen 2106 for a flight delay workflow use case. As shown in the example embodiment, a user can has entered a question in an input field 2102, asking “What causes flight delays?” The system may then process the question, before asking for clarification if necessary, e.g. see FIG. 28C.

FIG. 28C shows an example embodiment of a third user interface screen 2108 for a flight delay workflow use case. As shown, the system has processed a question asked by a user and displays the question asked and various options available for user consideration in information display 2111. These various options can help to clarify the user's ultimate goal and provide suggestions for the user to consider. Here these questions and suggestions include selectable buttons 2110. As shown, for the example embodiment these are: examining the biggest factors that cause flight delays, analyze delays according to parameters, suggest alternate routes to minimize delays, analyze airport delay patterns by parameters, analyze peer ranking of carriers by parameters and analyze the impact of time on delay patterns by parameters. Some buttons 2110 can also include one or more dropdown or other menus 2112, text input fields (not shown), or others. Users can also select a back button 2114 top return to a previous screen; buttons 2116 to favorite, run algorithm button, or others and interactive tile buttons 2118.

FIG. 28D shows an example embodiment of a fourth user interface screen 2120 for a flight delay workflow use case. In the example embodiment, if a user requests information about the biggest factors causing flight delays, the system can analyze and display various factors and their relative influences in information display 2111. As show, this may result in visualization 2122 of answers or relevant data in the form of bar charts, pie graphs, or various other types of display indications. As shown, relative influence in percent and various factors such as weather, time of departure, time of arrival, flight destination carrier, flight destination airport, flight source airport, flight source carrier, plane age, plane model, duration of flight, day of departure, and day of arrival have all been analyzed. In some embodiments, visualizations can be interacted with by selecting portions shown. Users can select buttons 2124 to export, share, save, list, or otherwise interact with results. Users can also select a back button 2114 top return to a previous screen.

FIG. 28E shows an example embodiment of a fifth user interface screen 2126 for a flight delay workflow use case. As shown, the user can select options to determine how a particular factor influences the original question. Here the user has selected a portion of the visualization 2122 for weather. In response, the system has provided several suggestions that the user may wish to use, in order to determine how weather causes flight delays. These are provided in the form of selectable buttons 2128 that allow the user to continue by selecting other related factors, more specific information, analysis of what factors within a chosen factor influence the delays, and refining factors to determine how different aspects of a factor influences flight delays. Some buttons 2128 can also include one or more dropdown or other menus 2130, text input fields (not shown), or others. Additionally, users can view and edit information by selecting an annotate button 2132 or entering information or notes into a field (not shown). Users can also select a back button 2114 top return to a previous screen.

FIG. 28F shows an example embodiment of a sixth user interface screen 2134 for a flight delay workflow use case. As shown, the system can analyze and then display correlations between different factors. In some embodiments, this occurs due to user selections and in some embodiments, it can occur as a feature of the system. Here, the system has found results that are correlated with weather causing flight delays, including likelihood of delay by city and likelihood of delay by time of year. These are displayed individually or collectively in visualization area 2136 and can be individually or collectively exported, saved, manipulated, and otherwise interacted with.

Additionally, in some embodiments the system can also determine that accessing additional datasets may help to provide enhanced results. The system can display its proposed suggestions in the form of additional related datasets with selectable buttons 2138 that that may help to further refine and enhance results. Here these are the National Oceanic and Atmospheric Administration (NOAA) and Weather Underground datasets. These can be third party databases or datasets that the system has access to in some embodiments. In some embodiments, these may be proprietary databases or datasets. In some embodiments, these can be links to or through search engines or other programs. Also shown is a selectable “back to goal menu” button 2140 that will take a user back to a goal menu to further refine or change their current search or query goals. Users can also select a back button 2114 top return to a previous screen.

FIG. 28G shows an example embodiment of a seventh user interface screen 2142 for a flight delay workflow use case. As shown, the system can display refined results in the form of visualization 2144 based on user selections and system processing in some embodiments. Here, the user query has asked for a correlation of a Weather Underground dataset with flight delays and the system has performed this action. Results in visualization 2144 include Relative Influence in percentage of factors including severe thunderstorms, winter storms, fog, wind over sixty miles per hour, surface ice, snow, temperature below, wind speeds, temperature, tornado warning, hail and sleet, hurricane warning, and others. In some embodiments, visualizations can be interacted with by selecting portions shown.

Additionally, as shown in the example embodiment, insight tiles 2118 show each step that the user has taken and that the system has performed. Here, the original question tile is first, refinement is second, initial results are third, correlated results are fourth, correlation with additional datasets is fifth, and current results screen is sixth. Users can select these interactive tiles in order to return to any portion of their line of inquiry to modify or view these previous screens. Users can also select a back button 2114 top return to a previous screen.

FIG. 28H shows an example embodiment of an eighth user interface screen for a flight delay workflow use case. As shown, the user can select options to determine how a particular factor influences the original question. Here the user has selected a portion of the visualization 2144 for severe thunderstorms. In response, the system has provided several suggestions that the user may wish to use, in order to determine how thunderstorms cause flight delays. These are provided in the form of selectable buttons 2146 that allow the user to continue by selecting the five most impactful factors to predict the likelihood of delays in real time, the five most impactful factors to predict the likelihood of delays on a future date, and analyze in more detail how thunderstorms cause delays. Additionally, users can view and edit information by selecting an annotate button 2132 or entering information or notes into a field (not shown). Users can also select a back button 2114 top return to a previous screen.

FIG. 28I shows an example embodiment of a ninth user interface screen 2146 for a flight delay workflow use case. As shown, the user can ask different questions at different portions of the analysis. Here the user has requested a determination on what the five most impactful factors are that can predict delays on future dates. The system has analyzed the request and recommended datasets with factor data that may not be currently included as selectable buttons 2150 for the National Oceanic and Atmospheric Administration (NOAA) and Weather Underground and Weather Monkey datasets.

FIG. 28J shows an example embodiment of a tenth user interface screen 2152 for a flight delay workflow use case. As shown, the system can analyze and display results based on a chosen dataset(s). Here, users can select a further information button 2154 to learn more about the dataset selected. Data visualization 2156 shows an overview of different types of delay information related to the user's query.

As also shown, the user can further modify or manipulate the results based on relevant information. For the example embodiment, this includes selecting one or more dates or ranges in a calendar window 2158. It also includes various dropdown menus 2160 to set departure cities, destination cities, or other locations information, as well as aircraft types, to further refine results.

FIG. 28K shows an example embodiment of an eleventh user interface screen 2162 for a flight delay workflow use case that is similar to FIG. 28J. As shown, the system can perform further analysis based on fine-tuned parameters chosen by the user. Here, the user has further modified or manipulated the results based on relevant information. For the example embodiment, this includes selecting Dec. 5, 2016 in calendar window 2158. It also includes various dropdown menus 2160, where departure city is set as Denver and no carrier, destination city, or aircraft type has been chosen to further define results. If this is the only data the user wishes to review, they can select the predict button 2164 to cause the system to process the inquiry and generate a result.

FIG. 28L shows an example embodiment of a twelfth user interface screen 2166 for a flight delay workflow use case. As shown, the system has processed the user inquiry from the embodiment of FIG. 28K. Results are shown in visualizations are 2170, which describe that 32% of flights departing from Denver are likely going to be more than 15 minutes delayed based on the dataset(s) analyzed. It also shows and describes that Southwest Airlines is the airline with the highest percentage of flights on time for the past 5 years of data analyzed. Users can modify their inquiry or perform a new inquiry using buttons described in FIG. 28J-28K. Additionally, the system proposes monitoring functions to the user that may help to further refine results further over time. This function is especially useful where data is dynamic and may change frequently. As shown, a set sentry button 2168 can be selected by a user that causes the system to periodically or continuously update results based on the inquiry stated. In some embodiments, users can select how frequently they wish to have the dataset updated and re-analyzed. In such embodiments, the system can provide the updated information to the user in one or more of a variety of formats. For example, it may transmit an alert to a user via email, via SMS or MMS, via phone call, via fax, via text message, or any other number of communication forms and formats.

FIG. 28M shows an example embodiment of a thirteenth user interface screen 2172 for a flight delay workflow use case. As shown, the system has set the monitoring functions, here as a “sentry” and is displaying a confirmation that the information has been registered and stored by the system.

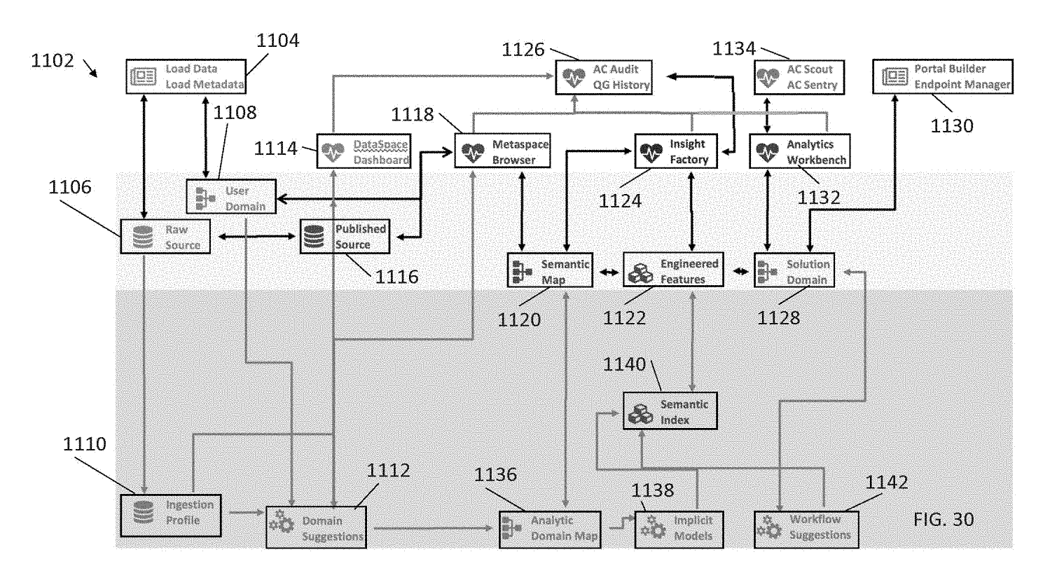

FIG. 29 shows an example embodiment diagram 735 showing overall user interface themes. In general, these can include analytic content inputs and outputs mapped to nudge types and machine learning workflow processes associated with user controls. Column 736 shows data types. Column 737 shows ontologies used. Column 738 shows aggregation types. Column 739 shows model, workflow, or rules used or applied. Column 740 shows dashboard or editor used. Column 741 shows standard user interface controls. It should be understood that diagram 735 can be a process diagram of the primary learning workflow using analytic content inputs and outputs shown in FIG. 30 in an abstract logical architecture diagram.

Sources row 742 shows source data information. Domains row 743 shows map domain and metadata information. Schema row 744 shows edit or query schema and features. Analytics row 745 shows build custom analytics workflows. Insights 746 row shows audit and nudge AC insights. Apps row 747 shows curate and publish apps information.

As shown, the data type for sources row 742 is raw source data. The data type for domains row 743 is published source data. The data type for schema row 744 is modified source data. The data type for analytics row 745 is analyzed source data. The data type for insights row 746 is solution source data. The data type for apps row 747 is app source data.

The ontologies used for sources row 742 is data dictionary. The ontologies used for domains row 743 is user domain. The ontologies used for schema row 744 is default domain. The ontologies used for analytics row 745 is analytic domain. The ontologies used for insights row 746 is solution domain. The ontologies used for apps row 747 is app domain.

The aggregation type for sources row 742 is quantitative summary. The aggregation type for domains row 743 is semantic summary. The aggregation type for schema row 744 is engineered features. The aggregation type for analytics row 745 is model score usages. The aggregation type for insights row 746 is visualization support. The aggregation type for apps row 747 is app support.

The model, workflow, or rules used or applied for the data type for sources row 742 is implicit models. The model, workflow, or rules used or applied for domains row 743 is relate, join, type, and goal. The model, workflow, or rules used or applied for schema row 744 is implicit models. The model, workflow, or rules used or applied for analytics row 745 is workflow improvements. The model, workflow, or rules used or applied for insights row 746 is insight management. The model, workflow, or rules used or applied for apps row 747 is sentry policies and scout missions.

The dashboard or editor used for sources row 742 is dataspace dashboard. The dashboard or editor used for domains row 743 is metaspace dashboard. The dashboard or editor used for schema row 744 is insight factory. The dashboard or editor used for analytics row 745 is analytics workbench. The dashboard or editor used for insights row 746 is AC Audit and QG Manager. The dashboard or editor used for apps row 747 is model performance.

The standard user interface controls for sources row 742 is load static and schedule stream. The standard user interface controls for domains row 743 is add features and add aggregations. The standard user interface controls for schema row 744 is load data and load metadata. The standard user interface controls for analytics row 745 is gestalt modeling and DSL workbench. The standard user interface controls for insights row 746 is portal builder and endpoint manager. The standard user interface controls for apps row 747 is solution status and integration management. Examples of each of rows 742, 743, 744, 745, 746, and 747 are provided herein with respect to FIG. 30.

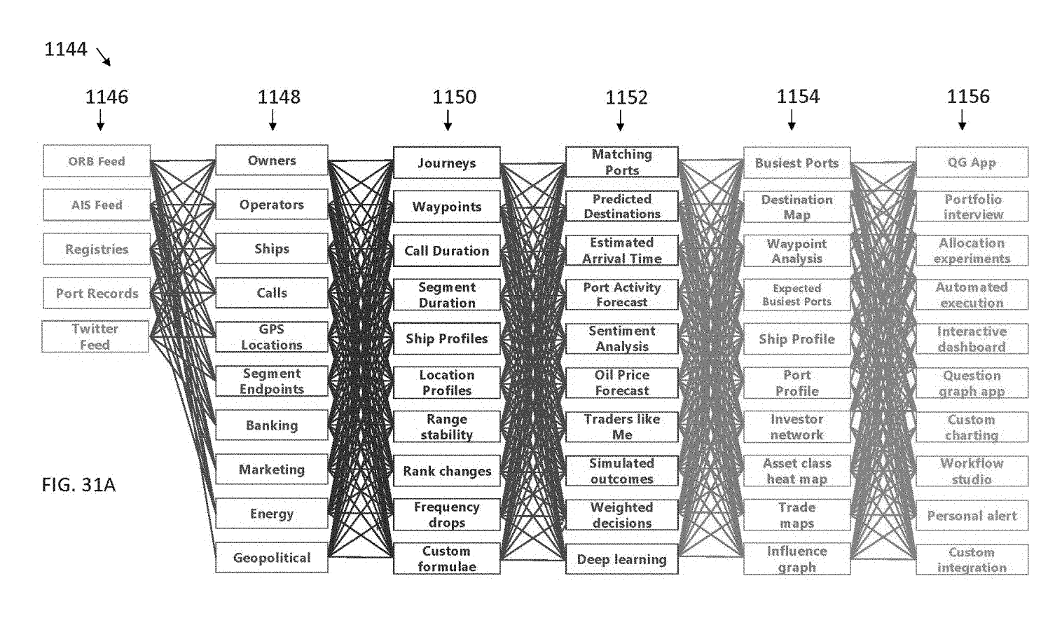

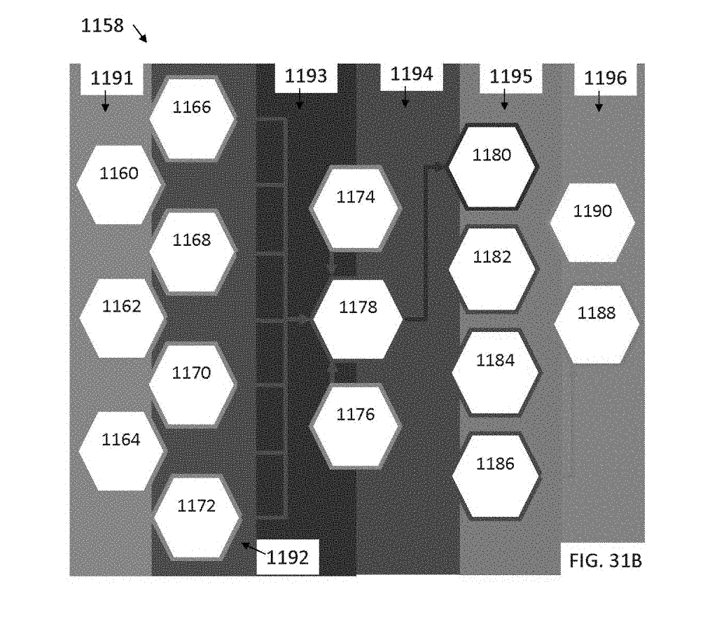

FIG. 31A shows an example embodiment of a logical architecture process diagram 1102 of the primary learning workflow using analytic content inputs and outputs (e.g. see FIG. 6B). As shown in the example embodiment, a Load Data and Load Metadata module 1104, which can include standard UI controls, can exchange information with raw source data 1106 and user domain ontologies 1108. Raw source data 1106 can be exchanged with published source data 1116. Both published source data 1116 and user domain ontologies 1108 can exchange information with metaspace browser module 1118, which can include a dashboard or editor. Metaspace browser module 1118 can also exchange data with semantic map ontologies 1120. Semantic map ontologies 1120 can also be exchanged with engineered features module 1122, which can include aggregation, and with insight factory module 1124, which can include a dashboard or editor. Insight factory module 1124 can also exchange data with engineered features module 1122 and with AC Audit and QG History module 1126. Further, engineered features module 1122 can exchange data with solution domain ontologies 1128. Solution domain ontologies 1128 can exchange data with portal builder endpoint manager 1130, which can include standard UI controls, and with analytics workbench module 1132, which can include a dashboard or editor. Analytics workbench module 1132 can exchange data with an AC Scout and AC Sentry module 1134. Each of dataspace dashboard module 1114, metaspace browser module 1118, insight factory module 1126, and analytics workbench module can send information to or be accessed by AC Audit and QG History module 1126, when curating and publishing apps.

As also shown in the example embodiment, raw source data 1106 can be sent to or accessed by ingestion profile module 1110 when curating and publishing apps. When curating and publishing apps, information from ingestion profile module 1110 can be sent to domain suggestions module 1112, which can include models, workflows, and rules, in addition to dataspace dashboard module 1114, which can include a dashboard or editor. Similarly, user domain ontologies 1108 can be sent to or accessed by domain suggestions module 1112, which can exchange data with metaspace browser module 1118, when curating and publishing apps. Additionally, domain suggestions module 1112 can send data to analytic domain map ontologies 1136 when curating and publishing apps.

Analytic domain map ontologies 1136 can exchange data with semantic map ontologies 1120 and also send data to implicit models module 1138, which can include models, workflows, and rules, when curating and publishing apps. Implicit models module 1138 can exchange data with semantic index module 1140, which can include aggregation, when curating and publishing apps. Solution domain ontologies 1128 can exchange data with a workflow suggestions module 1142, which can include models, workflows, and rules, when curating and publishing apps. Data from workflow suggestions module 1142 can be sent to or accessed by semantic index module 1140, which can also exchange data with engineered features module 1122, when curating and publishing apps.

In general, source data can be associated with load data and load metadata module 1104, raw source data 1106, user domain ontologies 1108, and dataspace dashboard module 1114. Mapping domain and metadata functionality can be associated with published source data 1116, metaspace browser module 1118, semantic map ontologies 1120, engineered features module 1122, and semantic index module 1140. Editing or querying schema and associated features functionality can be associated with insight factory 1124. Building custom analytics workflows can be associated with analytics workbench module 1132. Auditing and nudging AC insights can be associated with AC Audit and QG History module 1126, solution domain ontologies 1128, and portal builder and endpoint manager module 1130.

FIG. 31B shows an example embodiment diagram 1144 of a variety of AC learning workflow connections. As shown in the example embodiment, various sources 1146 can be associated with various domains 1148, which can be associated with various schema 1150, which can be associated with various analytics 1152, which can be associated with various insights 1154, which can be associated with various apps 1156. Further information about features, operations, and interactions of each of these is provided herein with respect to FIG. 29.

The example embodiment is generally associated with a maritime shipping analysis example. For the example embodiment shown, examples of sources 1146 include: ORB feeds, AIS feeds, registries, port records, twitter feeds, and others. Examples of domains 1148 include: owners, operators, ships, calls, GPS locations, segment endpoints, banking, marketing, energy, geopolitical, and others. Examples of schemas 1150, which can be features, include: journeys, waypoints, call durations, segment durations, ship profiles, location profiles, range stability, rank chances, frequency drops, custom formulae, and others. Examples of analytics 1152, which can be models, include: matching ports, predicted destinations, estimated arrival times, port activity forecasts, sentiment analysis, oil price forecast, traders like me, simulated outcomes, weighted decisions, deep learning, and others. Examples of insights 1154 include: busiest ports, destination maps, waypoint analysis, expected busiest ports, ship profiles, investor networks, asset class heat maps, trade maps, influence graphs, and others. Examples of apps 1156 include: QG apps, portfolio interviews, allocation experiments, automated executions, interactive dashboards, question graphing apps, custom charting, workflow studio, personal alerts, custom integrations, and others. Although nearly all connections are shown in the example embodiment between each level, it should be understood that in some embodiments, particular connections need not, may not, or cannot be made. For example, port record source information may not have any use for an energy domain and would therefore not be connected.

FIG. 31B shows an example embodiment of a sample machine learning workflow diagram 1158 constructed by the auto-curious module. As shown in the example embodiment, data from one or more sources including: real time streams 1160, custom documents 1162, big data 1164, public dynamic data 1166 such as the NYSE, enterprise data sources 1168, proprietary data 1170, static databases 1172, social media or other feeds or streams 1174, and third party databases 1176 or others can be tracked, received, accessed, parsed, or otherwise fed and processed through source layer 1191 and domain layer 1192 before being fed through schema layer 1193 to a merge topics module 1178, where it is further processed. Next, it can be fed through a calculate aggregates module 1180 and into analytics layer 1194 where it is processed using sentiment analysis module 1182, deep learning module 1184, and others, whereby a simulation modeling module 1186 may process the information. From simulation module 1186, various insights can be gleaned in insight layer 1195 and results can be personalized by personalization module 1188 for an individual user, group of users, business, research institution, analyst, or other entity. Next, automated execution module 1190 can process the data in apps layer 1196 for presentation to users and storage for further use.

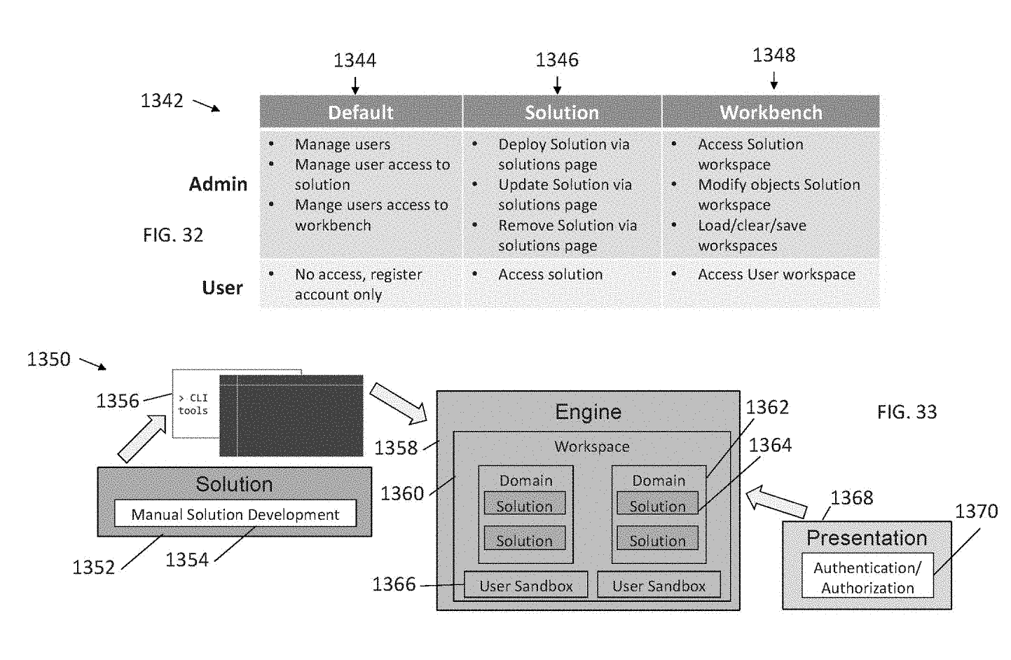

FIG. 32 shows an example embodiment table 1342 showing different administrative and user roles and access privileges for an AC system. As shown in the example embodiment, a default column 1344 describes default administrator roles as managing users, managing user access to solutions, managing user access to workbenches, and others. Default column 1344 also shows that users have no default access and are only able to initially register for a system account. A solution column 1346 shows that administrators are able to deploy solutions via a solutions page of the system, update solutions via a solutions page, remove solutions via a solutions page, and others. Solution column 1346 also shows that users are able to access solutions once registered and approved by the system or system administrators. A workbench column 1348 shows that administrators are able to access solution workspaces; modify objects in solution workspaces; load, clear, and save workspaces; and others. Workbench column 1348 also shows that users are able to access user workspaces when registered with the system.

In various embodiments, system administrators can be those who have broad access to most or all aspects of the system, including solutions and workbenches. They may be data scientists or have other roles at an organization implementing the teachings herein. Various levels of users may exist in various embodiments. “Producer” users may be those users who have registered and been granted access to one or more solutions and workbenches, based on their subscription or registration terms. They may be analysts or other professionals who use the system to process data and determine various solutions. “Curator” users can be users who have registered and been granted access to one or more solutions and workbenches, based on their subscription or registration terms. They may be subject matter experts (SME's) who are knowledgeable in a particular field or have a particular area of expertise. As such, they can help to provide nudges and also analyze solutions, accuracy, and provide other insights. Other users can include “Consumer” users. Consumers can be the general public or other individuals who have registered with the system and are using AC systems for various reasons and purposes. Any or all of these administrative and other users may interact through the system using appropriate user interfaces, which can include instant messaging, delayed delivery messaging (e.g. email and others), and various other functions.

FIG. 33 shows an example embodiment diagram 1350 of an AC system deployment model. In general, this can include an overall process for managing learning from distributed installations, incorporating findings into trusted instance confederations, and distributing insights and models based on policy and license scenarios. As shown in the example embodiment, a solution 1352 can include or be associated with one or more manual solution development module 1354 in some embodiments. These types of development modules 1354 can be operable for use in and be otherwise associated with manual DSL to solution deployment, app deployment, credential mapping, server data cache, and others. Manual solution development module 1354 can include content such as DSL Files; R Scripts/RDATA; Python Scripts/Libraries; Connections to Data; Startup DSL Scripts; and others in various embodiments. Manual development modules 1354 can also include contextual information, such as domain and solution information, roles and members information, solution manifests, and others in various embodiments.

Data from solutions 1352 can be fed through or accessed by CLI tools modules 1356 and others for additional processing. Data from CLI tools modules 1356 can be fed to or accessed by one or more engines 1358 for additional processing. Engine 1358 can include one or more workspace modules 1360. Workspace modules 1360 can manage or include one or more domain modules 1362, each having one or more solutions modules 1364. Workspace modules 1360 also can have one or more user sandboxes 1366. In some embodiments, only clients of a particular sandbox 1366 may be able to access particular domains 1362. In other words, in various embodiments, administrators and users that are registered may be assigned or otherwise work in user sandboxes 1366, which can include one or more domains 1364 that may be private, semi-private, or public. As such, web clients may be able to authenticate and use one or more solutions 1364 at a time within these domains 1362. One or more views are aliases to domain objects in domains 1362 within sandboxes 1366 and solutions 1364.

Presentation module 1368 can include at least one authentication/authorization module 1370. Authentication/authorization module 1370 can be operable to manage users, domains 1362, solutions 1364, roles, and others; to synchronize its contents with engine 1358; to allow access to sandboxes 1366; and others. Additionally, an overall relationship between the components depicted in FIG. 33 can be understood as engine 1358 being centralized within the system, AC operating on a broader sense, with further reaching implementations, presentation modules 1368 being broader still and applicable dependent on implementations, and solutions 1352 being the broadest and highly dependent on individual requirements for each implementation.

Additionally, it should be understood that FIG. 33 generally depicts formalizing the semantic footprint necessary to cover the Add Data scenario of external of bringing in data, models, ontologies, transforms, and analytics from previous work without any work except verifying the mapping suggestions. Here, the mechanisms for managing learning from distributed installations, incorporating findings into a centralized system AC instance and distributing insights and models to various servers, implementations, subscribers, and others based on system policy and license scenarios.

The present invention may be provided as a computer program product which may include a machine-readable medium having stored thereon instructions which may be used to program a computer (or other electronic devices) to perform a process according to the present invention. Moreover, the present invention may also be downloaded as a computer program product, wherein the program may be transferred from a remote computer to a requesting computer by way of data signals embodied in a carrier wave or other propagation medium via a communication link.

It should be noted that while the embodiments described herein may be performed under the control of a programmed processor, in alternative embodiments, the embodiments (and any steps thereof) may be fully or partially implemented by any programmable or hard coded logic. Additionally, the present invention may be performed by any combination of programmed general purpose computer components or custom hardware components. Therefore, nothing disclosed herein should be construed as limiting the present invention to a particular combination of hardware components.

Generally, in various embodiments of the invention, a network architecture can include multiple servers which can include applications distributed on one or more physical servers, each having one or more processors, memory banks, operating systems, input/output interfaces, power supplies, network interfaces, and other components and modules implemented in hardware, software or combinations thereof as are known in the art. These can be communicatively coupled with a network such as a public network (e.g. the Internet and/or a cellular-based wireless network, or other network) or a private network. Servers can be operable to interface with websites, webpages, web applications, social media platforms, advertising platforms, and others. Also, a plurality of end user devices can also be coupled to the network and can include, for example: user mobile devices such as phones, tablets, phablets, handheld video game consoles, media players, laptops; wearable devices such as smartwatches, smart bracelets, smart glasses or others; and user devices such as desktop devices or other devices with computing capability and network interfaces and operable to communicatively couple with the network.

Further, the system can include at least one system server which may distributed across or more physical servers, each having processor, memory, an operating system, and input/output interface, and a network interface all known in the art. A server system can include at least one user device interface implemented with technology known in the art for facilitating communication between user devices and a server based and communicatively coupled with an application program interface (API). API of the server system can also be communicatively coupled to at least one web application server system interface for communication with web applications, websites, webpages, websites, social media platforms, and others. API can also be communicatively coupled with a server based account, product or combination database, other databases implemented in non-transitory computer readable storage media and other interfaces. API can instruct database to store (and retrieve from the database) information. Databases can be implemented with technology known in the art, such as relational databases, object oriented databases, combinations thereof or others. Databases can be a distributed database and individual modules or types of data in the database can be separated virtually or physically in various embodiments.

Additionally, the functions described herein can include mobile applications, mobile devices such as smart phones/tablets, application programming interfaces (APIs), databases, social media platforms including social media profiles or other sharing capabilities, load balancers, web applications, page views, networking devices such as routers, terminals, gateways, network bridges, switches, hubs, repeaters, protocol converters, bridge routers, proxy servers, firewalls, network address translators, multiplexers, network interface controllers, wireless interface controllers, modems, ISDN terminal adapters, line drivers, wireless access points, cables, servers, power components and other equipment and devices as appropriate to implement the methods and systems described herein are contemplated.

A user mobile device, such as user mobile device can include a network connected application that is installed in, pushed to, or downloaded to the user mobile device. In many embodiments user devices are touch screen devices such as smart phones, phablets or tablets which have at least one processor, network interface, camera, power source, memory, speaker, microphone, input/output interfaces, operating systems and other typical components and functionality implemented and coupled to create a functional device, as is known in the art.

The present invention includes various steps. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A system for automating data science, comprising:
instructions stored in non-transitory computer readable media, that when executed by a processor of the system cause the system to perform:
steps for machine learning via a computer network using analytical workflows on a dataset that can adapt to user inputs and automatically suggest possibilities for further analysis,
wherein the steps are iterative.

2. The system for automating data science of claim 1, further comprising:
at least one step for a third-party user query for input.

3. The system for automating data science of claim 1, further comprising:
at least one step for querying and analyzing data from a related dataset.

4. The system for automating data science of claim 1, further comprising:
at least one step for displaying analysis to a user at a user interface and suggesting a refinement based on a first analysis output.

5. The system for automating data science of claim 1, further comprising:
at least one step for generating analytic context from statistical aggregations and observations of the data, analytic context of semantic representations and implicit models of simple machine learning outputs in order to create a consistent mapping to an Analytic Domain feature space.

5. The system for automating data science of claim 1, further comprising:
at least one step for analyzing the Analytic Domain mappings generated in several iterations of permutations of different analytic workflows to generate machine learning models that can be applied to suggest optimal data science tasks a to a user's current actions.

6. The system for automating data science of claim 1, further comprising:
at least one step for reviewing the Analytic Domain mappings' state, resolving a subset of applicable task and workflows and suggesting changes based on finding applicable data science tasks using the machine learning models derived for Analytic Domain analysis.

7. The system for automating data science of claim 1, further comprising:
at least one step for analyzing the interactions generated by Auto-curious and developing metaperception machine learning models that combine Analytic Domain properties for workflow analytics and visual analytics that recognize insights from user interactions

8. The system for automating data science of claim 1, further comprising:
at least one step for applying the Analytic Domain suggestion models generated by Auto-curious integrating the APIs of external analytic engines and driving remote execution of machine learning tasks via an external application of an analytic event orchestrator
